(19) United States
(12) Patent Application Publication
(10) Pub. No.: US 2025/0337657 A1
(43) Pub. Date: Oct. 30, 2025

(54) WIRELESS SENSING USING A FOUNDATION MODEL

(71) Applicants: Guozhen Zhu, North Bethesda, MD (US); Yuqian Hu, Greenbelt, MD (US); Beibei Wang, McLean, VA (US); Muhammed Zahid Ozturk, Rockville, MD (US); Sakila Jayaweera, Hyattsville, MD (US); Wei-Hsiang Wang, Beltsville, MD (US); Weihang Gao, Rockville, MD (US); Jiaxuan Zhang, Rockville, MD (US); K. J. Ray Liu, Potomac, MD (US); Oscar Chi-Lim Au, Rockville, MD (US)

(72) Inventors: Guozhen Zhu, North Bethesda, MD (US); Yuqian Hu, Greenbelt, MD (US); Beibei Wang, McLean, VA (US); Muhammed Zahid Ozturk, Rockville, MD (US); Sakila Jayaweera, Hyattsville, MD (US); Wei-Hsiang Wang, Beltsville, MD (US); Weihang Gao, Rockville, MD (US); Jiaxuan Zhang, Rockville, MD (US); K. J. Ray Liu, Potomac, MD (US); Oscar Chi-Lim Au, Rockville, MD (US)

(21) Appl. No.: 19/260,558

(22) Filed: Jul. 6, 2025

Related U.S. Application Data
(63) Continuation-in-part of application No. 18/391,529, filed on Dec. 20, 2023.
(63) Continuation-in-part of application No. 18/401,681, filed on Jan. 1, 2024, now Pat. No. 12,352,889.
(63) Continuation-in-part of application No. 18/991,632, filed on Dec. 22, 2024.
(63) Continuation-in-part of application No. 19/004,293, filed on Dec. 28, 2024, now Pat. No. 12,352,844.
(60) Provisional application No. 63/799,327, filed on May 2, 2025.

(51) Int. Cl. H04L 41/14; H04L 41/16

(52) U.S. Cl. CPC H04L 41/145; H04L 41/16

(57) ABSTRACT

Examples for performing wireless sensing tasks based on foundation model are described. In one example, a described method comprises: obtaining channel information (CI) data generated based on at least one wireless channel; generating a training dataset based on the CI data, wherein the training dataset comprises: a plurality of CI pairs, original CI data and a mask; training a foundation model using the training dataset based on an aggregate of a contrastive loss function and a reconstruction loss function; training a plurality of task-specific models; and performing a plurality of wireless sensing tasks based on the foundation model and the plurality of task-specific models. Each of the plurality of task-specific models is used to perform a corresponding one of the plurality of wireless sensing tasks together with the foundation model.

### CROSS-REFERENCE TO RELATED APPLICATIONS

The present application hereby incorporates by reference the entirety of the disclosures of, and claims priority to, each of the following cases:
(a) U.S. patent application Ser. No. 18/391,529, entitled “METHOD, APPARATUS, AND SYSTEM FOR WIRELESS HUMAN AND NON-HUMAN MOTION DETECTION”, filed on Dec. 20, 2023;
(b) U.S. patent application Ser. No. 18/401,681, entitled “METHOD, APPARATUS, AND SYSTEM FOR WIRELESS SENSING BASED ON DEEP LEARNING”, filed on Jan. 1, 2024;
(c) U.S. patent application Ser. No. 18/991,632, entitled “WIRELESS SENSING USING CLASSIFIER PROBING AND REFINEMENT”, filed on Dec. 22, 2024;
(d) U.S. patent application Ser. No. 19/004,293, entitled “WIRELESS SENSING FOR IN-VEHICLE CHILD PRESENCE DETECTION”, filed on Dec. 28, 2024;
(e) U.S. Provisional Patent application 63/799,327, entitled “DEEP LEARNING BASED WIRELESS SENSING WITH WIRELESS-SPECIFIC DATA AUGMENTATION”, filed on May 2, 2025.

### TECHNICAL FIELD

The present teaching generally relates to wireless sensing. More specifically, the present teaching relates to performing wireless sensing tasks based on a foundation model.

### BACKGROUND

With the proliferation of Internet of Things (IoT) devices, indoor intelligent applications such as security surveillance, intruder detection, occupancy monitoring, and activity recognition have gained significant attention. However, these applications frequently suffer from an elevated rate of false alarms due to the inability to recognize human and non-human subjects, such as pets, robotic vacuum cleaners, and electrical appliances. This ability to differentiate is essential, especially for applications related to security, health monitoring, automation and energy management. Misidentification can lead to user frustration, erode trust and hamper the practical and widespread adoption of these technologies. Given the prevalence of pets, robotic vacuum cleaners, and electrical appliances, especially in residential environments, it is crucial to develop a reliable system that can accurately recognize human and non-human subjects.

The accurate differentiation of human and various nonhuman movements still remains a challenge nowadays. For instance, camera-based methods and thermal-sensor based approaches can only detect moving subjects within the Line-Of-Sight (LOS). Additionally, camera-based systems raise privacy issues. Strategies leveraging radar to differentiate pets from humans based on vital signs expect pets to remain stationary, which is unrealistic. In addition, these methods have strict device placement requirements, often limited to LOS, and presume the subject is moving within a predetermined area.

### SUMMARY

The present teaching generally relates to wireless sensing. More specifically, the present teaching relates to performing wireless sensing tasks based on a foundation model.

In one embodiment, a method for wireless sensing is described. The method comprises: obtaining channel information (CI) data generated based on at least one wireless channel; generating a training dataset based on the CI data comprising multiple pairs of CI samples and associated masks; training a foundation model using the training dataset at least in part by: determining a contrastive loss function based on a first similarity metric between CI data of each CI pair in the training dataset, determining a reconstruction loss function based on a second similarity metric between the original CI data and predicted CI data generated based on the mask, determining a total loss function based on an aggregate of the contrastive loss function and the reconstruction loss function, and determining model parameters of the foundation model to minimize the total loss function; training a plurality of task-specific models; and performing a plurality of wireless sensing tasks based on the foundation model and the plurality of task-specific models, wherein each of the plurality of task-specific models is used to perform a corresponding one of the plurality of wireless sensing tasks together with the foundation model.

In another embodiment, a device for wireless sensing is described. The device comprises: at least one processor; and at least one memory storing instructions, which when executed, cause the at least one processor to perform operations comprising: obtaining channel information (CI) data generated based on at least one wireless channel, generating a training dataset based on the CI data, wherein the training dataset comprises: a plurality of CI pairs, original CI data and a mask, training a foundation model using the training dataset at least in part by: determining a contrastive loss function based on a first similarity metric between CI data of each CI pair in the training dataset, determining a reconstruction loss function based on a second similarity metric between the original CI data and predicted CI data generated based on the mask, determining a total loss function based on an aggregate of the contrastive loss function and the reconstruction loss function, and determining model parameters of the foundation model to minimize the total loss function, training a plurality of task-specific models, and performing a plurality of wireless sensing tasks based on the foundation model and the plurality of task-specific models, wherein each of the plurality of task-specific models is used to perform a corresponding one of the plurality of wireless sensing tasks together with the foundation model.

In yet another embodiment, a system for wireless sensing is described. The system comprises: at least one local device and a cloud server. The at least one local device is configured to: obtain channel information (CI) data generated based on at least one wireless channel; and generate a training dataset based on the CI data, wherein the training dataset comprises: a plurality of CI pairs, original CI data and a mask. The cloud server is configured to: train a foundation model using the training dataset at least in part by: determining a contrastive loss function based on a first similarity metric between CI data of each CI pair in the training dataset, determining a reconstruction loss function based on a second similarity metric between the original CI data and predicted CI data generated based on the mask, determining a total loss function based on an aggregate of the contrastive loss function and the reconstruction loss function, and determining model parameters of the foundation model to minimize the total loss function, and train a plurality of task-specific models. The at least one local device and the cloud server are further configured to perform a plurality of wireless sensing tasks based on the foundation model and the plurality of task-specific models. Each of the plurality of task-specific models is used to perform a corresponding one of the plurality of wireless sensing tasks together with the foundation model.

Other concepts relate to software for implementing the present teaching on wireless sensing using a foundation model. Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF DRAWINGS

The methods, systems, and/or devices described herein are further described in terms of example embodiments. These example embodiments are described in detail with reference to the drawings. These embodiments are non-limiting example embodiments, in which like reference numerals represent similar structures throughout the several views of the drawings.

FIG. 1 illustrates an example framework of a system for wireless sensing using a foundation model, according to some embodiments of the present disclosure.

FIG. 2 illustrates example processes for training and executing a foundation model for wireless sensing, according to some embodiments of the present disclosure.

FIG. 3 illustrates an example method for combing decisions for a wireless sensing task based on multiple links, according to some embodiments of the present disclosure.

FIG. 4 illustrates another example method for combing decisions for a wireless sensing task based on multiple links, according to some embodiments of the present disclosure.

FIG. 5 illustrates an example process for multi-task learning based on a foundation model, according to some embodiments of the present disclosure.

FIG. 6 illustrates an example mask used for contrastive loss, according to some embodiments of the present disclosure.

FIG. 7 illustrates an example architecture of an auto-encoder, according to some embodiments of the present disclosure.

FIG. 8 illustrates an example process for applying a mask, according to some embodiments of the present disclosure.

FIG. 9 illustrates an example block diagram of a first wireless device of a system for wireless sensing, according to some embodiments of the present disclosure.

FIG. 10 illustrates an example block diagram of a second wireless device of a system for wireless sensing, according to some embodiments of the present disclosure.

FIG. 11 illustrates a flow chart of an example method for wireless sensing using a foundation model, according to some embodiments of the present disclosure.

### DETAILED DESCRIPTION

The symbol “/” disclosed herein means “and/or”. For example, “A/B” means “A and/or B.” In some embodiments, a method/device/system/software of a wireless monitoring system is disclosed. A time series of channel information (CI) of a wireless multipath channel is obtained using a processor, a memory communicatively coupled with processor and a set of instructions stored in memory. The time series of CI (TSCI) may be extracted from a wireless signal transmitted from a Type1 heterogeneous wireless device (e.g. wireless transmitter (TX), “Bot” device) to a Type2 heterogeneous wireless device (e.g. wireless receiver (RX), “Origin” device) in a venue through the channel. The channel is impacted by an expression/motion of an object in venue. A characteristics/spatial-temporal information (STI)/motion information (MI) of object/expression/motion may be computed/monitored based on the TSCI. A task may be performed based on the characteristics/STI/MI. A task-related presentation may be generated in a user-interface (UI) on a device of a user.

Expression may comprise placement, placement of moveable parts, location/speed/acceleration/position/orientation/direction/identifiable place/region/presence/spatial coordinate, static expression/presentation/state/size/length/width/height/angle/scale/curve/surface/area/volume/pose/posture/manifestation/body language, dynamic expression/motion/sequence/movement/activity/behavior/gesture/gait/extension/contraction/distortion/deformation, body expression (e.g. head/face/eye/mouth/tongue/hair/voice/neck/limbs/arm/hand/leg/foot/muscle/moveable parts), surface expression/shape/texture/material/color/electromagnetic (EM) characteristics/visual pattern/wetness/reflectance/translucency/flexibility, material property (e.g. living tissue/hair/fabric/metal/wood/leather/plastic/artificial material/solid/liquid/gas/temperature), expression change, and/or some combination.

Wireless multipath channel may comprise: communication channel, analog frequency channel (e.g. with carrier frequency near 700/800/900 MHz, or 1.8/1.9/2.4/3/5/6/27/60/70+ GHz), coded channel (e.g. in CDMA), and/or channel of wireless/cellular network/system (e.g. WLAN, WiFi, mesh, 4G/LTE/5G/6G/7G/8G, Bluetooth, Zigbee, UWB, RFID, microwave). It may comprise multiple channels, which may be consecutive (e.g. adjacent/overlapping bands) or non-consecutive (e.g. non-overlapping bands, 2.4 GHZ/5 GHZ). While channel is used to transmit wireless signal and perform sensing measurements, data (e.g. TSCI/feature/component/characteristics/STI/MI/analytics/task outputs, auxiliary/non-sensing data/network traffic) may be communicated/transmitted in channel.

Wireless signal may comprise a series of probe signals. It may be any of: EM radiation, radio frequency (RF)/light/bandlimited/baseband signal, signal in licensed/unlicensed/ISM band, wireless/mobile/cellular/optical communication/network/mesh/downlink/uplink/unicast/multicast/broadcast signal. It may be compliant to standard/protocol (e.g. WLAN, WWAN, WPAN, WBAN, international/national/industry/defacto, IEEE/802/802.11/15/16, WiFi, 802.11n/ac/ax/be/bf, 3G/4G/LTE/5G/6G/7G/8G, 3GPP/Bluetooth/BLE/Zigbee/NFC/RFID/UWB/WiMax). A probe signal may comprise any of: protocol/standard/beacon/pilot/sounding/excitation/illumination/handshake/synchronization/reference/source/motion probe/detection/sensing/management/control/data/null-data/beacon/pilot/request/response/association/reassociation/disassociation/authentication/action/report/poll/announcement/extension/enquiry/acknowledgement frame/packet/signal, and/or null-data-frame (NDP)/RTS/CTS/QoS/CF-Poll/CF-Ack/block acknowledgement/reference/training/synchronization. It may comprise line-of-sight (LOS)/non-LOS components (or paths/links). It may have data embedded. Probe signal may be replaced by (or embedded in) data signal. Each frame/packet/signal may comprise: preamble/header/payload. It may comprise: training sequence, short (STF)/long (LTF) training field, L-STF/L-LTF/L-SIG/HE-STF/HE-LTF/HE-SIG-A/HE-SIG-B, channel estimation field (CEF). It may be used to transfer power wirelessly from Type1 device to Type2 device. Sounding rate of signal may be adjusted to control amount of transferred power. Probe signals may be sent in burst.

TSCI may be extracted/obtained (e.g. by IC/chip) from wireless signal at a layer of Type2 device (e.g. layer of OSI reference model, PHY/MAC/data link/logical link control/network/transport/session/presentation/application layer, TCP/IP/internet/link layer). It may be extracted from received wireless/derived signal. It may comprise wireless sensing measurements obtained in communication protocol (e.g. wireless/cellular communication standard/network, 4G/LTE/5G/6G/7G/8G, WiFi, IEEE 802.11/11bf/15/16). Each CI may be extracted from a probe/sounding signal, and may be associated with time stamp. TSCI may be associated with starting/stopping time/duration/amount of CI/sampling/sounding frequency/period. A motion detection/sensing signal may be recognized/identified base on probe signal. TSCI may be stored/retrieved/accessed/preprocessed/processed/postprocessed/conditioned/analyzed/monitored. TSCI/features/components/characteristics/STI/MI/analytics/task outcome may be communicated to edge/cloud server/Type1/Type2/hub/data aggregator/another device/system/network.

Type1/Type2 device may comprise components (hardware/software) such as electronics/chip/integrated circuit (IC)/RF circuitry/antenna/modem/TX/RX/transceiver/RF interface (e.g. 2.4/5/6/27/60/70+ GHz radio/front/back haul radio)/network/interface/processor/memory/module/circuit/board/software/firmware/connectors/structure/enclosure/housing/structure. It may comprise access point (AP)/base-station/mesh/router/repeater/hub/wireless station/client/terminal/“Origin Satellite”/“Tracker Bot”, and/or internet-of-things (IoT)/appliance/wearable/accessory/peripheral/furniture/amenity/gadget/vehicle/module/wireless-enabled/unicast/multicast/broadcasting/node/hub/target/sensor/portable/mobile/cellular/communication/motion-detection/source/destination/standard-compliant device. It may comprise additional attributes such as auxiliary functionality/network connectivity/purpose/brand/model/appearance/form/shape/color/material/specification. It may be heterogeneous because the above (e.g. components/device types/additional attributes) may be different for different Type1 (or Type2) devices.

Type1/Type2 devices may/may not be authenticated/associated/collocated. They may be same device. Type1/Type2/portable/nearby/another device, sensing/measurement session/link between them, and/or object/expression/motion/characteristics/STI/MI/task may be associated with an identity/identification/identifier (ID) such as UUID, associated/unassociated STA ID (ASID/USID/AID/UID). Type2 device may passively observe/monitor/receive wireless signal from Type1 device without establishing connection (e.g. association/authentication/handshake) with, or requesting service from, Type1 device. Type1/Type2 device may move with object/another object to be tracked.

Type1 (TX) device may function as Type2 (RX) device temporarily/sporadically/continuously/repeatedly/interchangeably/alternately/simultaneously/contemporaneously/concurrently; and vice versa. Type1 device may be Type2 device. A device may function as Type1/Type2 device temporarily/sporadically/continuously/repeatedly/simultaneously/concurrently/contemporaneously. There may be multiple wireless nodes each being Type1/Type2 device. TSCI may be obtained between two nodes when they exchange/communicate wireless signals. Characteristics/STI/MI of object may be monitored individually based on a TSCI, or jointly based on multiple TSCI.

Motion/expression of object may be monitored actively with Type1/Type2 device moving with object (e.g. wearable devices/automated guided vehicle/AGV), or passively with Type1/Type2 devices not moving with object (e.g. both fixed devices).

Task may be performed with/without reference to reference/trained/initial database/profile/baseline that is trained/collected/processed/computed/transmitted/stored in training phase. Database may be re-training/updated/reset.

Presentation may comprise UI/GUI/text/message/form/webpage/visual/image/video/graphics/animation/graphical/symbol/emoticon/sign/color/shade/sound/music/speech/audio/mechanical/gesture/vibration/haptics presentation. Time series of characteristic/STI/MI/task outcome/another quantity may be displayed/presented in presentation. Any computation may be performed/shared by processor (or logic unit/chip/IC)/Type1/Type2/user/nearby/another device/local/edge/cloud server/hub/data/signal analysis subsystem/sensing initiator/response/SBP initiator/responder/AP/non-AP. Presentation may comprise any of: monthly/weekly/daily/simplified/detailed/cross-sectional/small/large/form-factor/color-coded/comparative/summary/web view, animation/voice announcement/another presentation related to periodic/repetition characteristics of repeating motion/expression.

Multiple Type1 (or Type 2) devices may interact with a Type2 (or Type1) device. The multiple Type1 (or Type2) devices may be synchronized/asynchronous, and/or may use same/different channels/sensing parameters/settings (e.g. sounding frequency/bandwidth/antennas). Type2 device may receive another signal from Type1/another Type1 device. Type1 device may transmit another signal to Type2/another Type2 device. Wireless signals sent (or received) by them may be sporadic/temporary/continuous/repeated/synchronous/simultaneous/concurrent/contemporaneous. They may operate independently/collaboratively. Their data (e.g. TSCI/feature/characteristics/STI/MI/intermediate task outcomes) may be processed/monitored/analyzed independently or jointly/collaboratively.

Any devices may operate based on some state/internal state/system state. Devices may communicate directly, or via another/nearby/portable device/server/hub device/cloud server. Devices/system may be associated with one or more users, with associated settings. Settings may be chosen/selected/pre-programmed/changed/adjusted/modified/varied over time. The method may be performed/executed in shown order/another order. Steps may be performed in parallel/iterated/repeated. Users may comprise human/adult/older adult/man/woman/juvenile/child/baby/pet/animal/creature/machine/computer module/software. Step/operation/processing may be different for different devices (e.g. based on locations/orientation/direction/roles/user-related characteristics/settings/configurations/available resources/bandwidth/power/network connection/hardware/software/processor/co-processor/memory/battery life/antennas/directional antenna/power setting/device parameters/characteristics/conditions/status/state). Any/all device may be controlled/coordinated by a processor (e.g. associated with Type1/Type2/nearby/portable/another device/server/designated source). Some device may be physically in/of/attached to a common device.

Type1 (or Type2) device may be capable of wirelessly coupling with multiple Type2 (or Type1) devices. Type1 (or Type2) device may be caused/controlled to switch/establish wireless coupling (e.g. association/authentication) from Type2 (or Type1) device to another Type2 (or another Type1) device. The switching may be controlled by server/hub device/processor/Type1 device/Type2 device. Radio channel may be different before/after switching. A second wireless signal may be transmitted between Type 1 (or Type2) device and second Type2 (or second Type1) device through the second channel. A second TSCI of second channel may be extracted/obtained from second signal. The first/second signals, first/second channels, first/second Type1 device, and/or first/second Type2 device may be same/similar/co-located.

Type 1 device may transmit/broadcast wireless signal to multiple Type2 devices, with/without establishing connection (association/authentication) with individual Type2 devices. It may transmit to a particular/common MAC address, which may be MAC address of some device (e.g. dummy receiver). Each Type2 device may adjust to particular MAC address to receive wireless signal. Particular MAC address may be associated with venue, which may be recorded in an association table of an Association Server (e.g. hub device). Venue may be identified by Type1 device/Type2 device based on wireless signal received at particular MAC address.

For example, Type2 device may be moved to a new venue. Type1 device may be newly set up in venue such that Type1 and Type2 devices are not aware of each other. During set up, Type1 device may be instructed/guided/caused/controlled (e.g. by dummy receiver, hardware pin setting/connection, stored setting, local setting, remote setting, downloaded setting, hub device, and/or server) to send wireless signal (e.g. series of probe signals) to particular MAC address. Upon power up, Type2 device may scan for probe signals according to a table of MAC addresses (e.g. stored in designated source, server, hub device, cloud server) that may be used for broadcasting at different locations (e.g. different MAC address used for different venue such as house/office/enclosure/floor/multi-storey building/store/airport/mall/stadium/hall/station/subway/lot/area/zone/region/district/city/country/continent). When Type2 device detects wireless signal sent to particular MAC address, it can use the table to identify venue.

Channel may be selected from a set of candidate/selectable/admissible channels. Candidate channels may be associated with different frequency bands/bandwidth/carrier frequency/modulation/wireless standards/coding/encryption/payload characteristics/network/ID/SSID/characteristics/settings/parameters. Particular MAC address/selected channel may be changed/adjusted/varied/modified over time (e.g. according to time table/rule/policy/mode/condition/situation/change). Selection/change may be based on availability/collision/traffic pattern/co-channel/inter-channel interference/effective bandwidth/random selection/pre-selected list/plan. It may be done by a server (e.g. hub device). They may be communicated (e.g. from/to Type1/Type2/hub/another device/local/edge/cloud server).

Wireless connection (e.g. association/authentication) between Type1 device and nearby/portable/another device may be established (e.g. using signal handshake). Type1 device may send first handshake signal (e.g. sounding frame/probe signal/request-to-send RTS) to the nearby/portable/another device. Nearby/portable/another device may reply to first signal by sending second handshake signal (e.g. command/clear-to-send/CTS) to Type1 device, triggering Type1 device to transmit/broadcast wireless signal to multiple Type2 devices without establishing connection with the Type2 devices. Second handshake signals may be response/acknowledge (e.g. ACK) to first handshake signal. Second handshake signal may contain information of venue/Type1 device. Nearby/portable/another device may be a dummy device with purpose (e.g. primary purpose, secondary purpose) to establish wireless connection with Type1 device, to receive first signal, or send second signal. Nearby/portable/another device may be physically attached to Type1 device.

In another example, nearby/portable/another device may send third handshake signal to Type1 device triggering Type 1 device to broadcast signal to multiple Type2 devices without establishing connection with them. Type1 device may reply to third signal by transmitting fourth handshake signal to the another device.

Nearby/portable/another device may be used to trigger multiple Type1 devices to broadcast. It may have multiple RF circuitries to trigger multiple transmitters in parallel. Triggering may be sequential/partially sequential/partially/fully parallel. Parallel triggering may be achieved using additional device(s) to perform similar triggering in parallel to nearby/portable/another device. After establishing connection with Type1 device, nearby/portable/another device may suspend/stop communication with Type 1 device. It may enter an inactive/hibernation/sleep/stand-by/low-power/OFF/power-down mode. Suspended communication may be resumed. Nearby/portable/another device may have the particular MAC address and Type1 device may send signal to particular MAC address.

The (first) wireless signal may be transmitted by a first antenna of Type1 device to some first Type2 device through a first channel in a first venue. A second wireless signal may be transmitted by a second antenna of Type1 device to some second Type2 device through a second channel in a second venue. First/second signals may be transmitted at first/second (sounding) rates respectively, perhaps to first/second MAC addresses respectively. Some first/second channels/signals/rates/MAC addresses/antennas/Type2 devices may be same/different/synchronous/asynchronous. First/second venues may have same/different sizes/shape/multipath characteristics. First/second venues/immediate areas around first/second antennas may overlap. First/second channels/signals may be WiFi+LTE (one being WiFi, one being LTE), or WiFi+WiFi, or WiFi (2.4 GHz)+WiFi (5 GHz), or WiFi (5 GHz, channel=a1, BW=a2)+WiFi (5 GHz/channel=b1, BW=b2). Some first/second items (e.g. channels/signals/rates/MAC addresses/antennas/Type1/Type2 devices) may be changed/adjusted/varied/modified over time (e.g. based on time table/rule/policy/mode/condition/situation/another change).

Each Type1 device may be signal source of multiple Type2 devices (i.e. it sends respective probe signal to respective Type2 device). Each respective Type2 device may choose asynchronously the Type1 device from among all Type1 devices as its signal source. TSCI may be obtained by each respective Type2 device from respective series of probe signals from Type1 device. Type2 device may choose Type 1 device from among all Type1 devices as its signal source (e.g. initially) based on identity/identification/identifier of Type 1/Type2 device, task, past signal sources, history, characteristics, signal strength/quality, threshold for switching signal source, and/or information of user/account/profile/access info/parameters/input/requirement/criteria.

Database of available/candidate Type1 (or Type2) devices may be initialized/maintained/updated by Type2 (or Type1) device. Type2 device may receive wireless signals from multiple candidate Type1 devices. It may choose its Type1 device (i.e. signal source) based on any of: signal quality/strength/regularity/channel/traffic/characteristics/properties/states/task requirements/training task outcome/MAC addresses/identity/identifier/past signal source/history/user instruction/another consideration.

An undesirable/bad/poor/problematic/unsatisfactory/unacceptable/intolerable/faulty/demanding/undesirable/inadequate/lacking/inferior/unsuitable condition may occur when (1) timing between adjacent probe signals in received wireless signal becomes irregular, deviating from agreed sounding rate (e.g. time perturbation beyond acceptable range), and/or (2) processed/signal strength of received signal is too weak (e.g. below third threshold, or below fourth threshold for significant percentage of time), wherein processing comprises any lowpass/bandpass/highpass/median/moving/weighted average/linear/nonlinear/smoothing filtering. Any thresholds/percentages/parameters may be time-varying. Such condition may occur when Type1/Type2 device become progressively far away, or when channel becomes congested.

Some settings (e.g. Type1-Type2 device pairing/signal source/network/association/probe signal/sounding rate/scheme/channel/bandwidth/system state/TSCI/TSMA/task/task parameters) may be changed/varied/adjusted/modified. Change may be according to time table/rule/policy/mode/condition (e.g. undesirable condition)/another change. For example, sounding rate may normally be 100 Hz, but changed to 1000 Hz in demanding situations, and to 1 Hz in low power/standby situation.

Settings may change based on task requirement (e.g. 100 Hz normally and 1000 Hz momentarily for 20 seconds). In task, instantaneous system may be associated adaptively/dynamically to classes/states/conditions (e.g. low/normal/high priority/emergency/critical/regular/privileged/non-subscription/subscription/paying/non-paying). Settings (e.g. sounding rate) may be adjusted accordingly. Change may be controlled by: server/hub/Type1/Type2 device. Scheduled changes may be made according to time table. Changes may be immediate when emergency is detected, or gradual when developing condition is detected.

Characteristics/STI/MI may be monitored/analyzed individually based on a TSCI associated with a particular Type 1/Type2 device pair, or jointly based on multiple TSCI associated multiple Type1/Type2 pairs, or jointly based on any TSCI associated with the particular Type2 device and any Type1 devices, or jointly based on any TSCI associated with the particular Type1 device and any Type2 devices, or globally based on any TSCI associated with any Type1/Type2 devices.

A classifier/classification/recognition/detection/estimation/projection/feature extraction/processing/filtering may be applied (e.g. to CI/CI-feature/characteristics/STI/MI), and/or trained/re-trained/updated. In a training stage, training may be performed based on multiple training TSCI of some training wireless multipath channel, or characteristic/STI/MI computed from training TSCI, the training TSCI obtained from training wireless signals transmitted from training Type1 devices and received by training Type2 devices. Re-training/updating may be performed in an operating stage based on training TSCI/current TSCI. There may be multiple classes (e.g.

groupings/categories/events/motions/expression/activities/objects/locations) associated with venue/regions/zones/location/environment/home/office/building/warehouse/facility object/expression/motion/movement/process/event/manufacturing/assembly-line/maintenance/repairing/navigation/object/emotional/mental/state/condition/stage/gesture/gait/action/motion/presence/movement/daily/activity/history/event.

Classifier may comprise linear/nonlinear/binary/multiclass/Bayes classifier/Fisher linear discriminant/logistic regression/Markov chain/Monte Carlo/deep/neural network/perceptron/self-organization maps/boosting/meta algorithm/decision tree/random forest/genetic programming/kernel learning/KNN/support vector machine (SVM).

Feature extraction/projection may comprise any of: subspace projection/principal component analysis (PCA)/independent component analysis (ICA)/vector quantization/singular value decomposition (SVD)/eigen-decomposition/eigenvalue/time/frequency/orthogonal/non-orthogonal decomposition, processing/preprocessing/postprocessing. Each CI may comprise multiple components (e.g. vector/combination of complex values). Each component may be preprocessed to give magnitude/phase or a function of such.

Feature may comprise: output of feature extraction/projection, amplitude/magnitude/phase/energy/power/strength/intensity, presence/absence/proximity/likelihood/histogram, time/period/duration/frequency/component/decomposition/projection/band, local/global/maximum (max)/minimum (min)/zero-crossing, repeating/periodic/typical/habitual/one-time/atypical/abrupt/mutually-exclusive/evolving/transient/changing/time/related/correlated feature/pattern/trend/profile/events/tendency/inclination/behavior, cause-and-effect/short-term/long-term/correlation/statistics/frequency/period/duration, motion/movement/location/map/coordinate/height/speed/acceleration/angle/rotation/size/volume, suspicious/dangerous/alarming event/warning/belief/proximity/collision, tracking/breathing/heartbeat/gait/action/event/statistical/hourly/daily/weekly/monthly/yearly parameters/statistics/analytics, well-being/health/disease/medical statistics/analytics, an early/instantaneous/contemporaneous/delayed indication/suggestion/sign/indicator/verifier/detection/symptom of a state/condition/situation/disease/biometric, baby/patient/machine/device/temperature/vehicle/parking lot/venue/lift/elevator/spatial/road/fluid flow/home/room/office/house/building/warehouse/storage/system/ventilation/fan/pipe/duct/people/human/car/boat/truck/airplane/drone/downtown/crowd/impulsive event/cyclo-stationary/environment/vibration/material/surface/3D/2D/local/global, and/or another measurable quantity/variable. Feature may comprise monotonic function of feature, or sliding aggregate of features in sliding window.

Training may comprise AI/machine/deep/supervised/unsupervised/discriminative training/auto-encoder/linear discriminant analysis/regression/clustering/tagging/labeling/Monte Carlo computation.

A current event/motion/expression/object in venue at current time may be classified by applying classifier to current TSCI/characteristics/STI/MI obtained from current wireless signal received by Type2 device in venue from Type1 devices in an operating stage. If there are multiple Type1/Type2 devices, some/all (or their locations/antenna locations) may be a permutation of corresponding training Type 1/Type2 devices (or locations/antenna locations). Type1/Type2 device/signal/channel/venue/object/motion may be same/different from corresponding training entity. Classifier may be applied to sliding windows. Current TSCI/characteristics/STI/MI may be augmented by training TSCI/characteristics/STI/MI (or fragment/extract) to bootstrap classification/classifier.

A first section/segment (with first duration/starting/ending time) of a first TSCI (associated with first Type1-Type2 device pair) may be aligned (e.g. using dynamic time warping/DTW/matched filtering, perhaps based on some mismatch/distance/similarity score/cost, or correlation/autocorrelation/cross-correlation) with a second section/segment (with second duration/starting/ending time) of a second TSCI (associated with second Type1-Type2 device pair), with each CI in first section mapped to a CI in second section. First/second TSCI may be preprocessed. Some similarity score (component/item/link/segment-wise) may be computed. The similarity score may comprise any of: mismatch/distance/similarity score/cost. Component-wise similarity score may be computed between a component of first item (CI/feature/characteristics/STI/MI) of first section and corresponding component of corresponding mapped item (second item) of second section. Item-wise similarity score may be computed between first/second items (e.g. based on aggregate of corresponding component-wise similarity scores). An aggregate may comprise any of: sum/weighted sum, weighted average/robust/trimmed mean/arithmetic/geometric/harmonic mean, median/mode. Link-wise similarity score may be computed between first/second items associated with a link (TX-RX antenna pair) of first/second Type1-Type2 device pairs (e.g. based on aggregate of corresponding item-wise similarity scores). Segment-wise similarity score may be computed between first/second segments (e.g. based on aggregate of corresponding link-wise similarity scores). First/second segment may be sliding.

In DTW, a function of any of: first/second segment, first/second item, another first (or second) item of first (or second) segment, or corresponding timestamp/duration/difference/differential, may satisfy a constraint. Time difference between first/second items may be constrained (e.g. upper/lower bounded). First (or second) section may be entire first (or second) TSCI. First/second duration/starting/ending time may be same/different.

In one example, first/second Type1-Type2 device pairs may be same and first/second TSCI may be same/different. When different, first/second TSCI may comprise a pair of current/reference, current/current or reference/reference TSCI. For “current/reference”, first TSCI may be current TSCI obtained in operating stage and second TSCI may be reference TSCI obtained in training stage. For “reference/reference”, first/second TSCI may be two TSCI obtained during training stage (e.g. for two training events/states/classes). For “current/current”, first/second TSCI may be two TSCI obtained during operating stage (e.g. associated with two different antennas, or two measurement setups). In another example, first/second Type1-Type2 device pairs may be different, but share a common device (Type1 or Type2).

Aligned first/second segments (or portion of each) may be represented as first/second vectors. Portion may comprise all items (for “segment-wise”), or all items associated with a TX-RX link (for “link-wise”), or an item (for “item-wise”), or a component of an item (for “component-wise”). Similarity score may comprise combination/aggregate/function of any of: inner product/correlation/autocorrelation/correlation indicator/covariance/discriminating score/distance/Euclidean/absolute/L_k/weighted distance (between first/second vectors). Similarity score may be normalized by vector length. A parameter derived from similarity score may be modeled with a statistical distribution. A scale/location/another parameter of the statistical distribution may be estimated.

Recall there may be multiple sliding segments. Classifier may be applied to a sliding first/second segment pair to obtain a tentative classification result. It may associate current event with a particular class based on one segment pair/tentative classification result, or multiple segment pairs/tentative classification results (e.g. associate if similarity scores prevail (e.g. being max/min/dominant/matchless/most significant/excel) or significant enough (e.g. higher/lower than some threshold) among all candidate classes for N consecutive times, or for a high/low enough percentage, or most/least often in a time period).

Channel information (CI) may comprise any of: signal strength/amplitude/phase/timestamp, spectral power measurement, modem parameters, dynamic beamforming information, transfer function components, radio state, measurable variables, sensing data/measurement, coarse/fine-grained layer information (e.g. PHY/MAC/datalink layer), digital gain/RF filter/frontend-switch/DC offset/correction/IQ-compensation settings, environment effect on wireless signal propagation, channel input-to-output transformation, stable behavior of environment, state profile, wireless channel measurements/received signal strength indicator (RSSI)/channel state information (CSI)/channel impulse response (CIR)/channel frequency response (CFR)/characteristics of frequency components (e.g. subcarriers)/channel characteristics/channel filter response, auxiliary information, data/meta/user/account/access/security/session/status/supervisory/device/network/household/neighborhood/environment/real-time/sensor/stored/encrypted/compressed/protected data, identity/identifier/identification.

Each CI may be associated with timestamp/arrival time/frequency band/signature/phase/amplitude/trend/characteristics, frequency-like characteristics, time/frequency/time-frequency domain element, orthogonal/non-orthogonal decomposition characteristics of signal through channel. Timestamps of TSCI may be irregular and may be corrected (e.g. by interpolation/resampling) to be regular, at least for a sliding time window.

TSCI may be/comprise a link-wise TSCI associated with an antenna of Type1 device and an antenna of Type2 device. For Type1 device with M antennas and Type2 device with N antennas, there may be MN link-wise TSCI.

CI/TSCI may be preprocessed/processed/postprocessed/stored/retrieved/transmitted/received. Some modem/radio state parameter may be held constant. Modem parameters may be applied to radio subsystem and may represent radio state. Motion detection signal (e.g. baseband signal, packet decoded/demodulated from it) may be obtained by processing (e.g. down-converting) wireless signal (e.g. RF/WiFi/LTE/5G/6G signal) by radio subsystem using radio state represented by stored modem parameters. Modem parameters/radio state may be updated (e.g. using previous modem parameters/radio state). Both previous/updated modem parameters/radio states may be applied in radio subsystem (e.g. to process signal/decode data). In the disclosed system, both may be obtained/compared/analyzed/processed/monitored.

Each CI may comprise N1 CI components (CIC) (e.g. time/frequency domain component, decomposition components), each with corresponding CIC index. Each CIC may comprise a real/imaginary/complex quantity, magnitude/phase/Boolean/flag, and/or some combination/subset. Each CI may comprise a vector/matrix/set/collection of CIC. CIC of TSCI associated with a particular CIC index may form a CIC time series. TSCI may be divided into N1 time series of CIC (TSCIC), each associated with respective CIC index. Characteristics/STI/MI may be monitored based on TSCIC. Some TSCIC may be selected based on some criteria/cost function/signal quality metric (e.g. SNR, interference level) for further processing.

Multi-component characteristics/STI/MI of multiple TSCIC (e.g. two components with indices 6 and 7, or three components indexed at 6, 7, 10) may be computed. In particular, k-component characteristics may be a function of k TSCIC with k corresponding CIC indices. With k=1, it is single-component characteristics which may constitute/form a one-dimensional (1D) function as CIC index spans all possible values. For k=2, two-component characteristics may constitute/form a 2D function. In special case, it may depend only on difference between the two indices. In such case, it may constitute 1D function. A total characteristics may be computed based on one or more multi-component characteristics (e.g. weighted average/aggregate). Characteristics/STI/MI of object/motion/expression may be monitored based on any multi-component characteristics/total characteristics.

Characteristics/STI/MI may comprise: instantaneous/short-/long-term/historical/repetitive/repeated/repeatable/recurring/periodic/pseudoperiodic/regular/habitual/incremental/average/initial/final/current/past/future/predicted/changing/deviational/change/time/frequency/orthogonal/non-orthogonal/transform/decomposition/deterministic/stochastic/probabilistic/dominant/key/prominent/representative/characteristic/significant/insignificant/indicative/common/averaged/shared/typical/prototypical/persistent/abnormal/abrupt/impulsive/sudden/unusual/unrepresentative/atypical/suspicious/dangerous/alarming/evolving/transient/one-time quantity/characteristics/analytics/feature/information, cause-and-effect, correlation indicator/score, auto/cross correlation/covariance, autocorrelation function (ACF), spectrum/spectrogram/power spectral density, time/frequency function/transform/projection, initial/final/temporal/change/trend/pattern/tendency/inclination/behavior/activity/history/profile/event, location/position/localization/spatial coordinate/change on map/path/navigation/tracking, linear/rotational/horizontal/vertical/location/distance/displacement/height/speed/velocity/acceleration/change/angular speed, direction/orientation, size/length/width/height/azimuth/area/volume/capacity, deformation/transformation, object/motion direction/angle/shape/form/shrinking/expanding, behavior/activity/movement, occurrence, fall-down/accident/security/event, period/frequency/rate/cycle/rhythm/count/quantity, timing/duration/interval, starting/initiating/ending/current/past/next time/quantity/information, type/grouping/classification/composition, presence/absence/proximity/approaching/receding/entrance/exit, identity/identifier, head/mouth/eye/breathing/heart/hand/handwriting/arm/body/gesture/leg/gait/organ characteristics, tidal volume/depth of breath/airflow rate/inhale/exhale time/ratio, gait/walking/tool/machine/complex motion, signal/motion characteristic/information/feature/statistics/parameter/magnitude/phase/degree/dynamics/anomaly/variability/detection/estimation/recognition/identification/indication, slope/derivative/higher order derivative of function/feature/mapping/transformation of another characteristics, mismatch/distance/similarity score/cost/metric, Euclidean/statistical/weighted distance, L1/L2/Lk norm, inner/outer product, tag, test quantity, consumed/unconsumed quantity, state/physical/health/well-being/emotional/mental state, output responses, any composition/combination, and/or any related characteristics/information/combination.

Test quantities may be computed. Characteristics/STI/MI may be computed/monitored based on CI/TSCI/features/similarity scores/test quantities. Static (or dynamic) segment/profile may be identified/computed/analyzed/monitored/extracted/obtained/marked/presented/indicated/highlighted/stored/communicated by analyzing CI/TSCI/features/functions of features/test quantities/characteristics/STI/MI (e.g. target motion/movement presence/detection/estimation/recognition/identification). Test quantities may be based on CI/TSCI/features/functions of features/characteristics/STI/MI. Test quantities may be processed/tested/analyzed/compared.

Test quantity may comprise any/any function of: data/vector/matrix/structure, characteristics/STI/MI, CI information (CII, e.g. CI/CIC/feature/magnitude/phase), directional information (DI, e.g. directional CII), dominant/representative/characteristic/indicative/key/archetypal/example/paradigmatic/prominent/common/shared/typical/prototypical/averaged/regular/persistent/usual/normal/atypical/unusual/abnormal/unrepresentative data/vector/matrix/structure, similarity/mismatch/distance score/cost/metric, auto/cross correlation/covariance, sum/mean/average/weighted/trimmed/arithmetic/geometric/harmonic mean, variance/deviation/absolute/square deviation/averaged/median/total/standard deviation/derivative/slope/variation/total/absolute/square variation/spread/dispersion/variability, divergence/skewness/kurtosis/range/interquartile range/coefficient of variation/dispersion/L-moment/quartile coefficient of dispersion/mean absolute/square difference/Gini coefficient/relative mean difference/entropy/maximum (max)/minimum (min)/median/percentile/quartile, variance-to-mean ratio, max-to-min ratio, variation/regularity/similarity measure, transient event/behavior, statistics/mode/likelihood/histogram/probability distribution function (pdf)/moment generating function/expected function/value, behavior, repeatedness/periodicity/pseudo-periodicity, impulsiveness/suddenness/occurrence/recurrence, temporal profile/characteristics, time/timing/duration/period/frequency/trend/history, starting/initiating/ending time/quantity/count, motion classification/type, change, temporal/frequency/cycle change, etc.

Identification/identity/identifier/ID may comprise: MAC address/ASID/USID/AID/UID/UUID, label/tag/index, web link/address, numeral/alphanumeric ID, name/password/account/account ID, and/or another ID. ID may be assigned (e.g. by software/firmware/user/hardware, hardwired, via dongle). ID may be stored/retrieved (e.g. in database/memory/cloud/edge/local/hub server, stored locally/remotely/permanently/temporarily). ID may be associated with any of: user/customer/household/information/data/address/phone number/social security number, user/customer number/record/account, timestamp/duration/timing. ID may be made available to Type1/Type2 device/sensing/SBP initiator/responder. ID may be for registration/initialization/communication/identification/verification/detection/recognition/authentication/access control/cloud access/networking/social networking/logging/recording/cataloging/classification/tagging/association/pairing/transaction/electronic transaction/intellectual property control (e.g. by local/cloud/server/hub, Type1/Type2/nearby/user/another device, user).

Object may be person/pet/animal/plant/machine/user, baby/child/adult/older person, expert/specialist/leader/commander/manager/personnel/staff/officer/doctor/nurse/worker/teacher/technician/serviceman/repairman/passenger/patient/customer/student/traveler/inmate/high-value person/, object to be tracked, vehicle/car/AGV/drone/robot/wagon/transport/remote-controlled machinery/cart/moveable objects/goods/items/material/parts/components/machine/lift/elevator, merchandise/goods/cargo/people/items/food/package/luggage/equipment/cleaning tool in/on workflow/assembly-line/warehouse/factory/store/supermarket/distribution/logistic/transport/manufacturing/retail/wholesale/business center/facility/hub, phone/computer/laptop/tablet/dongle/plugin/companion/tool/peripheral/accessory/wearable/furniture/appliance/amenity/gadget, IoT/networked/smart/portable devices, watch/glasses/speaker/toys/stroller/keys/wallet/purse/handbag/backpack, goods/cargo/luggage/equipment/motor/machine/utensil/table/chair/air-conditioner/door/window/heater/fan, light/fixture/stationary object/television/camera/audio/video/surveillance equipment/parts, ticket/parking/toll/airplane ticket, credit/plastic/access card, object with fixed/changing/no form, mass/solid/liquid/gas/fluid/smoke/fire/flame, signage, electromagnetic (EM) source/medium, and/or another object.

Object may have multiple parts, each with different movement (e.g. position/location/direction change). Object may be a person walking forward. While walking, his left/right hands may move in different directions, with different instantaneous motion/speed/acceleration.

Object may/may not be communicatively coupled with some network, such as WiFi, MiFi, 4G/LTE/5G/6G/7G/8G, Bluetooth/NFC/BLE/WiMax/Zigbee/mesh/adhoc network. Object may be bulky machinery with AC power supply that is moved during installation/cleaning/maintenance/renovation. It may be placed on/in moveable platforms such as elevator/conveyor/lift/pad/belt/robot/drone/forklift/car/boat/vehicle. Type1/Type2 device may attach to/move with object. Type 1/Type2 device may be part of/embedded in portable/another device (e.g. module/device with module, which may be large/sizeable/small/heavy/bulky/light, e.g. coin-sized/cigarette-box-sized). Type 1/Type2/portable/another device may/may not be attached to/move with object, and may have wireless (e.g. via Bluetooth/BLE/Zigbee/NFC/WiFi) or wired (e.g. USB/micro-USB/Firewire/HDMI) connection with a nearby device for network access (e.g. via WiFi/cellular network). Nearby device may be object/phone/AP/IoT/device/appliance/peripheral/amenity/furniture/vehicle/gadget/wearable/networked/computing device. Nearby device may be connected to some server (e.g. cloud server via network/internet). It may/may not be portable/moveable, and may/may not move with object. Type1/Type2/portable/nearby/another device may be powered by battery/solar/DC/AC/other power source, which may be replaceable/non-replaceable, and rechargeable/non-rechargeable. It may be wirelessly charged.

Type 1/Type2/portable/nearby/another device may comprise any of: computer/laptop/tablet/pad/phone/printer/monitor/battery/antenna, peripheral/accessory/socket/plug/charger/switch/adapter/dongle, internet-of-thing (IoT), TV/sound bar/HiFi/speaker/set-top box/remote control/panel/gaming device, AP/cable/broadband/router/repeater/extender, appliance/utility/fan/refrigerator/washer/dryer/microwave/oven/stove/range/light/lamp/tube/pipe/tap/lighti ng/air-conditioner/heater/smoke detector, wearable/watch/glasses/goggle/button/bracelet/chain/jewelry/ring/belt/clothing/garment/fabric/shirt/pant/dress/glove/handwear/shoe/footwear/ha t/headwear/bag/purse/wallet/makeup/cosmetic/ornament/book/magazine/paper/stationary/signage/poster/display/printed matter, furniture/fixture/table/desk/chair/sofa/bed/cabinet/shelf/rack/storage/box/bucket/basket/packaging/carriage/tile/shingle/brick/block/mat/panel/curtain/cushion/pad/carpet/material/building material/glass, amenity/sensor/clock/pot/pan/ware/container/bottle/can/utensil/plate/cup/bowl/toy/ball/tool/pen/racket/lock/bell/camera/microphone/painting/frame/mirror/coffee-maker/door/window, food/pill/medicine, embeddable/implantable/gadget/instrument/equipment/device/apparatus/machine/controller/mechanical tool, garage-opener, key/plastic/payment/credit card/ticket, solar panel, key tracker, fire-extinguisher, garbage can/bin, WiFi-enabled device, smart device/machine/machinery/system/house/office/building/warehouse/facility/vehicle/car/bicycle/motorcycle/boat/vessel/airplane/cart/wagon, home/vehicle/office/factory/building/manufacturing/production/computing/security/another device.

One/two/more of Type 1/Type2/portable/nearby/another device/server may determine an initial characteristics/STI/MI of object, and/or may share intermediate information. One of Type1/Type2 device may move with object (e.g. “Tracker Bot”). The other one of Type 1/Type2 device may not move with object (e.g. “Origin Satellite”, “Origin Register”). Either may have known characteristics/STI/MI. Initial STI/MI may be computed based on known STI/MI.

Venue may be any space such as sensing area, room/house/home/office/workplace/building/facility/warehouse/factory/store/vehicle/property, indoor/outdoor/enclosed/semi-enclosed/open/semi-open/closed/over-air/floating/underground space/area/structure/enclosure, space/area with wood/glass/metal/material/structure/frame/beam/panel/column/wall/floor/door/ceiling/window/cavity/gap/opening/reflection/refraction medium/fluid/construction material/fixed/adjustable layout/shape, human/animal/plant body/cavity/organ/bone/blood/vessel/air-duct/windpipe/teeth/soft/hard/rigid/non-rigid tissue, manufacturing/repair/maintenance/mining/parking/storage/transportation/shipping/logistic/sports/entertainment/amusement/public/recreational/government/community/seniors/elderly care/geriatric/space facility/terminal/hub, distribution center/store, machine/engine/device/assembly line/workflow, urban/rural/suburban/metropolitan area, staircase/escalator/elevator/hallway/walkway/tunnel/cave/cavern/channel/duct/pipe/tube/lift/well/pathway/roof/basement/den/alley/road/path/highway/sewage/ventilation system/network, car/truck/bus/van/container/ship/boat/submersible/train/tram/airplane/mobile home, stadium/city/playground/park/field/track/court/gymnasium/hall/mart/market/supermarket/plaza/square/construction site/hotel/museum/school/hospital/university/garage/mall/airport/train/bus station/terminal/hub/platform, valley/forest/wood/terrain/landscape/garden/park/patio/land, and/or gas/oil/water pipe/line. Venue may comprise inside/outside of building/facility. Building/facility may have one/multiple floors, with a portion underground.

A event may be monitored based on TSCI. Event may be object/motion/gesture/gait related, such as fall-down, rotation/hesitation/pause, impact (e.g. person hitting sandbag/door/bed/window/chair/table/desk/cabinet/box/another person/animal/bird/fly/ball/bowling/tennis/soccer/volley ball/football/baseball/basketball), two-body action (e.g. person releasing balloon/catching fish/molding clay/writing paper/typing on computer), car moving in garage, person carrying smart phone/walking around venue, autonomous/moveable object/machine moving around (e.g. vacuum cleaner/utility/self-driving vehicle/car/drone).

Task may comprise: (a) sensing task, any of: monitoring/sensing/detection/recognition/estimation/verification/identification/authentication/classification/locationing/guidance/navigation/tracking/counting of/in any of: object/objects/vehicle/machine/tool/human/baby/elderly/patient/intruder/pet presence/proximity/activity/daily-activity/well-being/breathing/vital sign/heartbeat/health condition/sleep/sleep stage/walking/location/distance/speed/acceleration/navigation/tracking/exercise/safety/danger/fall-down/intrusion/security/life-threat/emotion/movement/motion/degree/pattern/periodic/repeated/cyclo-stationary/stationary/regular/transient/sudden/suspicious motion/irregularity/trend/change/breathing/human biometrics/environment informatics/gait/gesture/room/region/zone/venue, (b) computation task, any of: signal processing/preprocess/postprocessing/conditioning/denoising/calibration/analysis/feature extraction/transformation/mapping/supervised/unsupervised/semi-supervised/discriminative/machine/deep learning/training/clustering/training/PCA/eigen-decomposition/frequency/time/functional decomposition/neural network/map-based/model-based processing/correction/geometry estimation/analytics computation, (c) IoT task, any of: smart task for venue/user/object/human/pet/house/home/office/workplace/building/facility/warehouse/factory/store/vehicle/property/structure/assembly-line/loT/device/system, energy/power management/transfer, wireless power transfer, interacting/engage with user/object/intruder/human/animal (e.g. presence/motion/gesture/gait/activity/behavior/voice/command/instruction/query/music/sound/image/vide o/location/movement/danger/threat detection/recognition/monitoring/analysis/response/execution/synthesis, generate/retrieve/play/display/render/synthesize dialog/exchange/response/presentation/experience/media/multimedia/expression/sound/speech/music/image/imaging/video/animation/webpage/text/message/notification/reminder/enquiry/warning, detect/recognize/monitor/interpret/analyze/record/store user/intruder/object input/motion/gesture/location/activity), activating/controlling/configuring (e.g. turn on/off/control/lock/unlock/open/close/adjust/configure) a device/system (e.g. vehicle/drone/electrical/mechanical/air-conditioning/heating/lighting/ventilation/clearning/entertainment/loT/security/siren/access system/device/door/window/garage/lift/elevator/escalator/speaker/television/light/peripheral/accessory/wearable/furniture/appliance/amenity/gadget/alarm/camera/gaming/coffee/cooking/heater/fan/housekeeping/home/office machine/device/robot/vacuum cleaner/assembly line), (d) miscellaneous task, any of: transmission/coding/encryption/storage/analysis of data/parameters/analytics/derived data, upgrading/administration/configuration/coordination/broadcasting/synchronization/networking/encryption/communication/protection/compression/storage/database/archiving/query/cloud computing/presentation/augmented/virtual reality/other processing/task. Task may be performed by some of: Type1/Type2/nearby/portable/another device, and/or hub/local/edge/cloud server.

Task may also comprise: detect/recognize/monitor/locate/interpret/analyze/record/store user/visitor/intruder/object/pet, interact/engage/converse/dialog/exchange with user/object/visitor/intruder/human/baby/pet, detect/locate/localize/recognize/monitor/analyze/interpret/learn/train/respond/execute/synthesize/generate/record/store/summarize health/well-being/daily-life/activity/behavior/pattern/exercise/food-intake/restroom visit/work/play/rest/sleep/relaxation/danger/routine/timing/habit/trend/normality/normalcy/anomaly/regularity/irregularity/change/presence/motion/gesture/gait/expression/emotion/state/stage/voice/command/instruction/question/query/music/sound/location/movement/fall-down/threat/discomfort/sickness/environment/, generate/retrieve/play/display/render/synthesize dialog/exchange/response/presentation/report/experience/media/multimedia/expression/sound/speech/music/image/imaging/video/animation/webpage/t ext/message/notification/reminder/enquiry/warning, detect/recognize/monitor/interpret/analyze/record/store user/intruder/object input/motion/gesture/location/activity), detect/check/monitor/locate/manage/control/adjust/configure/lock/unlock/arm/disarm/open/close/fully/partially/activat c/turn on/off some system/device/object (e.g. vehicle/robot/drone/electrical/mechanical/air-conditioning/heating/ventilation/HVAC/lighting/cleaning/entertainment/loT/security/siren/access systems/devices/items/components, door/window/garage/lift/elevator/escalator/speaker/television/light/peripheral/accessory/wearable/furniture/appliance/amenity/gadget/alarm/camera/gaming/c offec/cooking/heater/fan/housekeeping/home/office machine/device/vacuum cleaner/assembly line/window/garage/door/blind/curtain/panel/solar panel/sun shade), detect/monitor/locate user/pet do something (e.g. sitting/sleeping on sofa/in bedroom/running on treadmill/cooking/watching TV/eating in kitchen/dining room/going upstairs/downstairs/outside/inside/using rest room), do something (e.g. generate message/response/warning/clarification/notification/report) automatically upon detection, do something for user automatically upon detecting user presence, turn on/off/wake/control/adjust/dim light/music/radio/TV/HiFi/STB/computer/speaker/smart device/air-conditioning/ventilation/heating system/curtains/light shades, turn on/off/pre-heat/control coffee-machine/hot-water-pot/cooker/oven/microwave oven/another cooking device, check/manage temperature/setting/weather forecast/telephone/message/mail/system check, present/interact/engage/dialog/converse (e.g. through smart speaker/display/screen; via webpage/email/messaging system/notification system).

When user arrives home by car, task may be to, automatically, detect user/car approaching, open garage/door upon detection, turn on driveway/garage light as user approaches garage, and/or turn on air conditioner/heater/fan. As user enters house, task may be to, automatically, turn on entrance light/off driveway/garage light, play greeting message to welcome user, turn on user's favorite music/radio/news/channel, open curtain/blind, monitor user's mood, adjust lighting/sound environment according to mood/current/imminent event (e.g. do romantic lighting/music because user is scheduled to cat dinner with girlfriend soon) on user's calendar, warm food in microwave that user prepared in morning, do diagnostic check of all systems in house, check weather forecast for tomorrow/news of interest to user, check calendar/to-do list, play reminder, check telephone answering/messaging system/email, give verbal report using dialog system/speech synthesis, and/or remind (e.g. using audible tool such as speakers/HiFi/speech synthesis/sound/field/voice/music/song/dialog system, using visual tool such as TV/entertainment system/computer/notebook/tablet/display/light/color/brightness/patterns symbols, using haptic/virtual reality/gesture/tool, using smart device/appliance/material/furniture/fixture, using server/hub device/cloud/fog/edge server/home/mesh network, using messaging/notification/communication/scheduling/email tool, using UI/GUI, using scent/smell/fragrance/taste, using neural/nervous system/tool, or any combination) user of someone's birthday/call him, prepare/give report. Task may turn on air conditioner/heater/ventilation system in advance, and/or adjust temperature setting of smart thermostat in advance. As user moves from entrance to living room, task may be to turn on living room light, open living room curtain, open window, turn off entrance light behind user, turn on TV/set-top box, set TV to user's favorite channel, and/or adjust an appliance according to user's preference/conditions/states (e.g. adjust lighting, choose/play music to build romantic atmosphere).

When user wakes up in morning, task may be to detect user moving around in bedroom, open blind/curtain/window, turn off alarm clock, adjust temperature from night-time to day-time profile, turn on bedroom light, turn on restroom light as user approaches restroom, check radio/streaming channel and play morning news, turn on coffee machine, preheat water, and/or turn off security system. When user walks from bedroom to kitchen, task may be to turn on kitchen/hallway lights, turn off bedroom/restroom lights, move music/message/reminder from bedroom to kitchen, turn on kitchen TV, change TV to morning news channel, lower kitchen blind, open kitchen window, unlock backdoor for user to check backyard, and/or adjust temperature setting for kitchen.

When user leaves home for work, task may be to detect user leaving, play farewell/have-a-good-day message, open/close garage door, turn on/off garage/driveway light, close/lock all windows/doors (if user forgets), turn off appliance (e.g. stove/microwave/oven), turn on/arm security system, adjust light/air-conditioning/heating/ventilation systems to “away” profile to save energy, and/or send alerts/reports/updates to user's smart phone.

Motion may comprise any of: no-motion, motion sequence, resting/non-moving motion, movement/change in position/location, daily/weekly/monthly/yearly/repeating/activity/behavior/action/routine, transient/time-varying/fall-down/repeating/repetitive/periodic/pseudo-periodic motion/breathing/heartbeat, deterministic/non-deterministic/probabilistic/chaotic/random motion, complex/combination motion, non-/pseudo-/cyclo-/stationary random motion, change in electro-magnetic characteristics, human/animal/plant/body/machine/mechanical/vehicle/drone motion, air-/wind-/weather-/water-/fluid-/ground/sub-surface/seismic motion, man-machine interaction, normal/abnormal/dangerous/warning/suspicious motion, imminent/rain/fire/flood/tsunami/explosion/collision, head/facial/eye/mouth/tongue/neck/finger/hand/arm/shoulder/upper/lower/body/chest/abdominal/hip/leg/foot/joint/knee/elbow/skin/below-skin/subcutaneous tissue/blood vessel/intravenous/organ/heart/lung/stomach/intestine/bowel/eating/breathing/talking/singing/dancing/coordinated motion, facial/eye/mouth expression, and/or hand/arm/gesture/gait/UI/keystroke/typing stroke.

Type 1/Type2 device may comprise heterogeneous IC, low-noise amplifier (LNA), power amplifier, transmit-receive switch, media access controller, baseband radio, and/or 2.4/3.65/4.9/5/6/sub-7/over-7/28/60/76 GHz/another radio. Heterogeneous IC may comprise processor/memory/software/firmware/instructions. It may support broadband/wireless/mobile/mesh/cellular network. WLAN/WAN/MAN, standard/IEEE/3GPP/WiFi/4G/LTE/5G/6G/7G/8G, IEEE 802.11/a/b/g/n/ac/ad/af/ah/ax/ay/az/be/bf/15/16, and/or Bluetooth/BLE/NFC/Zigbee/WiMax.

Processor may comprise any of: general-/special-/purpose/embedded/multi-core processor, microprocessor/microcontroller, multi-/parallel/CISC/RISC processor, CPU/GPU/DSP/ASIC/FPGA, and/or logic circuit. Memory may comprise non-/volatile, RAM/ROM/EPROM/EEPROM, hard disk/SSD, flash memory, CD-/DVD-ROM, magnetic/optical/organic/storage system/network, network/cloud/edge/local/external/internal storage, and/or any non-transitory storage medium. Set of instructions may comprise machine executable codes in hardware/IC/software/firmware, and may be embedded/pre-loaded/loaded upon-boot-up/on-the-fly/on-demand/pre-installed/installed/downloaded.

Processing/preprocessing/postprocessing may be applied to data (e.g. TSCI/feature/characteristics/STI/MI/test quantity/intermediate/data/analytics) and may have multiple steps. Step/pre-/post-/processing may comprise any of: computing function of operands/LOS/non-LOS/single-link/multi-link/component/item/quantity, magnitude/norm/phase/feature/energy/timebase/similarity/distance/characterization score/measure computation/extraction/correction/cleaning, linear/nonlinear/FIR/IIR/MA/AR/ARMA/Kalman/particle filtering, lowpass/bandpass/highpass/median/rank/quartile/percentile/mode/selective/adaptive filtering, interpolation/intrapolation/extrapolation/decimation/subsampling/upsampling/resampling, matched filtering/enhancement/restoration/denoising/smoothing/conditioning/spectral analysis/mean subtraction/removal, linear/nonlinear/inverse/frequency/time transform, Fourier transform (FT)/DTFT/DFT/FFT/wavelet/Laplace/Hilbert/Hadamard/trigonometric/sine/cosine/DCT/power-of-2/sparse/fast/frequency transform, zero/cyclic/padding, graph-based transform/processing, decomposition/orthogonal/non-orthogonal/over-complete projection/eigen-decomposition/SVD/PCA/ICA/compressive sensing, grouping/folding/sorting/comparison/soft/hard/thresholding/clipping, first/second/high order derivative/integration/convolution/multiplication/division/addition/subtraction, local/global/maximization/minimization, recursive/iterative/constrained/batch processing, least mean square/absolute error/deviation, cost function optimization, neural network/detection/recognition/classification/identification/estimation/labeling/association/tagging/mapping/remapping/training/clustering/machine/supervised/unsupervised/semi-supervised learning/network, vector/quantization/encryption/compression/matching pursuit/scrambling/coding/storing/retrieving/transmitting/receiving/time-domain/frequency-domain/normalization/scaling/expansion/representing/merging/combining/splitting/tracking/monitoring/shape/silhouette/motion/activity/analysis, pdf/histogram estimation/importance/Monte Carlo sampling, error detection/protection/correction, doing nothing, time-varying/adaptive processing, conditioning/weighted/averaging/over selected components/links, arithmetic/geometric/harmonic/trimmed mean/centroid/medoid computation, morphological/logical operation/permutation/combination/sorting/AND/OR/XOR/union/intersection, vector operation/addition/subtraction/multiplication/division, and/or another operation. Processing may be applied individually/jointly. Acceleration using GPU/DSP/coprocessor/multicore/multiprocessing may be applied.

Function may comprise: characteristics/feature/magnitude/phase/energy, scalar/vector/discrete/continuous/polynomial/exponential/logarithmic/trigonometric/transcendental/logical/piecewise/linear/algebraic/nonlinear/circular/piecewise linear/real/complex/vector-valued/inverse/absolute/indicator/limiting/floor/rounding/sign/composite/sliding/moving function, derivative/integration, function of function, one-to-one/one-to-many/many-to-one/many-to-many function, mean/mode/median/percentile/max/min/range/statistics/histogram, local/global max/min/zero-crossing, variance/variation/spread/dispersion/deviation/standard deviation/divergence/range/interquartile range/total variation/absolute/total deviation, arithmetic/geometric/harmonic/trimmed mean/square/cube/root/power, thresholding/clipping/rounding/truncation/quantization/approximation, time function processed with an operation (e.g. filtering), sine/cosine/tangent/cotangent/secant/cosecant/elliptical/parabolic/hyperbolic/game/zeta function, probabilistic/stochastic/random/ergodic/stationary/deterministic/periodic/repeated function, inverse/transformation/frequency/discrete time/Laplace/Hilbert/sine/cosine/triangular/wavelet/integer/power-of-2/sparse transform, orthogonal/non-orthogonal/eigen projection/decomposition/eigenvalue/singular value/PCA/ICA/SVD/compressive sensing, neural network, feature extraction, function of moving window of neighboring items of time series, filtering function/convolution, short-time/discrete transform/Fourier/cosine/sine/Hadamard/wavelet/sparse transform, matching pursuit, approximation, graph-based processing/transform/graph signal processing, classification/identification/class/group/category/labeling, processing/preprocessing/postprocessing, machine/learning/detection/estimation/feature extraction/learning network/feature extraction/denoising/signal enhancement/coding/encryption/mapping/vector quantization/remapping/lowpass/highpass/bandpass/matched/Kalman/particle/FIR/IIR/MA/AR/ARMA/median/mode/adaptive filtering, first/second/high order derivative/integration/zero crossing/smoothing, up/down/random/importance/Monte Carlo sampling/resampling/converting, interpolation/extrapolation, short/long term statistics/auto/cross correlation/moment generating function/time averaging/weighted averaging, special/Bessel/Beta/Gamma/Gaussian/Poisson/integral complementary error function.

Sliding time window may have time-varying width/size. It may be small/large at beginning to enable fast/accurate acquisition and increase/decrease over time to steady-state size comparable to motion frequency/period/transient motion duration/characteristics/STI/MI to be monitored. Window size/time shift between adjacent windows may be constant/adaptively/dynamically/automatically changed/adjusted/varied/modified (e.g. based on battery life/power consumption/available computing power/change in amount of targets/nature of motion to be monitored/user request/choice/instruction/command).

Characteristics/STI/MI may be determined based on characteristic value/point of function and/or associated argument of function (e.g. time/frequency). Function may be outcome of a regression. Characteristic value/point may comprise local/global/constrained/significant/first/second/i\hat{ }th maximum/minimum/extremum/zero-crossing (e.g. with positive/negative time/frequency/argument) of function. Local signal-to-noise-ratio (SNR) or SNR-like parameter may be computed for each pair of adjacent local max (peak)/local min (valley) of function, which may be some function (e.g. linear/log/exponential/monotonic/power/polynomial) of fraction or difference of a quantity (e.g. power/magnitude) of local max over the quantity of local min. Local max (or min) may be significant if its SNR is greater than threshold and/or if its amplitude is greater (or smaller) than another threshold. Local max/min may be selected/identified/computed using persistence-based approach. Some significant local max/min may be selected based on selection criterion (e.g. quality criterion/condition, strongest/consistent significant peak in a range). Unselected significant peaks may be stored/monitored as “reserved” peaks for use in future selection in future sliding time windows. E.g. a particular peak (e.g. at particular argument/time/frequency) may appear consistently over time. Initially, it may be significant but not selected (as other peaks may be stronger). Later, it may become stronger/dominant consistently. When selected, it may be back-traced in time and selected in earlier time to replace previously selected peaks (momentarily strong/dominant but not persistent/consistent). Consistency of peak may be measured by trace, or duration of being significant. Alternatively, local max/min may be selected based on finite state machine (FSM). Decision thresholds may be time-varying, adjusted adaptively/dynamically (e.g. based on back-tracing timing/FSM, or data distribution/statistics).

A similarity score (SS)/component SS may be computed based on two temporally adjacent CI/CIC, of one TSCI or of two different TSCI. The pair may come from same/different sliding window(s). SS or component SS may comprise: time reversal resonating strength (TRRS), auto/cross correlation/covariance, inner product of two vectors, L1/L2/Lk/Euclidean/statistical/weighted/distance score/norm/metric/quality metric, signal quality condition, statistical characteristics, discrimination score, neural network/deep learning network/machine learning/training/discrimination/weighted averaging/preprocessing/denoising/signal conditioning/filtering/time correction/timing compensation/phase offset compensation/transformation/component-wise operation/feature extraction/FSM, and/or another score.

Any threshold may be fixed (e.g. 0, 0.5, 1, 1.5, 2), pre-determined and/or adaptively/dynamically determined (e.g. by FSM, or based on time/space/location/antenna/path/link/state/battery life/remaining battery life/available resource/power/computation power/network bandwidth). Threshold may be applied to test quantity to differentiate two events/conditions/situations/states, A and B. Data (e.g. CI/TSCI/feature/similarity score/test quantity/characteristics/STI/MI) may be collected under A/B in training situation. Test quantity (e.g. its distribution) computed based on data may be compared under A/B to choose threshold based on some criteria (e.g. maximum likelihood (ML), maximum aposterior probability (MAP), discriminative training, minimum Type 1 (or 2) error for given Type 2 (or 1) error, quality criterion, signal quality condition). Threshold may be adjusted (e.g. to achieve different sensitivity), automatically/semi-automatically/manually/adaptively/dynamically, once/sometimes/often/periodically/repeatedly/occasionally/sporadically/on-demand (e.g. based on object/movement/location direction/action/characteristics/STI/MI/size/property/trait/habit/behavior/venue/feature/fixture/furniture/barrier/material/machine/living thing/thing/boundary/surface/medium/map/constraint/model/event/state/situation/condition/time/timing/duration/state/history/u ser/preference). An iterative algorithm may stop after N iterations, after time-out period, or after test quantity satisfies a condition (e.g. updated quantity greater than threshold) which may be fixed/adaptively/dynamically adjusted.

Searching for local extremum may comprise constrained/minimization/maximization, statistical/dual/constraint/convex/global/local/combinatorial/infinite-dimensional/multi-objective/multi-modal/non-differentiable/particle-swarm/simulation-based optimization, linear/nonlinear/quadratic/higher-order regression, linear/nonlinear/stochastic/constraint/dynamic/mathematical/disjunctive/convex/semidefinite/conic/cone/interior/fractional/integer/sequential/quadratic programming, conjugate/gradient/subgradient/coordinate/reduced descent, Newton's/simplex/iterative/point/ellipsoid/quasi-Newton/interpolation/memetic/genetic/evolutionary/pattern-/gravitational-search method/algorithm, constraint satisfaction, calculus of variations, optimal control, space mapping, heuristics/metaheuristics, numerical analysis, simultaneous perturbation stochastic approximation, stochastic tunneling, dynamic relaxation, hill climbing, simulated annealing, differential evolution, robust/line/Tabu/reactive search/optimization, curve fitting, least square, variational calculus, and/or variant. It may be associated with an objective/loss/cost/utility/fitness/energy function.

Regression may be performed using regression function to fit data, or function (e.g. ACF/transform/mapped) of data, in regression window. During iterations, length/location of regression window may be changed. Regression function may be linear/quadratic/cubic/polynomial/another function. Regression may minimize any of: mean/weighted/absolute/square deviation, error, aggregate/component/weighted/mean/sum/absolute/square/high-order/another error/cost (e.g. in projection domain/selected axes/orthogonal axes), robust error (e.g. first error (e.g. square) for smaller error magnitude, second error (e.g. absolute) for larger error magnitude), and/or weighted sum/mean of multiple errors (e.g. absolute/square error). Error associated with different links/path may have different weights (e.g. link with less noise may have higher weight). Regression parameter (e.g. time-offset associated with max/min regression error of regression function in regression window, location/width of window) may be initialized and/or updated during iterations (e.g. based on target value/range/profile, characteristics/STI/MI/test quantity, object motion/quantity/count/location/state, past/current trend, location/amount/distribution of local extremum in previous windows, carrier/subcarrier frequency/bandwidth of signal, amount of antennas associated with the channel, noise characteristics, histogram/distribution/central/F-distribution, and/or threshold). When converged, current time offset may be at center/left/right (or fixed relative location) of regression window.

In presentation, information may be displayed/presented (e.g. with venue map/environmental model). Information may comprise: current/past/corrected/approximate/map/location/speed/acceleration/zone/region/area/segmentation/coverage-area, direction/path/trace/history/traffic/summary, frequently-visited areas, customer/crowd event/distribution/behavior, crowd-control information, acceleration/speed/vital-sign/breathing/heart-rate/activity/emotion/sleep/state/rest information, motion-statistics/MI/STI, presence/absence of motion/people/pets/object/vital sign, gesture (e.g. hand/arm/foot/leg/body/head/face/mouth/eye)/meaning/control (control of devices using gesture), location-based gesture-control/motion-interpretation, identity/identifier (ID) (e.g. of object/person/user/pet/zone/region, device/machine/vehicle/drone/car/boat/bicycle/TV/air-con/fan/, self-guided machine/device/vehicle), environment/weather information, gesture/gesture control/motion trace, earthquake/explosion/storm/rain/fire/temperature, collision/impact/vibration, event/door/window/open/close/fall-down/accident/burning/freezing/water-/wind-/air-movement event, repeated/pseudo-periodic event (e.g. running on treadmill, jumping up/down, skipping rope, somersault), and/or vehicle event. Location may be one/two/three dimensional (e.g. expressed/represented as 1D/2D/3D rectangular/polar coordinates), relative (e.g. w.r.t. map/environmental model) or relational (e.g. at/near/distance-from a point, halfway between two points, around corner, upstairs, on table top, at ceiling, on floor, on sofa).

Information (e.g. location) may be marked/displayed with some symbol. Symbol may be time-varying/flashing/pulsating with changing color/intensity/size/orientation. Symbol may be a number reflecting instantaneous quantity (e.g. analytics/gesture/state/status/action/motion/breathing/heart rate, temperature/network traffic/connectivity/remaining power). Symbol/size/orientation/color/intensity/rate/characteristics of change may reflect respective motion. Information may be in text or presented visually/verbally (e.g. using pre-recorded voice/voice synthesis)/mechanically (e.g. animated gadget, movement of movable part).

User device may comprise smart phone/tablet/speaker/camera/display/TV/gadget/vehicle/appliance/device/loT, device with UI/GUI/voice/audio/record/capture/sensor/playback/display/animation/VR/AR (augmented reality)/voice (assistance/recognition/synthesis) capability, and/or tablet/laptop/PC.

Map/floor plan/environmental model (e.g. of home/office/building/store/warehouse/facility) may be 2-/3-/higher-dimensional. It may change/evolve over time (e.g. rotate/zoom/move/jump on screen). Walls/windows/doors/entrances/exits/forbidden areas may be marked. It may comprise multiple layers (overlays). It may comprise maintenance map/model comprising water pipes/gas pipes/wiring/cabling/air ducts/crawl-space/ceiling/underground layout.

Venue may be segmented/subdivided/zoned/grouped into multiple zones/regions/sectors/sections/territories/districts/precincts/localities/neighborhoods/areas/stretches/expance such as bedroom/living/dining/rest/storage/utility/warehouse/conference/work/walkway/kitchen/foyer/garage/first/second floor/offices/reception room/area/regions. Segments/regions/areas may be presented in map/floor plan/model with presentation characteristic (e.g. brightness/intensity/luminance/color/chrominance/texture/animation/flashing/rate).

An example of disclosed system/apparatus/method. Stephen and family want to install disclosed wireless motion detection system to detect motion in their 2000 sqft two-storey town house in Seattle, Washington. Because his house has two storeys, Stephen decides to use one Type2 device (named A) and two Type1 devices (named B and C) in ground floor. His ground floor has three rooms: kitchen, dining and living rooms arranged in straight line, with dining room in middle. He put A in dining room, and B in kitchen and C in living room, partitioning ground floor into 3 zones (dining room, living room, kitchen). When motion is detected by AB pair and/or AC pair, system would analyze TSCI/feature/characteristics/STI/MI and associate motion with one of 3 zones.

When Stephen and family go camping in holiday, he uses mobile phone app (e.g. Android phone app or iPhone app) to turn on motion detection system. If system detects motion, warning signal is sent to Stephen (e.g. SMS, email, push message to mobile phone app). If Stephen pays monthly fee (e.g. $10/month), a service company (e.g. security company) will receive warning signal through wired (e.g. broadband)/wireless (e.g. WiFi/LTE/5G) network and perform security procedure (e.g. call Stephen to verify any problem, send someone to check on house, contact police on behalf of Stephen).

Stephen loves his aging mother and cares about her well-being when she is alone in house. When mother is alone in house while rest of family is out (e.g. work/shopping/vacation), Stephen turns on motion detection system using his mobile app to ensure mother is ok. He uses mobile app to monitor mother's movement in house. When Stephen uses mobile app to see that mother is moving around house among the three regions, according to her daily routine, Stephen knows that mother is ok. Stephen is thankful that motion detection system can help him monitor mother's well-being while he is away from house.

On typical day, mother would wake up at 7 am, cook her breakfast in kitchen for 20 minutes, cat breakfast in dining room for 30 minutes. Then she would do her daily exercise in living room, before sitting down on sofa in living room to watch favorite TV show. Motion detection system enables Stephen to see timing of movement in 3 regions of house. When motion agrees with daily routine, Stephen knows roughly that mother should be doing fine. But when motion pattern appears abnormal (e.g. no motion until 10 am, or in kitchen/motionless for too long), Stephen suspects something is wrong and would call mother to check on her. Stephen may even get someone (e.g. family member/neighbor/paid personnel/friend/social worker/service provider) to check on mother.

One day Stephen feels like repositioning a device. He simply unplugs it from original AC power plug and plugs it into another AC power plug. He is happy that motion detection system is plug-and-play and the repositioning does not affect operation of system. Upon powering up, it works right away.

Sometime later, Stephen decides to install a similar setup (i.e. one Type2 and two Type 1 devices) in second floor to monitor bedrooms in second floor. Once again, he finds that system set up is extremely easy as he simply needs to plug Type2 device and Type1 devices into AC power plug in second floor. No special installation is needed. He can use same mobile app to monitor motion in both ground/second floors. Each Type2 device in ground/second floors can interact with all Type1 devices in both ground/second floors. Stephen has more than double capability with combined systems.

Disclosed system can be applied in many applications. Type 1/Type2 devices may be any WiFi-enabled devices (e.g. smart IoT/appliance/TV/STB/speaker/refrigerator/stove/oven/microwave/fan/heater/air-con/router/phone/computer/tablet/accessory/plug/pipe/lamp/smoke detector/furniture/fixture/shelf/cabinet/door/window/lock/sofa/table/chair/piano/utensil/wearable/watch/tag/key/ticket/belt/wallet/pen/hat/necklace/implantable/phone/eyeglasses/glass panel/gaming device) at home/office/facility, on table, at ceiling, on floor, or at wall. They may be placed in conference room to count people. They may form a well-being monitoring system to monitor daily activities of older adults and detect any sign of symptoms (e.g. dementia, Alzheimer's disease). They may be used in baby monitors to monitor vital signs (breathing) of babies. They may be placed in bedrooms to monitor sleep quality and detect any sleep apnea. They may be placed in cars to monitor well-being of passengers and drivers, detect sleepy drivers or babies left in hot cars. They may be used in logistics to prevent human trafficking by monitoring any human hidden in trucks/containers. They may be deployed by emergency service at disaster area to search for trapped victims in debris. They may be deployed in security systems to detect intruders.

In some embodiments, the present disclosure discloses deep learning based wireless sensing using a foundation model (FM). In some embodiments, a deep neural network (DNN; or deep learning network, or network of neural networks)/model/FM/LLM may be used as a classifier/detector to classify/detect input into a number of outcome classes. The classifier/detector may comprise a neural network-based feature extraction module (or stage-1 network) followed by a neural network-based classifier/detector module (or stage-2 network). The feature extraction module may be a convolutional neural network (CNN) with N₂ layers, each layer with multiple associated convolution filters. The convolution filters may be applied (separately/independently) to each of a plurality of input matrices. Down-sampling may be applied. The classifier/detector/DNN/model/FM/LLM module may comprise one of: feedforward neural network (FNN), fully-connected network (FCN), convolutional neural network (CNN), recurrent neural network (RNN), long short-term memory (LSTM), or transformer. An input to the DNN/model/FM/LLM may be computed/generated/prepared based on a plurality of the 1D transform (at some granularity/granularities).

In some examples, some variables used in the present disclosure may include: N1 TSCI (although N1 may be different for different situations/setups/venues, DL may expect M1 TSCI, where M1 may be larger/smaller than or equal to N1), N2 layer of CNN (M2), N3 layer of FCN (M3), N4 CIC of each CI (M4), N5 CI in a time period (M5), N6 pairs from N1 TSCI (M6), N7 TX antenna, N8 RX antenna, N9 sliding time window in time period (M9), N10 device-pair of Type 1/Type2 devices (M10), N11-point 1D transform (M11), N12 (out of N4) selected CIC (or per-component 1D transform) to compute per-TSCI 1D transform, N13-point resampling (from N11 point), N14 (out of N1) selected per-TSCI 1D transform to compute per-device-pair 1D transform.

In some examples, a wireless sensing system may include N10 TX-RX device pairs, N1 TSCI/pair, N4 CIC/CI. For example, in the wireless sensing system there may be N10 TX-RX device-pairs in a venue, each TX-RX device pair of the system comprising a respective Type1 heterogeneous wireless device (TX device) of the system and a respective Type2 heterogeneous wireless device (RX device) of the system working together to perform at least one wireless sensing task (e.g. occupancy/presence detection/learning/supervised learning/unsupervised learning/self-supervised learning/generative pretext task based on restoration/feature learning/feature similarity as pretext task/task transfer/contrastive learning, or more than one tasks/subtasks). A wireless sensing task may be performed in a robust, environmentally independent manner (e.g. for any N10, for any TX-RX device pair with any bandwidth/modulation, for any placement/orientation of TX/RX devices, for TX/RX devices with any amount of antennas, for any venue, etc.).

For each TX-RX device-pair, a respective wireless signal (e.g. WiFi signal, cellular signal, UWB, Bluetooth, radar signal, etc.) may be transmitted from a respective Type 1 device (TX) with respective N7 TX antennas to a respective Type2 device (RX) with respective N8 RX antennas through a respective wireless channel of a venue. A respective number, N1=N7*N8, of time series of channel information (TSCI, e.g. CSI, CIR, CFR, RSSI) of the respective wireless channel may be obtained/extracted from the respective received wireless signal by the respective Type2 device, each TSCI being associated with one of the N7 TX antennas and one of the N8 RX antennas.

In some cases, the TX antennas may be close to each other and the RX antennas may be also close to each other, such that all the N1 TSCI may be monitoring same objects/events in a same region/zone of a venue. Thus they may be analyzed together (e.g. by computing autocorrelation function (ACF) or short-time Fourier transform (STFT) based on all N1 TSCI) for a task.

In other cases, the TX antennas may be strategically placed at different locations/corners of the venue (e.g. different/adjacent/opposite corners of a car). Similarly, the RX antennas may be placed at different locations/corners of venue (e.g. different/adjacent/opposite corners in a car). The corresponding N1 TSCI may be used to monitor different regions/zones of the venue and/or same/different objects/motions/events. Thus, each of the N1 TSCI may be analyzed independently (e.g. by computing N1 ACF, each based on respective TSCI) for a task.

The TSCI may be preprocessed (e.g. denoising, phase cleaning, correction, compensation). Each channel information (CI) of the N1 TSCI may have respective N4 components (called “CI components” or CIC, e.g. the components may be multiple subcarriers in CFR, multiple taps in CIR). Each CI may be represented as a N4-tuple vector (each of the N4 vector component may be respective CI component, or a function (e.g. magnitude/magnitude square/phase or a function of them) of the respective CI component). N7, N8, N1 and/or N4 may be same/different for different device-pairs (e.g. different N1 due to different amount of TX/RX antennas of Type1/Type2 devices, different N4 due to different bandwidth of the wireless signals: 20/40/80/160/320/640 MHZ, etc.). The TSCI may be decomposed into N4 time series of CIC (TSCIC), each TSCIC associated with respective one of the N4 CIC of respective CI of TSCI. A feature of each CIC (such as magnitude, magnitude, phase, or a function of such) may be computed.

There may be multiple venues. Each venue may have respective N10 device-pairs. Different venues may have a different number of N10. Each device-pair may have respective N1 TSCI. Different device-pairs may have different N1. For each venue, there may be multiple states (e.g. no-presence, presence, no-motion, human-motion-in-kitchen, nonhuman-motion-in-kitchen, human-motion-in-living-room, nonhuman-motion-in-living-room, etc.). For the venue, multiple sets of respective N1 TSCI may be captured, each set for a respective state.

In some embodiments, the wireless sensing system may include deep learning based system blocks. A deep neural network (DNN) (e.g. deep learning (DL), FNN, FCN, CNN, RNN, LSTM, transformer, network, deep network, network of network, mixture of experts (MoE), model, foundation model (FM), and/or large language model (LLM), etc.) may be used to perform at least one wireless sensing task based on the respective N1 TSCI generated by the N10 TX-RX device-pairs. The wireless sensing system may comprise several major system blocks: (1) a TSCI generation block in which, for each of the N10 TX-RX device pair, respective N1 TSCI are generated by the respective receiver (RX) of the device-pair based on respective wireless signal transmitted from respective transmitter (TX) to the respective RX. N1 may be different for different device-pairs. (Different device-pairs may have same/different N1, same/different sounding frequency and/or same/different wireless signal bandwidth, resulting in same/different amount of CIC); (2) a data augmentation block in which augmented TSCI (comprising augmented CI and/or augmented CIC) are generated based on TSCI obtained in the CSI generation block and/or CSI preprocessing block. (The augmented TSCI may be used for generating augmented DNN-input for training/running DNN, e.g. in contrastive learning, predictive learning); (3) a TSCI preprocessing block in which, for each TX-RX device-pair, the respective N1 TSCI are converted/preprocessed into respective M1 regularized input TSCI which has standard/unified/regularized format/characteristics for the next block (embedding block). (The M1 may be same for all device-pairs. The M1 regularized input TCSI with the regularized format may be used by the embedding block to generate DNN-input for training/running DNN); (4) an embedding block in which, for each TX-RX device-pair, the respective M1 regularized input TSCI are used/processed to generate DNN-input (an embedding of preprocessed input) to be fed as input to the next block (DNN). (While TSCI of different device-pairs may have significantly different sampling characteristics/format (e.g. sounding rate, amount of CIC) unsuitable for the embedding block, the M1 regularized input TSCI with the regularized characteristics/format are readily used by embedding block. The DNN-input is in a format suitable for use by DNN); (5) a deep neural network (DNN) block which takes DNN-input as input and output a task result. The DNN may comprise any of: neural network (NN), feedforward NN (FNN), convolutional NN (CNN), recurrent NN (RNN), long-short term memory (LSTM), transformer, autoencoder, fully-connected (FCN), mixture of experts (MoE), generative adversarial network (GAN), network of networks, with associated model (AI model), foundation model (FM), and/or large language model (LLM).

In a training phase of the model of DNN, machine learning (e.g. supervised/unsupervised/self-supervised/meta learning, reinforced training, few-shot training, transfer learning, etc.) may be used to train the model of DNN (e.g. with a large set of model parameters) using a set (e.g. large set) of training data. The set of training data may comprise a set of TSCI obtained by various TX-RX device-pairs transmitting wireless signals with various characteristics (sounding rate, carrier frequency, bandwidth) in various venues under various events/conditions/states and measuring the TSCI based on the received wireless signals. There may be a wide variety of wireless devices in the device-pairs comprising access point (AP), client devices, IoT devices, consumer electronics, computing devices, smart device, vehicle devices, etc. The training data may/may not be labeled. In unsupervised training/self-supervised training, the training data may not include any label. In supervised training/reinforced/few-shot/meta/transfer training, some/all training data may be labeled. In machine learning, a loss function may be defined/computed and the parameters of the DNN model may be adjusted to optimize (e.g. minimize) the loss function.

In some embodiments, the DNN of the wireless sensing system may be trained using a combination of contrasting learning and predictive learning. The DNN may map each CI data to a latent/embedding point in a latent/embedding space. In contrastive learning, a contrastive loss function may be defined/computed based on a distance score/similarity score in latent space (embedding space) and may be minimized for the set of training data by adjusting the DNN model parameters. The DNN model parameters may be trained such that a pair of similar inputs (positive pair, e.g. two augmented inputs, or a TSCI and associated augmented TSCI, or a DNN-input and associated augmented DNN-input) may have a small distance score (or high similarity score) in latent/embedding space and thus a lower contrastive loss. A pair of dissimilar inputs (negative pair, e.g. two different TSCI associated with different events, or with different venue) should have a large distance (or small similarity score) and thus a larger contrastive loss.

In some embodiments, the DNN may generate a predicted CI data. In the predictive training, a reconstruction/prediction loss function (e.g. mean square error, MSE) may be defined/computed between a predicted CI data and an actual CI data, and may be minimized for the set of training data by adjusting the DNN model parameters.

In the wireless sensing system, a total loss function may be computed/defined as an aggregate (e.g. weighted sum or weighted product) of the contrastive loss function and the reconstruction loss function, and may be minimized. In the weighted sum/product of the two loss functions, the weight may be a fixed pre-defined value (e.g. 0.1/0.3/0.5/0.7/0.9) throughout the training. Alternatively, in the training, the weight may start with an initial value and may be changed gradually (e.g. according to a schedule, or controlled by a rate parameter) as the training proceeds (e.g. the weight changed from 0.1 gradually to 0.5).

In some embodiments, the system may have a cloud-edge architecture, where some system blocks (e.g. the TSCI generation block, the TSCI preprocessing block, the data augmentation block, and/or the embedding block) may be in the edge (e.g. a processor of an RX of a TX-RX device-pair, a local server or device) while some other blocks (e.g. the DNN block, the embedding block, the data augmentation block) may be in the cloud (e.g. in a cloud server).

In some examples, as transmission/storage of TSCI is tedious, time consuming, and very demanding on transmission resources/bandwidth and storage resources/memory, transmission of TSCI from edge to the cloud may be avoided by putting the TSCI generation block, the TSCI preprocessing block, the data augmentation block, and the embedding block in the edge, and by putting the DNN block in the cloud. All the immediate processing of any TSCI may be performed in the edge (e.g. processor associated with RX or edge server) to generate the DNN-input and augmented DNN-input. The DNN-input and augmented DNN-input may be transmitted to the cloud (cloud server). The DNN model with lots of parameters may be stored in the cloud, trained/fine-tuned in the cloud and run/executed in the cloud.

In some embodiments, the transmission of the DNN-input may still be considerable and significant. To avoid the transmission of DNN-input from the edge to the cloud, the DNN may further be decomposed into two stages: (1) a CNN to extract features from the DNN-input, and (2) another neural network (e.g. transformer, auto-encoder, FCN, RNN, LSTN) that takes the extracted features as input and output the task results. The stage-1 CNN used to extract features of DNN-input may further be placed in the edge, while the stage-2 neural network may be placed in the cloud. The extracted features by the stage-1 CNN may be transmitted from the edge to the cloud. Typically, a transmission of the extracted features may be much less demanding (e.g. in terms of bandwidth, time delay, memory storage) than the transmission of the DNN-input.

In some cases, for each TX-RX device-pair, transmission of DNN-input/augmented DNN-input, or transmission of the extract features, from the edge (e.g. from the RX of the device-pair) to the cloud may be further reduced by performing a motion detection locally in the edge (e.g. by a motion detection module of the RX of the device-pair) based on the N1 TSCI (without using the DNN). The DNN-input or extracted features may be transmitted only if motion is detected by the motion detection module. In a motion detection task, a similarity score between two temporally adjacent CI of a TSCI may be computed. Motion may be detected when the similarity score is greater than a threshold.

In some embodiments. “DNN-input” (or embedding) may generated from M1 “regularized” “input” TSCI for deep neural network (DNN). A deep neural network (DNN) (e.g. deep learning (DL), FNN, FCN, CNN, RNN, LSTM, transformer, network, deep network, network of network, mixture of experts (MoE), model, foundation model (FM), and/or large language model (LLM), etc.) may be used to perform at least one wireless sensing task based on a formatted input called “DNN-input” (with a certain format for the DNN, e.g. k-D matrix, k-D transform matrix) generated/formatted/constructed from multiple CI/TSCI. In deep learning (e.g. training/running/re-training/fine-tuning DNN), M1 regularized “input” TSCI (with associated regularized “input” sampling frequency being MF1, i.e. regularized “input” CI of each regularized “input” TSCI being sampled as MF1 sample/second) may be used/needed/required/expected/supposed to be used in each input instance to construct the DNN-input. The CI of each of the M1 regularized “input” TSCI may be needed/required/expected/supposed to have M4 regularized “input” CIC. (The M1 regularized input TSCI may be obtained/constructed from the N1 TSCI associated with one TX-RX device pair, or from respective N1 TSCI associated with multiple TX-RX device pairs in the venue and/or additional venues.) There may be a time series of DNN-input. In each input instance, the M1 regularized input TSCI (e.g. all regularized input CI of the M1 regularized input TSCI in a sliding time window) may be used to generate/construct/assemble at least one “DNN-input” to the DNN (e.g. for training the DNN in a training phase, or to be processed/analyzed by the DNN to perform the at least one task).

In some embodiments, the DNN may be a mixture of expert (MoE), or an expert in a MoE. Different experts in a MoE may have/use the same DNN-input requirements/formats/definitions. Alternatively, different experts in MoE may use/have different DNN-input formats/requirements/definitions. For MoE, a device (e.g. an AP) may choose/decide/switch which one (or more) expert among a MoE is to be used/executed/called/chosen to process the M1 regularized input TSCI (or to process a sliding time window of the M1 regularized input TSCI), to generate/compute respective DNN-input associated with the chosen expert(s).

The DNN-input to the DNN may be generated by applying any of the following operations to the M1 regularized input TSCI: preprocessing/processing/postprocessing/filtering, resampling, feature extraction, transformation, 1D/2D/k-D transform at a granularity level, concatenating/combining/organizing/assembling to form a matrix, and/or another operation. The DNN-input may have fixed size (e.g. a 1D/2D/k-D matrix with fixed dimension and fixed size in each dimension). The fixed dimension and/or fixed size may be initialized/determined before the task. Alternatively, the DNN-input may have a flexible size which may be adaptively changed (e.g. changed during re-training/adaptation/learning/evolution in the task, change of task, and/or restriction to/emphasizing a particular subtask of the task).

In some embodiments, one or more of the dimensions/elements of the DNN-input may be masked (e.g. masked/forced to be or replaced by zero, or some predefined pattern). A DNN-input mask may be associated with the DNN-input to indicate which elements are valid or invalid. The DNN-input mask may have the same dimension and size as the DNN-input. Any DNN-input mask elements may be either “0” or “1”. A mask element of “1” may mean the corresponding element in the DNN-input may be valid and may be used by the DNN. A mask element of “0” may mean the corresponding element of the DNN-input is invalid and may be ignored by the DNN (or to be ignored in training/running/re-training/refinement of DNN). A logical operation (e.g. logical AND) may be performed between the mask element and corresponding DNN-input element to force the DNN-input element to be zero (or another default value). Alternatively, the DNN may choose to synthesize/generate a padded/replacement/synthesized value to take the place of an invalid DNN-input element.

In some cases, the mask elements may take on additional values. For example, a mask element of “2” which may mean the corresponding element in the DNN-input may be a generated element generated using some padding/synthesizing/interpolation/generation algorithm, and is to be used with caution by the DNN. In another example, a mask element of “3” may mean the corresponding element in the DNN-input may be preprocessed/filtered/cleaned/denoised/conditioned in some method. The mask may be input to the DNN (e.g. as meta data). The mask may be included as part of the DNN-input. For any DNN-input, the associated DNN-input mask may be used in the execution/running of the DNN. When a DNN-input element is associated with a DNN-input mask element of “1” (meaning “valid”), the DNN-input element may be “valid” and may be used (in a normal manner) in all the associated DNN links (connections) in the DNN block.

In some embodiments, a DNN-input element associated with a DNN-input mask element of “0” (meaning “invalid”) may be ignored/skipped/not-used in the associated DNN links in the DNN. Or equivalently, the DNN-input element may be “invalid” and may be forced to be a value (e.g. zero) so that it has no effect in the DNN. For any DNN links immediately connected to an “invalid” DNN-input element, model parameter associated with the “invalid” DNN-input element may be considered “invalid” momentarily for the DNN-input. The invalid DNN-links may be excluded in the computation of loss functions (e.g. contrastive loss function, reconstruction loss function, total loss function). In a training phase, back propagation may be used to propagate updated DNN model parameters in a backward manner. The DNN model parameters of the invalid links may not be updated for the DNN-input. The computation associated with the invalid DNN links may not be performed (or simply forced to be zero). Any node with all input links being invalid may be considered “invalid” momentarily for the DNN-input.

In some embodiments, masking may be performed in TSCI set. TSCI, or CI. There may be N1 TSCI associated with a TX-RX device pair, each TSCI with N5 CI in a time period, each CI with N4 CIC. From the N1 TSCI, M1 regularized input TSCI may be constructed, each regularized input TSCI with M5 regularized CI in the time period, each regularized CI with M4 CIC. Any of these items may be valid/invalid/missing/noisy. Respective masks may be constructed/computed/defined to mark corresponding states.

For TSCI-set mask, some TSCI in the set of N1 TSCI and/or the set of M1 regularized input TSCI may be invalid/missing/noisy/bad. Thus a TSCI-set mask comprising N1/M1 mask elements may be constructed/computed for the N1 TSCI/the M1 regularized input TSCI, each mask element associated with respective TSCI. Similar to the DNN-input mask elements, any TSCI-set mask element may be either “0” (to indicate invalid TSCI), or “1” (to indicate valid TSCI), or other logical flags/values such as “2” (e.g. to indicate “padded”, or “synthesized”, or “denoised”, or “processed” TSCI). Invalid TSCI may not be used, while valid TSCI may be. A synthesized/padded/denoised/processed/borrowed TSCI may be used/generated for and/or used to replace an invalid TSCI.

For TSCI mask, some of the N5/M5 CI may be missing/invalid in the time period in any of the N1 TSCI/the M1 regularized input TSCI. Thus a TSCI mask comprising N5/M5 mask elements may be constructed/computed for the N5/M5 CI in the respective TSCI, each TSCI mask element associated with respective CI in the time period. Similar to the DNN-input mask elements, any TSCI mask element may be either “0” (to indicate invalid CI), or “1” (to indicate valid CI), or other logical flags/values such as “2” (e.g. to indicate “padded”, or “synthesized”, or “denoised”, or “processed” CI). A respective padded/generated/replacement CI may be generated/synthesized for and/or used to replace any invalid CI.

For CI mask, some of the N4/M4 CIC may be missing/invalid in the time period in any CI of the N1 TSCI/the M1 regularized input TSCI. Thus a CI mask comprising N4/M4 mask elements may be constructed/computed for the N4/M4 CIC in respective CI of respective TSCI, each CI mask element associated with respective CIC of the CI. Similar to the DNN-input mask elements, any CI mask element may be either “0” (to indicate invalid CIC), or “1” (to indicate valid CIC), or other logical flags/values such as “2” (e.g. to indicate “padded”, or “synthesized”, or “denoised”, or “processed” CIC). A respective padded/generated/replacement CIC may be generated/synthesized for and/or used to replace any invalid CIC.

In some embodiments, data augmentation is applied for wireless sensing. Data augmentation may comprise techniques to artificially expand/diversify (i.e. increase diversity and amount of) training data by creating variations/modifications of existing data (e.g. the N1 TSCI, the M1 regularized “input” TSCI, the “DNN-input”) without actually collecting new data. Data augmentation may be applied to each DNN-input to generate one or more “augmented” DNN-input for training/re-training/refining the DNN. Data augmentation may also be applied to a CIC (regularized or not), a CI (regularized or not), a TSCI (regularized or not) and/or a set of TSCI (regularized or not) to generate respective one or more “augmented” CIC, “augmented” CI, “augmented” TSCI, and/or “augmented” set of TSCI. Augmented non-regularized CIC/CI/TSCI/set of TSCI may be used to generate/construct/form one or more “augmented” regularized CIC/CI/TSCI/set of TSCI. Any augmented regularized CIC/CI/TSCI/set of TSCI may be used to generate augmented DNN-input, for training/re-training/refining the DNN.

For example, data augmentation may be applied to a TSCI (regularized or not, augmented or not) to generate an augmented input TSCI which may be used to construct an augmented set of M1 regularized input TSCI for generating a respective augmented DNN-input. In particular, k of the M1 regularized input TSCI may be augmented to generate an augmented set of TSCI (comprising k augmented TSCI, and (M1-k) non-augmented TSCI) to generate one or more respective DNN-inputs, wherein k may be 0, 1, 2, . . . , or M1. Different augmentation steps/methodologies/procedures may be applied to different input TSCI. Even when none of the M1 regularized input TSCI is augmented, an augmented set of M1 TSCI may be generated from the set of M1 regularized input TSCI (e.g. by shuffling an order of the set of M1 regularized input TSCI, or by applying a same/common augmentation to all of the set of M1 regularized input TSCI).

In some embodiments, in the set of training data (training TSCI) for training the DNN, there may be imbalance of training data for different classes. More augmentation may be applied to a class with insufficient/less/imbalanced training data so as to generate more augmented training data. For classes with more/sufficient training data, augmentation may still be applied, to a lesser extent, to generate more variety/diversification of training data.

For matrix data, data augmentation may involve geometric transformation, rotation, flipping, cropping, scaling, translation, changing/adjusting colors/hue/brightness/contrast/saturation/dynamic range, edge enhancement, image filtering/blurring/sharpening, adding/injecting noise, occlusion, masking random regions, label-preserving perturbation, etc. Tabular data may be represented as matrices with rows as samples (e.g. TSCI) and columns as features (e.g. link associated with a TX antenna and an RX antenna). Data augmentation may comprise feature noise, feature shuffling (e.g. permute/shuffle non-critical columns), interpolation between samples (e.g. interpolation between rows), GANs for synthetic data, or synthetic sample generation (SMOTE). Time series data (e.g. TSCI) may be represented as matrices. Augmentation may comprise time warping, permutation, shuffling, magnitude scaling, window slicing, temporal scaling/resampling/subsampling/interpolation.

In some embodiments, the M1 regularized input TSCI may be generated based on N1 TSCI. The M1 regularized input TSCI used to generate the DNN-input may be obtained/constructed from the N1 TSCI of a device-pair. (Alternatively, the M1 regularized input TSCI may be obtained/constructed from TSCI of more than one device-pairs. The more than one device-pairs may be placed/situated/installed/reside in similar/same sub-region or sub-area of a venue and thus may monitor a same motion/state/activity in the sub-region/sub-area.) As N1 may be different for different device-pairs while M1 may be fixed, there may be three cases: (1) M1=N1, (2) M1<N1, (3) M1>N1.

For case (1): M1=N1, the M1 regularized input TSCI may not be ordered (i.e. it is simply a set/collection of M1 TSCI), and the M1 regularized input TSCI may simply comprise the N1 TSCI (i.e. only one combination). Alternatively, the M1 regularized input TSCI may be ordered. There may be (M1)! (i.e. M1 factorial, where (M1)!=(M1)*(M1-1)*(M1-2)* . . .*3*2*1) ways (permutations/shuffling's) to generate the M1 regularized input TSCI from the N1 TSCI, resulting in (M1)! DNN-inputs. In other words, there may be (M1)! input instances of M1 ordered regularized input TSCI to generate (M1)! DNN-inputs to train/run the DNN based on the same N1 TSCI.

For case (2): M1<N1, the M1 regularized input TSCI may comprise a subset of the N1 TSCI. When the M1 regularized input TSCI are not ordered, there may be [C_(N1)\hat{ }(M1)]=[(N1)!/(N1-M1)!/(M1)!]=(N1)*(N1-1)**(N1-2)* . . .*(N1-M1+1)/M1/(M1-1)/(M1-2)/ . . . /3/2/1 ways (or combinations) to generate the M1 regularized input TSCI from the N1 TSCI. In other words, there may be [(N1)!/(N1-M1)!/(M1)!] input instances or DNN-inputs (each comprising M1 un-ordered input TSCI) to train/run the DNN based on the N1 TSCI. When the M1 regularized input TSCI are ordered, there may be [P_(N1)\hat{ }(M1)]=[(N1)!/(N1-M1)!]=(N1)*(N1-1)*(N1-2)* . . .*(N1-M1+1) ways (permutations/shuffling's) to generate the M1 regularized input TSCI from the N1 TSCI. In other words, there may be [(N1)!/(N1-M1)!] input instances of M1 ordered input TSCI to generate [(N1)!/(N1-M1)!] DNN-inputs to train the DNN based on the N1 TSCI.

For case (3): M1>N1, the N1 TSCI may be used to construct a total of M1 constructed TSCI. Each set of M1 constructed TSCI may be used to generate one (e.g. when M1 TSCI are not ordered) or more (e.g. when M1 TSCI are ordered) DNN-inputs. As M1>N1, some of the N1 TSCI may be “expanded” by repeating/duplicating/cloning them one or more times (i.e. a repeated TSCI may appear two or more times among the M1 TSCI).

Alternatively, one (or more) of the M1 constructed TSCI may be copied/borrowed/generated from one or more second TSCI associated with a second TX-RX device-pair (e.g. the original TX-RX device-pair and the second TX-RX device-pair may be in same/similar sub-region of venue and thus can both capture the same motion/state/activity). The second TSCI may be captured/obtained in the second TX-RX device-pair with same/different sampling parameters (e.g. different timing, different sampling/sounding rate, different amount of CIC). In the copying/borrowing/generation process, the second TSCI may be adapted/resampled/interpolated/synchronized to match the rest of the M1 constructed TSCI.

Alternatively, one (or more) of the M1 constructed TSCI may be obtained by combining/merging/mixing two or more TSCI (e.g. of the N1 TSCI and/or of another N1 second TSCI associated with the second TX-RX device pair) to form a “combined” TSCI. For example, some of the N4/M4 “combined” CIC of a “combined” CI of the combined TSCI may be (e.g. copied from) corresponding CIC of CI of a first TSCI, while some other of the N4/M4 combined CIC of the combined CI may be (e.g. copied from) corresponding CIC of CI of a second TSCI, and so on. Some of the N4/M4 CIC of a CI of the combine TSCI may be an aggregate (e.g. weighted sum/mean) of respective CIC of respective CI of the first TSCI and respective CIC of respective CI of the second TSCI. Weights in any weighted aggregate may be same/different for different CIC.

In some embodiments, the M1 regularized input TSCI may be generated based on P1 TSCI chosen from N1 TSCI. Alternatively, in any of cases (1), (2) or (3), a number, P1, of TSCI (with P1<M1) may be chosen/selected from the N1 TSCI (e.g. using maximal-ratio combining/MRC) and the P1 chosen TSCI may be used to construct a total of M1 constructed TSCI to generate a DNN-input (similar to case (3) above). In addition to including the P1 chosen TSCI in the M1 constructed TSCI, M1-P1 additional TSCI may be constructed. Similar to case (3), some of the P1 chosen TSCI may be “expanded” by repeating/duplicating/cloning them one or more times. One of the M1 constructed TSCI may be borrowed from another TX-RX device-pair. Two or more of the P1 chosen TSCI (and/or any borrowed TSCI from another TX-RX device-pair) may be “combined” to form a combined TSCI to be used as one of the M1 constructed TSCI.

In some embodiments, for DNN-input used for training/running/fine-tuning the DNN, a standard/target/nominal/reference/required/unified/regularized sounding frequency (or temporal rate of CI in a regularized input TSCI) may be assumed/required/expected/used/shared/common in the M1 regular input TSCI. Associated with a device-pair, a first sounding frequency may be the same/common among the N1 TSCI, and a second sounding frequency may be the same/common among the M1 regularized input TSCI. The second sounding frequency may be the standard sounding frequency for generating the DNN-input and may be the same for all device-pairs. But the first sounding frequency may be same/different from the second sounding frequency. If different, resampling may be done to ensure the M1 regularized input TSCI have the second sounding frequency. In addition, the first sounding frequency may be different/same for different device-pairs (e.g. one may be 1 Hz (i.e. 1 sounding/s), another may be 10 Hz, and yet another one may be 1000 Hz). The re-sampling (e.g. interpolation, zero/first/second/ . . . /higher order interpolation, spline interpolation, decimation, subsampling or any combination) may be performed on the N1 TSCI to generate the M1 regularized input TSCI such that the sounding frequency of resampled CI/CIC of some/all TSCI associated with any device-pairs may have the assumed/required/expected/used/share/common sounding frequency. Suppose a first TSCI with first sounding frequency F1 is to be resampled to become a second TSCI with second sounding frequency F2. Consider a sliding time period of T1. There may be F1*T1 CI/CIC of the first TSCI in the sliding time period, while there may be F2*T1 CI/CIC of the second TSCI in the sliding time period. The resampling may resample the F1*T1 CI/CIC to generate the F2*T1 CI/CIC, based on some re-sampling filter. The resampling may happen before, or after, the generation of the M1 regularized input TSCI from the N1 TSCI.

In some embodiments, a time mask may be constructed/computed/defined for each TSCI (regularized, or not) in a period of time. The time mask may comprise a plurality of time mask elements in a fine time base (e.g. with a time resolution of 10 ms for 100 Hz, 1 ms for 1000 Hz, 0.2 ms for 5000 Hz, 0.1 ms for 10000 Hz) capable of representing samples at a high sampling frequency (e.g. 100/1000/5000/10000 Hz), each time mask element associated with a respective relative time stamp (expressed with respect to the time base) in the period of time. A time separation between consecutive time mask elements (time difference between their time stamps) may be/reflect the time base/resolution to represent the sampling time stamps. A time mask element of “1” may mean a CI is valid/sampled at the respective time stamp, while a time mask element of “0” may mean the CI at respective time stamp is invalid/not-sampled/not-captured/not-generated. In addition, there may be additional time mask element labels such as “2” which may mean the respective CI is generated/synthesized using some method (e.g. zero-order hold/interpolation, first-order/linear interpolation, etc.). A time mask element label “3” may mean the respective CI is preprocessed/cleaned/denoised/conditioned using some method. The time mask may be metadata of respective TSCI. A time mask element label “4” may mean the respective is resampled.

In some embodiments, data augmentation may be performed using time scaling and warping. Time scaling and/or time warping may be applied to any TSCI (e.g. any of the N1 TSCI or any of the M1 regularized input TSCI) to generate an augmented TSCI. Time scaling (e.g. time compression, or time expansion from 7 seconds to 10 seconds) may be a data augmentation technique used primarily for time series data or sequential signal (e.g. TSCI). It may modify the temporal length (duration) of a signal (TSCI, or a time period/section of TSCI) while preserving its essential characteristics. Time compression may reduce the duration of the signal (e.g. from 10 seconds to 7 seconds) by removing samples (e.g. CI of TSCI) or resampling at a higher rate. Time expansion may increase the duration of signal (e.g. from 7 second to 10 second) by inserting samples or resampling at a lower rate. For example, a TSCI comprising an object motion lasting for 10 seconds. Time compression may be applied to the TSCI to generate an augmented TSCI with object motion lasting for 7 seconds. Time scaling may be linear or nonlinear. Dynamic time warping (DTW) may nonlinearly stretch or shrink segments to match a target length. Neural time scaling may use autoencoders or generative adversarial networks (GANs) to learn optimal time-warping functions. An augmented time mask may be associated with the augmented TSCI. Time scaling and/or time warping may be applied to the time mask of the TSCI to generate the augmented time mask of the augmented TSCI.

In some embodiments, data augmentation may be performed based on scaling/noise injection. Augmented TSCI, augmented CI, augmented CIC may be generated by adding noise to respective TSCI, CI and CIC. Noise (e.g. Gaussian/Laplacian noise, impulsive noise, salt-and-pepper noise) may be added to one of N4/M4 CIC of a CI of a TSCI to generate respective augmented CIC. The resulting CI and TSCI are then augmented CI and augmented TSCI due to the augmented CIC. For different CIC, noise with same/different statistical distribution/behavior may be added. A feature (e.g. magnitude, magnitude-square, power) of TSCI/CI/CIC may be scaled/normalized to generate a respective augmented TSCI/CI/CIC.

In some embodiments, for each DNN-input (i.e. for each “to-be-augmented” DNN-input) generated from M1 regularized input TSCI for training/running the DNN (whether ordered or not ordered, whether before or after resampling), a number of associated augmented DNN-input for training/re-training/tuning the DNN may be generated. An augmented DNN-input may be generated by augmenting one or more of the M1 regularized input TSCI, or by augmenting one or more of the N1 TSCI. In the generation/construction of the augmented DNN-input, the to-be-augmented TSCI (also called to-be-replaced TSCI) may be replaced by an augmented TSCI generated from the to-be-augmented TSCI and/or the rest of the TSCI (i.e. the rest of the M1 regularized input TSCI and/or the rest of the N1 TSCI), using any data augmentation method.

In some embodiments, data augmentation may be performed based on permutation of multiple TSCI. In the generation of an augmented DNN-input, some/all of the M1 regularized input TSCI (or the N1 TSCI) may be augmented by applying a permutation/shuffling/re-ordering to the some/all of M1 regularized input TSCI (or the N1 TSCI). The individual TSCI may/may not be altered. This permutation/shuffling/re-ordering is at TSCI level.

In some embodiments, one or more CI/matrix may be represented as vectors. Each CI may be represented as a vector. For example, a CI with N CIC may be a (N)-tuple vector. Multiple vectors (e.g. CI vector) may be jointly represented as a combined vector by concatenating (or combining/grouping/merging) the respective vectors in some order. A number of time-stamped CI of a TSCI may be concatenated/grouped/combined together (e.g. in chronological order) to form a combined vector. For example, there may be N5 CI of a TSCI in a time period and they may be represented as a (N*N5)-tuple vector. Or, a CI may be concatenated with a denoised version of the CI and/or a transformed version of the CI to form a combined vector. Or, multiple CI/CIC from multiple TSCI may be concatenated to form a combined vector. A 2D matrix may be represented as a row-ordered vector, or column-ordered vector. Similarly, a k-D matrix may be scanned in a scanning order (e.g. raster or zig-zag scanning order) and then the scanned elements may be represented as a vector.

In some embodiments, data augmentation may be performed using transformation/permutation of vector/sub-vector. Transformation and/or permutation may be applied to any vector X (in a vector space), or a subvector of X (in a subspace of the vector space). Permutation is an arrangement of objects in a specific order. Permutation (e.g. rearranging/reorganizing/re-ordering/shuffling) may be applied to elements of a vector/subvector, or to a collection of time stamped quantities (such as a collection of CI of a TSCI, which are naturally ordered based on time stamp). Transformation may be applied to a vector or a subvector. Transformation may comprise any of: algebraic operations such as addition (e.g. add noise/Gaussian noise/impulsive noise), subtraction, multiplication (e.g. multiply by noise), division, scalar multiplication, permutation, shuffling, resampling, subsampling, truncation, quantization, extraction of a subset or a subvector, noise injection, 1D transform, etc. There may be three ways to generate augmented input using augmentation/permutation/shuffling/transformation to: (1) multiple TSCI, (2) multiple CI in a TSCI. (3) multiple CIC of CI in a TSCI.

(1) Augmentation/permutation/transformation of multiple TSCI. First, augmentation/transformation/permutation/shuffling may be applied to multiple TSCI (e.g. the N1 TSCI, the M1 regularized input TSCI, or a subset of them). The multiple TSCI may be ordered and some/all of them may be permuted/re-ordered/re-arranged/reorganized/shuffled (e.g. the “i-th” TSCI may become the “j-th” TSCI after permutation, where i and j are different), regardless of whether none/some/any/all individual input TSCI may be augmented or not.

(2) Augmentation/permutation/transformation of multiple CI of a TSCI. Second, augmentation/transformation/permutation/shuffling may be applied to multiple CI of one TSCI. The multiple CI may comprise CI of the TSCI in one or multiple sliding time windows. The multiple sliding time windows may have same/different window lengths. Respective permutation/transformation/shuffling may be applied to each individual time window of CI. Another permutation/transformation/shuffling may be applied to the multiple time windows (e.g. the “i-th” window may become the “j-th” window after permutation).

(3) Augmentation/permutation/transformation of multiple CIC of CI of a TSCI. Third, augmentation/transformation/permutation/shuffling may be applied to multiple CIC of CI of one TSCI to generate augmented CI, or to elements of a vector to generate an augmented vector. The transformation/permutation/shuffling may comprise rotation and/or shifting. In particular, the CIC of each CI may be right rotated/left rotated, and/or right shifted/left shifted to generate an augmented CI.

In some embodiments, data augmentation may be performed using matrix multiplication. Let X1 be an N-tuple vector (a 1D array, or rank-1/order-1 tensor) which may represent one (or more) CI with N4/M4 CIC. Let X1(i) be the i\hat{ }{th} element/component of X1. Let X2 be an augmented N-tuple vector obtained/generated by transforming/permuting/shuffling the N elements/components of X1. The augmented vector X2 may be computed by multiplying the vector X1 by an N×N square matrix A1 (e.g. N4×N4 for N=N4, or M4×M4 for N=M4), i.e. X2=A1*X1 (e.g. a transformation of the rank-1 tensor, or a multi-linear map). As such, the augmentation may be linear.

In some embodiments, data augmentation may be performed using permutation. The A1 may be an N×N identity matrix such that X2=X1. The identity matrix is a diagonal matrix with diagonal elements being 1 and other elements being zero. Alternatively, A1 may be a permutation matrix, which may be the identity matrix with the columns or the rows permuted/shuffled. Each permutation matrix has a 1 in each column/row with the rest of the elements in the column/row being zero. For example, A1 may be an anti-diagonal matrix with the anti-diagonal elements being 1 and other elements being zero, which corresponds to a flipping of elements of X1 such that the elements are arranged in reverse order. For example, X2(1)=X1(N), X2(2)=X1(N−1) . . . . X2(i)=X1(N+1−i) . . . . X2(N−1)=X1(2), X2(N)=X1(1).

In some embodiments, data augmentation may be performed using rotation. The A1 may be the N×N identity matrix with the columns right-rotated by k, or left-rotate by N-k. Or the A1 may be the identity matrix with the rows up-rotated by k or down-rotated by N-k. The X2 may be X1 left-rotated (or up-rotated) by k. i.e. X2(i)=X1((i+k) mod N) where mod is modulo. In other words, X2(1)=X1(1+k), X2(2)=X1(2+k), . . . . X2(N−k)=X1(N), X2(N−k+1)=X1(1), X2(N−k+2)=X1(2), . . . . X2(N)=X1(k).

In some embodiments, data augmentation may be performed using shifting. The A1 may be the N×N identity matrix with the columns right-shifted by k, or with the rows up-shifted by k. The X2 may be the X1 left-shifted (or up shifted) by k. i.e. X2(1)=X1(1+k), X2(2)=X1(2+k), . . . . X2(N−k)=X1(N), X2(N−k+1)=0, X2(N−k+2)=0 . . . . X2(N)=0. The A1 may also be the N×N identity matrix with the columns left-shifted by k, or the rows down-shifted by k. The X2 may be the X1 right-shifted by k. i.e. X2(1)=0, X2(2)=0 . . . . X2(N−k1)=0. X2(N−k+1)=X1(1), X2(N−k+2)=X1(2), . . . . X2(N)=X1(k).

In some embodiments, data augmentation may be performed using cropping. The augmented vector X2 may be generated by cropping. Some elements of X1 may be forced to be zero. In some case, some elements of X1 may be forced to be erratic (e.g. artificially large magnitude, very large magnitude). For example, all elements of the i-th row of A1 may be zero such that the i-th element of X2=A1*X1 may be zero.

In some embodiments, the system may perform sectional augmentation/permutation/transformation. The N-tuple vector X1 may be subdivided/segmented into a number of “sections” or sub-vectors (e.g. first half, second half, or first/second/third/fourth quarter). Respective augmentation/permutation/transform/shuffling may be applied to respective individual sections/sub-vectors. Another augmentation/permutation/transform/shuffling may be applied to the number of sections/sub-vectors. Different sections/sub-vectors may have same/different amount of elements. For example, the CI may be a CFR for a 160 MHz channel, and the CI vector X1 may be subdivided into eight sections or eight sub-vectors, each with CIC corresponding to a respective 20 MHz band. Or, X1 may be subdivided into four sections/sub-vectors, each with CIC corresponding to respective 40 MHz band. Or X1 may be subdivided into two sections/sub-vectors, each with CIC corresponding to respective 80 MHz band.

In some embodiments, each section/subvector may comprise a respective set/collection of consecutive vector elements (e.g. CIC with consecutive indices). Alternatively, the vector elements in a section may not be consecutive (i.e. indices may not be consecutive). For example, four sections/subvectors may be obtained by subsampling X1 by a factor of 4. One section may comprise the subsampled elements at a first subsampling phase (e.g. X1(1), X1(5), X1(9) . . . or X(4n+1) for n=0, 1 . . . ), while a second section may comprise another phase of subsampled elements (e.g. X1(2), X1(6), X1(10), . . . , or X1(4n+2) for n=0, 1 . . . ). A third section may comprise X1(3), X1(7), X1(11) . . . , or X1(4n+3) for n=0.1 . . . , and a fourth section may comprise X1(4), X1(8), X1(12) . . . or X1(4n+4) for n=0, 1, . . . , etc. Different sections may have same/different amount of (ordered) vector elements/CIC. The number of sections may be ordered/indexed. Some respective transformation/permutation/shuffling (e.g. rotation/shifting/flipping/random) may be performed/applied in each section independently. Different/same transformation/permutation/shuffling may be applied to different sections.

In some embodiments, some transformation/permutation/shuffling (e.g. rotation/shifting/flipping/random) may be applied/performed to the number of sections. For example, an augmented vector X2 may be obtained by shifting or rotating the sections by k section-positions (or by k section index), i.e. i-th section shifted/rotated to become (i+k)-th section. For example, the first section of X1 may be shifted to become second section of X2 (e.g. k=1), the second section of X1 may be shifted to become third section of X2, and so on.

In some embodiments, CI interpolation may be performed in punctured transmission. Puncturing is a way to increase channel efficiency/usage/throughput and to reduce latency by reducing interference effects in wireless channels and may happen during the transmission of wireless signals in one or more of the N10 TX-RX device-pairs TSCI. In punctured transmission (e.g. preamble puncturing in 802.11be, BSS coloring in 802.11ax/be) in an affected device-pair, one or more busy (e.g. with severe interference) or unavailable narrow channels may be excluded (“punctured”) from a wide channel. As a result, some subband/subcarrier of the band of the wide channel (i.e. some CIC of a CI) may be skipped/not used/not available (e.g. due to severe interference). For example, a particular 20 MHz subband in a 160 MHz band may be busy/blocked and may be skipped such that the available bandwidth is effectively 140 MHz (which may be the 160 MHz band with a 20 MHz “hole” or missing band). Without the puncturing, the 160 MHz communication channel may need to fall back to 80 MHz due to the interference. During punctured communication with associated “hole” or missing band in an affected TX-RX device-pair in a period of time, some corresponding CIC of each associated CI captured by the TX-RX device-pair in the period of time may be missing/unavailable/invalid. A first CI mask (as explained above) comprising N4 CI mask elements (or components) may be constructed/defined for each CI of the N1 TSCI associated with the affected device-pair in the period of time, each CI mask element/component associated with respective CIC of the CI. Associated with the first CI mask, a second CI mask comprising M4 CI mask elements may be constructed/defined for each CI of the M1 regularized input TSCI in the period of time. Any CI mask element may be either “0” (to indicate invalid CIC), or “1” (to indicate valid CIC), or other logical flags/values such as “2” (e.g. to indicate “padded”, or “synthesized”, or “denoised”, or “processed” CIC). A synthesized/generated/replacement/borrowed/interpolated CIC may be generated to replace an invalid CIC of a CI. The generated CIC of the CI may be generated based on an interpolation based on “adjacent” CIC. The adjacent CIC may comprise (a) other CIC of the CI with adjacent CIC indices, and/or (b) CIC of temporally adjacent CI in the same TSCI.

In some embodiments, data augmentation may be performed for multi-link operation (MLO). Multiple bands may be used for data/control transmission simultaneously. For example, for a TX-RX device-pair operating in multi-link operation (MLO) (e.g. IEEE 802.11be (Wi-Fi 7)), in which 3 bands may be used simultaneously: 2.4 GHZ, 5 GHZ and 6 GHZ. Multiple sets of respective N1 TSCI may be obtained from a TX-RX device-pair, each set associated with a respective band. The N1 may be same/different for different bands. The amount of CIC (N4) in different bands may be same/different.

In multi-link aggregation (MLA), multiple bands across multiple links may be combined to achieve larger bandwidth. Each link may be associated with a respective TX-RX device-pair, and a respective set of N1 TSCI. Different links may have same/different N1 and/or N4. In Multi-Link Switching (MLS), multiple bands across multiple links may be switched (e.g. one band at a time). Each band of each link may be associated with a respective set of N1 TSCI. In Asynchronous Multi-Link (AML), each of multiple links may have independent transmission resulting in respective set of N1 TSCI. In coordinated MLO (e.g. in 802.11bn), multiple AP may jointly manage punctured channels to optimize network-wide performance. Each AP may generate a respective set of N1 TSCI. In Co—BF (e.g. in 802.11bn), multiple (e.g. two) AP may simultaneously transmit to multiple target STA in the same channel by coordinating beamforming and null steering to prevent interference. This may enhance throughput/reliability and reduce latency in multi-AP environment. Each AP may generate a respective set of N1 TSCI. Independent data augmentation may be applied to each set of N1 TSCI. The multiple set of respective N1 TSCI may be combined/mixed/merged/interchanged. A time mask may be shared by the multiple TSCI.

In some embodiments, DNN-input may be generated from M1 regularized input TSCI for deep neural network. The regularized CI of each of the M1 regularized input TSCI may be needed/required/expected/supposed to have M4 regularized CIC in order to generate the DNN-input. M4 may be a fixed/pre-defined number. But the CI of the N1 TSCI (of a device-pair) with N4 CIC may not be used directly as the regularized CI (with M4 regularized CIC) due to the mismatching amount of CIC, especially since N4 may be different for different device-pair. Thus M4 regularized CIC of the regularized CI may be constructed/converted from some N4 “initial” CIC of some “initial” CI. Alternatively, an (M4)-tuple regularized CI vector Y with M4 CIC/components/elements may be constructed from a (N4)-tuple initial CI vector X with N4 initial components/elements/CIC. The vector Y may be computed as a matrix A2 of size M4×N4 multiplied by vector X, i.e. Y=A2*X. Often, the i-th row of matrix A2 may be a unity vector with (N4-1) “0” and one “1” at the j-th element, such that the i-th element of Y is the j-th element of X. Sometimes, the i-th row of A2 may comprise more than one non-zero elements with a sum of unity such that i-th element of Y is a weighted sum of corresponding elements of X, with corresponding weights as indicated in the i-th row of A2. The conversion from N4 initial CIC to M4 regularized CIC may happen before the construction of the M1 regularized input TSCI from the N1 TSCI such that each CI of the M1 regularized input TSCI may have M4 CIC. Alternatively, the conversion from N4 initial CIC to M4 regularized CIC may happen after the construction of the M1 regularized input TSCI such that each CI of the M1 regularized input TSCI may have N4 CIC which may then be converted to M4 regularized CIC.

In some embodiments, as N4 may be different for different device-pairs while M4 may be fixed, there may be 3 situations: (1) M4=N4, (2) M4<N4, (3) M4>N4.

For case (1): M4=N4, the M4-tuple regularized CI vector Y may simply be the N4-tuple initial CI vector X (i.e. Y=X, or equivalent, the matrix A2 may be an identity matrix). Alternatively, the regularized CI vector Y may be a permutation of the initial CI vector (i.e. matrix A2 may be an M4×M4 permutation matrix). There may be (M4)! different permutation matrices such that (M4)! different regularized CI vector Y may be generated from each initial CI vector X. Data augmentation may be applied to each respective regularized CI vector Y, or the respective DNN-input generated by the respective regularized CI vector Y.

For case (2): M4<N4, the regularized CI vector Y may comprise a subset of elements of initial CI vector X. There may be [P_(N4)\hat{ }(M4)]=[(N4)!/(N4-M4)!]=(N4)*(N4-1)*(N4-2)* . . .*(N4-M4+1) ways (permutations/shuffling's) to generate the M4-tuple regularized CI vector Y from the N4-tuple initial CI vector X. In other words, there may be [(N4)!/(N4-M4)!] input instances of M4-tuple regularized CI vector Y to generate [(N4)!/(N4-M4)!] DNN-inputs to train/run the DNN based on the N4-tuple initial CI vector X. One element of M4-tuple Y may be a “summary” (e.g. a linear combination, an aggregate, a weighted average/sum) of multiple elements of N4-tuple X. The M4 elements of M4-tuple Y may be chosen/selected from the N4 elements of N4-tuple X based on an algorithm/criterion (e.g. maximal-ratio combining/MRC, largest eigenvalues, etc.)

For case (3): M4>N4, as the M4-tuple Y needs more elements than the N4-tuple X possesses, at least M4-N4 elements need to be generated for Y based on X. A first way to generate one or more M4-tuple Y from N4-tuple X is zero-padding, in which zeros are padded around the elements of N4-tuple X to form a M4-tuple vector. A total of M4-N4 zeros may be padded at the beginning, or at the end, or partially at beginning and at end. In some cases, some of the M4-N4 zeros may be added/placed/inserted in between the N4 elements of X. A second way to generate M4-tuple Y from N4-tuple X is to “expand” X by repeating/duplicating/cloning/mirroring at least one element of X. For example, a cyclic repetition of elements of N4-tuple X may be formed, and the M4-tuple Y may be any stretch/section of M4 elements of the cyclic repetition. In a second example, the elements of N4-tuple X may be mirrored to form a mirrored vector X2 comprising approximately 2*N4 elements. Then cyclic repetition of the elements of X2 may be formed, and the M4-tuple Y may be any stretch/section of M4 elements of the cyclic repetition. The mirrored vector X2 may be any of: (1) a (2*N4)-tuple vector [X(1), X(2), . . . . X(N4-1), X(N4), X(N4), X(N4-1) . . . . X(2), X(1)], in which both X(1) and X(N4) appear twice, where X(i) is i-th element of X. (2) a (2*N4-1)-tuple vector [X(1), X(2) . . . . X(N4-1), X(N4), X(N4-1), . . . . X(2), X(1)] in which X(1) appeared twice and X(N4) appeared once, (3) a (2*N4-1)-tuple vector [X(1), X(2), . . . . X(N4-1), X(N4), X(N4), X(N4-1) . . . . X(2)], in which X(1) appeared once and X(N4) appeared twice, (4) a (2*N4-2)-tuple vector [X(1), X(2), . . . . X(N4-1), X(N4), X(N4-1), . . . . X(2)], in which both X(1) and X(N4) appear once.

In some embodiments, a third way to generate M4-tuple Y from N4-tuple X is to generate each of the M4-N4 to-be-generated elements of M4-tuple Y as a respective linear combination of one or more elements of N4-tuple X. The M4-N4 generated elements may be placed/added/inserted at the beginning, or at the end, or partially at the beginning and at the end of elements of N4-tuple X. In some cases, the generated elements may be placed/added/inserted in between the N4 elements of X.

In some embodiments, N11-point 1D transform (e.g. auto-correlation function or ACF, short time Fourier transform or STFT) may be performed at a granularity level (e.g. per-CIC, per-TSCI, per-device-pair, all-device-pair). In a sliding time window, 1-dimensional (1D) N11-point transform (e.g. ACF, STFT) may be computed for CIC and/or CI of any TSCI (e.g. any of the N1 TSCI or the M1 regularized input TSCI of each device pair, or any of the M1 regularized input TSCI used to generate DNN-input for DNN/LLM) associated with any of the N10 device-pairs in the sliding time window, each 1D transform with N11 transform components. Let X be a N11-tuple vector of CIC/CI with N11 vector components/CIC/CI. Let Y be a N11-tuple vector comprising the 1D transform of X. The 1D transform may be linear such that Y may be computed as Y=A*X, where A is a N11×N11 transform matrix. The 1D transform may also be nonlinear, or it may comprise a linear portion and a nonlinear portion. The 1D transform may comprise any of: autocorrelation function (ACF), short time Fourier transform (STFT), wavelet transform, Hadamard transform, or some frequency transform. The 1D transform may also be a trivial unity transform such that there is effectively no transform performed on the N11 CIC/CI. The N11 may be same/different for all TSCI associated with any of the N10 TX-RX device-pairs, even though different device-pairs may have same/different N4, N7, N8, and/or N1, same/different placement/orientation of TX and RX, and same/different system configuration/antenna types/antenna amounts/signal transmissions/modulation (e.g. WiFi 2.4 GHZ, WiFi 5 GHZ, WiFi 6 GHZ, WiFi 60 GHZ, 3G/4G/5G/6G/7G/8G, UWB, millimeter wave (mmWave), Bluetooth, etc.). In particular the N11 may be same for all TSCI, especially when all TSCI are associated with same sounding frequency.

In some embodiments, DNN-input may be generated based on N11-point 1D transform. The N11-point transform coefficients of some TSCI (e.g. the M1 regularized input TSCI) may be used to generate the DNN-input (or the M1 regularized input TSCI) for the DNN. Deep learning (DL, e.g. supervised learning, unsupervised learning, self-supervised learning) may be used to train or fine-tune (for a task/sub-task) the DNN/model/FM/LLM using training TSCI obtained/generated from a variety of device-pairs with same/different N4, N7, N8, N1 and with same/different training placement/orientation/venue, sampling/sounding frequency, carrier frequency band, signal transmission/modulation, etc. The trained DNN/model/FM/LLM may be used for various/any/all device-pairs with various N4, N7, N8 and/or N1. The trained DNN/model/FM/LLM may be adapted/adopted/prompted/fine-tuned to work (e.g. with various additional DNN) for various sensing tasks (e.g. “down-stream” tasks). Fine tuning may change the DNN/model/foundation model/LLM itself while prompting may change the way to use the DNN/model/FM/LLM. There may be N9 sliding time windows in a time period (e.g. 0.1/1/10/100/1000/10000 seconds), and there may be many time periods along the time axis. Adjacent time periods may/may not overlap.

In some embodiments, different N1 may be used for different sliding time windows of different duration. The 1D transform may be performed for sliding time windows with different duration. Suppose the sounding frequency associated with a TSCI is F1. There may be a first series of sliding time windows each of duration T1, and a second series of sliding time windows each of duration T2. The 1D transform may be computed for each sliding time window of the two series of sliding time windows. For a first sliding time window of duration T1, a first N11-point 1D transform may be computed based on CI of the TSCI in the first sliding time window, with the first N11 being F1*T1. For a second sliding time window of duration T2, a second N11-point 1D transform may be computed based on the TSCI in the second sliding time window with second N11 being F1*T2. A short sliding time window (e.g. T1=10 seconds) may reflect short-term behavior while a long sliding time window (e.g. T2=1000 seconds) may reflect long/longer-term behavior.

In some embodiments, N11-point or N13-point 1D transform may be performed with resampling. The N11 may be different for different TSCI. For example, a first TSCI may be associated with a first sounding frequency F1 (e.g. 10 Hz) and a second TSCI may be associated with a second frequency F2 (e.g. 50 Hz). The 1D transform may be performed in both TSCI in respective time window associated with a common sliding time period T1 (e.g. 1/10/100/1000 seconds). The N11 for the first TSCI in the common time period may be T1*F1 while another N11 for the second TSCI in the common time period may be T1*F2. In the case that the two N11 are different for different TSCI, the N11 1D transform coefficients of the first TSCI in the common time period may be resampled (e.g. interpolated, decimated, and/or subsampled) to give N13 (which may be equal to the another N11) resampled transform coefficients, wherein N13 may be the same for all TSCI (e.g. N13 may be associated with the required/expected/used/shared/common sounding frequency). Alternatively, the N11 CI/CIC in the sliding time period of the first TSCI (e.g. the common time period T1 in the first/second TSCI) may be resampled to give N13 resampled CI/CIC (with the N13 being the same for all TSCI) and a N13-point 1D transform may be applied to the N13 resampled CI in the sliding time period to give N13 (resampled) transform coefficients. The N13-point (resampled) transform coefficients may be used to generate the DNN-input to the DL/DNN/model/FM/LLM, using the common format/presentation/expression.

Different granularity levels may include: per-TSCIC, per-TSCI, per-device-pair, all-device-pair. The 1D transform may be computed at different granularity level (e.g. at per-TSCIC/per-component level, at per-TSCI level, at per-device-pair level, or at all-device-pair level). A hierarchy of granularity levels may be established/constructed/determined. In the hierarchy, the per-component/per-TSCIC granularity level may be a lower granularity level compared with per-TSCI granularity level (i.e. the per-component/per-TSCIC granularity level may be “lower” than per-TSCI granularity level), which may be lower than per-device-pair granularity level, which in turn may be lower than all-device-pair granularity level. In any case, the 1D transform at a granularity level may be a transformation (e.g. of CI, or of CIC) at the granularity level from a first domain (e.g. time domain) to a second domain (e.g. transform domain), or vice versa, associated with the 1D transform. The transform domain may be a “time-lag” domain when 1D transform is ACF, or a frequency domain when 1D transform is Fourier/wavelet/trigonometric transform (e.g. FFT).

In some embodiments, higher granularity-level quantities can be computed based on multiple lower granularity-level quantities. A higher-granularity-level quantity (e.g. 1D transform, or 2-D transform, or motion statistics) in a time window may be computed based on a plurality of lower-granularity-level quantities in the time window. In particular, a higher-granularity-level 1D/2D/k-D transform may be/comprise an aggregate (e.g. sum/product/mean, possibly weighted) of a plurality of lower-granularity-level 1D/2D/k-D transforms. A per-TSCI 1D/2D/k-D transform may be an aggregate of multiple per-component (or per-TSCIC) 1D/2D/k-D transforms. If each CI has N4 CIC, the per-TSCI 1D/2D/k-D transform may be an aggregate of N4 per-TSCIC 1D/2D/k-D transforms. A per-device-pair 1D/2D/k-D transform may be a first aggregate of multiple per-component (per-TSCIC) 1D/2D/k-D transform, or a second aggregate of multiple per-TSCI 1D/2D/k-D transform, or a third aggregate of the first and second aggregates. An all-device-pair 1D/2D/k-D transform may be a first aggregate of multiple per-component/per-TSCIC 1D/2D/k-D transform, or a second aggregate of multiple per-TSCI 1D/2D/k-D transform, or a third aggregate of multiple per-device-pair 1D/2D/k-D transform, or a fourth aggregate of the first, second and third aggregates. A 2D transform may be constructed based on a plurality of 1D transform. Recursively, a k-D transform may be constructed based on multiple (k−1)-D transforms.

In some embodiments, when more lower granularity-level quantities (in the plurality of lower granularity-level quantities) are used to compute a higher granularity-level quantity, the resulting higher granularity-level quantity may be more substantial/representative/revealing/reliable/trustworthy. Thus a (or more than one) granularity-level score (e.g. a confidence/reliability/trust/trustworthiness score) may be computed for/associated with each granularity-level quantity. The granularity-level score may be non-negative. The granularity-level score may be a real number (e.g. non-negative) between an upper bound and a lower bound. For example, it may be between −1 and 1, or between 0 and 1, or between 0 and 10, or between 0 and 100. The granularity-level score of (or associated with) the higher-granularity-level quantity (e.g. higher granularity-level 1D transform) may be larger when more lower-granularity-level quantities (e.g. lower granularity-level 1D transform) are used to compute the higher granularity-level quantity. The higher-granularity-level quantity may be monotonic increasing/non-decreasing with respect to each lower-granularity-level quantity. The higher granularity-level quantity (e.g. 1D transform) may be computed as a weighted sum/mean/quantity of multiple lower granularity-level quantities. A larger weight may be given/assigned to a lower granularity-level quantity with larger granularity-level score (i.e. larger weights for more substantial/representative/revealing/confident/reliable/trustworthy quantities as reflected by the associated granularity-level score) in the computation of the weighted sum/mean/quantity. The weight may be a function of the associated score. The function may be monotonic (e.g. monotonic increasing/non-decreasing). The weight may also be a function of an associated transform index. Alternatively, all weights may be equal (i.e. un-weighted) for all lower granularity-level quantities. The weights used in any weighted sum/mean/quantity may be normalized.

In some embodiments, per-component/per-TSCIC level 1D transform (N4/M4 for each TSCI, N1*N4/N1*M4 for each device-pair) may be performed. At the per-component/per-TSCIC granularity level (i.e. lowest level), a per-component (or per-TSCIC) 1D N11-point transform (e.g. ACF, STFT) associated with a CIC of CI of a TSCI of a device-pair may be computed for each of the respective N4 CIC of CI of each respective N1 TSCI of each of N10 device-pairs in the sliding time window (e.g. first CIC of all CI of each TSCI in the sliding time window). In the sliding time window, there may be N4 per-TSCIC/per-component 1D transforms corresponding to the respective N4 CIC of CI of each TSCI, each per-component 1D transform associated with a respective one of the respective N4 CIC of the TSCI. There may be N1*N4 per-component/per-TSCIC 1D transforms for the respective N4 CIC of the respective N1 TSCI of the device-pair (which is a TX-RX pair comprising a Type1 device (TX) and a Type2 device (RX)). For the M1 “input” TSCI with M4 CIC for each “input” CI used to generate the DNN-input for training DNN/model/FM/LLM, there may be M4 per-TSCIC 1D transform for the M4 “input” TSCIC of each input TSCI in the sliding time window, and there may be a total of M1*M4 per-TSCIC 1D transform for the M4 input TSCI.

In some embodiments, per-TSCI level 1D transform (1 for each TSCI, N1 for each device-pair) may be performed as aggregate of N4 per-component/per-TSCIC 1D transform. At the per-TSCI granularity level (or at wireless link level associated with a particular TX antenna and a particular RX antenna), a per-TSCI 1D transform associated with a TSCI (associated with respective TX antenna and respective RX antenna) of a device-pair may be computed as an aggregate of the respective N4 per-component 1D transforms of the TSCI of the device-pair in the sliding time window. There may be respective N1 per-TSCI 1D transforms for the device-pair, each associated with one of the N1 TSCI of the device-pair. For the M1 regularized input TSCI, there may be M1 per-TSCI 1D transform in the sliding time window. Alternatively, a per-TSCI 1D transform such as ACF may be computed for N11 CI of each TSCI directly. The computation of the 1D transform (e.g. ACF or other correlation/covariance-based 1D transform) may comprise products of two CI. To compute such products, each of the two CI may be represented as a respective N4-tuple CI vector with respective N4 vector elements/CIC (or respective M4-tuple vector with respective M4 CIC). The product of two CI may be the dot product of the two respective CI vectors. The aggregate may comprise any of: a sum, product, weighted sum, weighted product, mean, weighted mean/average, arithmetic mean, geometric mean, harmonic mean, percentile, median (50-percentile), minimum (0-percentile), maximum (100-percentile), trimmed mean (mean of percentile from A1-percentile to A2-percentile), mode, etc.

In some embodiments, each higher granularity-level 1D transform (e.g. per-TSCI 1D transform, per-TSCI ACF, per-TSCI STFT, etc.) may be a weighted aggregate (e.g. weighted average/product/mean) of the corresponding lower granularity-level 1D transform. For example, each per-TSCI 1D transform (e.g. per-TSCI ACF/STFT) may be a weighted average of the N4 associated per-TSCIC/per-component 1D transforms. The weights may be computed based on maximum ratio combining (MRC). The weights may be all equal such that the weighted average may simply be an un-weighted average. Some of the lower granular-level 1D transforms may be selected to compute the weighted average while the rest may not be selected. For example, a number, N12, of the N4 CIC (called “selected CIC”) or TSCIC (“selected TSCIC”) may be selected to compute the per-TSCI 1D transform, while the remaining N4-N12 of the N4 CIC (called un-selected CIC) or TSCIC (“unselected TSCIC”) may be unselected. The weights for/of the selected lower granular-level 1D transform (e.g. the N12 selected CIC/TSCIC) may be non-zero while the weights for/of the un-selected lower granularity-level 1D transform (e.g. the N4-N12 unselected CIC/TSCIC) may be zero. The weight for a lower granularity-level 1D transform may be associated with/a function of/proportional to the lower granularity-level 1D transform evaluated at a particular transform index. For example, the weight for a selected CIC/TSCIC (i.e. the weight for the associated per-component/per-TSCIC 1D transform) may be the associated per-component/per-TSCIC 1D transform evaluated at a pre-defined non-zero transform index (e.g. the first non-zero transform index). Alternatively, the weighted aggregate (e.g. weighted average) may simply be an un-weighted aggregate (e.g. un-weighted average/product/mean) with all weights being equal. The weights may be normalized. For example, the weights for the N12 selected CIC/TSCIC may be normalized to unity so that their sum is unity (i.e. one).

In some embodiments, a feature (or characteristic value) of each lower granularity-level 1D transform may be computed. The selection of the selected lower granularity-level 1D transform may be based on an analysis/comparison of the lower granularity-level 1D transform. The feature may comprise (or may be based on) one or more local maxima and/or local minima of the 1D transform (or one or more local max/min of first/second/higher order derivatives of the 1D transform). The feature may be the 1D transform evaluated at a particular transform index. A number of the lower granularity-level 1D transform with the largest (or smallest) feature may be selected as the selected lower granularity-level 1D transform. If there are N12 selected lower granularity-level 1D transform, the N12 lower granularity-level 1D transforms with the top N12 features (or bottom N12 features) may be selected as the N12 selected lower granularity-level 1D transform. For example, to select the N12 selected CIC/TSCIC to compute the per-TSCI 1D transform, all N4 per-component/per-TSCIC 1D transforms may be analyzed and compared. A per-component/per-TSCIC characteristic value (e.g. the feature of the 1D transform) may be computed for each of the N4 per-component/per-TSCIC 1D transforms. The N12 selected CIC may then be selected based on the N4 per-component characteristic values. The N12 selected CIC may comprise/be the CIC associated with one of: maximum (100-percentile) characteristic value, or top (or largest) N12 characteristic values, or multiple local maxima, or minimum (0-percentile) characteristic values, or bottom (or smallest) N12 characteristic values, or multiple local minima, or median (50-percentile) characteristic value, or a group of N12 percentile characteristic value around the median.

In some embodiments, the characteristic value of any 1D transform (e.g. per-component/per-TSCIC 1D transform, or per-TSCI 1D transform, or per-device-pair 1D transform, or all-device-pair 1D transform) may be a first aggregate (e.g. minimum) of all, or a subset, of the N11 transform values of the 1D transform. The subset of transform values may be those associated with a subset of transform indices, such as a range of transform indices, from transform index a1 to index a2. The a1 may be N11*b1 and a2 may be N11*b2. The b1 may be 0.1/0.2/0.3/0.4 or other values. The b2 may be 0.6/0.7/0.8/0.9 or other values. The first aggregate may comprise/be a percentile, maximum (100-percentile), minimum (0-percentile), median (50-percentile), mean, weighted mean, arithmetic mean, geometric mean, harmonic mean trimmed mean (sum of percentile from A1-percentile to A2-percentile, e.g. (A1,A2)=(0,10), or (3,17), or (33,66), or (90-100), or (83,97)), difference between two percentile (A2-percentile minus A1-percentile, e.g. (A1,A2)=(0,100), (10,90), (25,75)), and/or the transform value at a particular transform index (e.g. first non-zero transform index). In some embodiments, a particular characteristic value is minimum transform value in a subset of transform indices. In particular, the characteristic value may be a minimum of a subset of transform values, each of the subset of transform values has a transform index in a range from a1=N11*b1 to a2=N11*b2, with b1=0.2 and b2=0.8. And the N12 selected CIC may be the N12 CIC associated with bottom N12 characteristic values.

In some embodiments, N10 per-device-pair level 1D transform may be performed as aggregate of N1*N4 per-component 1D transform or N1 per-TSCI 1D transform. At the per-device-pair granularity level, a first per-device-pair 1D transform associated with a device pair of TX device and RX device may be computed as an aggregate of all the respective N1*N4 per-component 1D transforms associated with all the respective N4 CIC of CI of all respective N1 TSCI of the device-pair in the sliding time window. A second per-device-pair 1D transform associated with the device pair may be computed as another aggregate of all respective N1 per-TSCI 1D transforms associated with the respective N1 TSCI of the device-pair in the sliding time window. There may be N10 of first (or second) per-device-pair 1D transforms.

In some embodiments, N13 (out of N1*N4) selected per-component 1D transform may be performed to compute per-device-pair 1D transform. The first per-device-pair 1D transform may be a weighted average of all or a subset of the N1*N4 per-component/per-TSCIC 1D transforms (e.g. using maximum ratio combining (MRC). A number, N13, of the N1*N4 per-component/per-TSCIC 1D transforms may be selected to compute the first per-device-pair 1D transform, while a number, N1*N4-N13, of the per-component 1D transforms may be unselected, wherein N13< (N1*N4). The weights for/of the N13 selected per-component 1D transforms (in the weighted average) may be non-zero while the weights for/of the N1*N4-N13 unselected ones may be zero. The weight for a selected per-component 1D transform may be the selected per-component 1D transform evaluated at a pre-defined non-zero transform index (e.g. first non-zero transform index). The weights for the N13 selected per-component 1D transforms may be normalized so that their sum is unity (i.e. one).

In some embodiments, to select the N13 selected per-component 1D transforms, all N1*N4 per-component 1D transforms may be analyzed and compared. And N1*N4 per-component/per-TSCIC characteristic values may be computed, one for each of the N1*N4 per-component/per-TSCIC 1D transforms. The N13 selected per-component 1D transforms may then be selected based on the N1*N4 per-component characteristic values. The N13 selected per-component 1D transforms may comprise/be the per-component 1D transforms associated with one of: maximum (100-percentile) characteristic value, or top (or largest) N13 characteristic values, or multiple local maxima, or min (0-percentile) characteristic values, or bottom (or smallest) N13 characteristic values, or multiple local minima, or median (50-percentile) characteristic value, or a group of N13 percentile characteristic value around the median. The N13 selected per-component 1D transforms may be associated with bottom (smallest) N13 per-component/per-TSCIC characteristic values.

In some embodiments, N14 (out of N1) may be selected per-TSCI 1D transformed selected to compute per-device-pair 1D transform. The second per-device-pair 1D transform may be a weighted average of all or a subset of the N1 per-TSCI 1D transforms (e.g. using maximum ratio combining (MRC). A number, N14, of the N1 per-TSCI 1D transforms may be selected to compute the second per-device-pair 1D transform, while a number, N1-N14, of the per-TSCI 1D transforms may be unselected, wherein N14<N1. The weights for/of the N14 selected per-TSCI 1D transforms may be non-zero while the weights for/of the N1-N14 unselected ones may be zero. The weight for a selected per-TSCI 1D transform may be the selected per-TSCI 1D transform evaluated at a pre-defined non-zero transform index (e.g. first non-zero transform index). The weights for the N14 selected per-TSCI 1D transforms may be normalized so that their sum is unity (i.e. one).

In some embodiments, N14 may be selected per-TSCI 1D transform by analyzing all N1 per-TSCI characteristic values. To select the N14 selected per-component 1D transforms, all N1 per-TSCI 1D transforms may be analyzed and compared. And N1 per-TSCI characteristic values may be computed, one for each of the N1 per-TSCI 1D transforms. The N14 selected per-TSCI 1D transforms may then be selected based on the N1 per-TSCI characteristic values. The N14 selected per-TSCI 1D transforms may comprise/be the per-TSCI 1D transforms associated with one of: maximum (100-percentile) characteristic value, or top (or largest) N14 characteristic values, or multiple local maxima, or min (0-percentile) characteristic values, or bottom (or smallest) N14 characteristic values, or multiple local minima, or median (50-percentile) characteristic value, or a group of N14 percentile characteristic value around the median. The N14 selected per-TSCI 1D transforms may be associated with bottom (smallest) N14 per-TSCI characteristic values.

In some embodiments, all-device-pair level 1D transform may be performed as aggregate of N10*N1*N4 per-component 1D transform, or N10*N1 per-TSCI 1D transform, or N10 per-device-pair 1D transform. At the all-device-pair granularity level, a first all-device-pair 1D transform associated with all device-pairs may be computed as an aggregate of all the respective N1*N4 per-component 1D transforms associated with all the respective N4 CIC of CI of all respective N1 TSCI of all of the N10 device-pairs in the sliding time window. A second all-device-pair 1D transform associated with all device-pairs may be computed as another aggregate of all the respective N1 per-TSCI 1D transforms associated with the N1 TSCI of each of the N10 device-pairs in the sliding time window. A third all-device-pair 1D transform associated with all device-pairs may be computed as yet another aggregate of all the N10 per-device-pair 1D transforms associated with the N10 device-pairs in the sliding time window.

In some embodiments, the system may select lower granularity 1D-transform to compute all-device-pair 1D transform. The first/second/third all-device-pair 1D transform may be a weighted average of all, or a subset of, the respective lower-granularity 1D transforms. Some of the lower-granularity 1D transforms may be selected to compute the all-device-pair 1D transform while the remaining lower-granularity 1D transforms may be unselected. The weights for/of the selected lower-granularity 1D transforms (in the weighted average) may be non-zero while the weights for the unselected may be zero. The weight for a selected lower-granularity 1D transform may be the selected lower-granularity 1D transform evaluated at a pre-defined non-zero transform index (e.g. first non-zero transform index). The weights of all the selected lower-granularity 1D transforms may be normalized so that their sum is unity.

In some embodiments, the system may select the selected lower granularity 1D transform by analyzing the characteristic value in the lower granularity. To select the selected lower-granularity 1D transforms, all the lower-granularity 1D transforms may be analyzed and compared. A characteristic value may be computed for each of the lower-granularity 1D transforms, and the selected lower-granularity 1D transforms may be selected based on the characteristic values. The selected lower-granularity 1D transforms may comprise/be those associated with one of: maximum (100-percentile) characteristic value, or a plurality of top (or largest) characteristic values, or multiple local maxima, or min (0-percentile) characteristic values, or a plurality of bottom (or smallest) characteristic values, or multiple local minima, or median (50-percentile) characteristic value, or a plurality of percentile characteristic value around the median. The selected lower-granularity 1D transforms may be associated with a plurality of bottom (smallest) characteristic values.

In some embodiments, the system may perform sensing using motion statistics (MS) in sliding time window. In general, the sensing task (e.g. monitoring/detection/estimation/recognition/counting of presence/motion/breathing/vital-sign/fall-down/abnormality/movement/location/daily-activity of one or more objects) may be performed for each sliding time window by computing at least one motion statistics (MS) based on the respective N1 TSCI of each of the N10 device-pairs in the sliding time window. For example, motion detection may be performed by comparing a MS with a threshold. Object motion may be detected if at least one MS is greater than some threshold. The motion statistics (MS) may be computed at different granularity: for all-device-pairs, per-device-pair, per-TSCI and/or per CIC/TSCIC/component. The granularity level of the MS may be chosen to achieve different tradeoff between sensing task performance and sensitivity to any change in: (a) spatial arrangement of the device-pairs, (b) amount of spatial streams (or wireless links, or antenna-pairs), (c) amount of CIC (or channel bandwidth). An MS may be computed as/computed based on a feature of a N11-point 1D transform.

In some embodiments, a per-component/per-TSCIC MS may be computed for each TSCIC of each TSCI of each device-pair (or for each of respective N4 TSCIC of each of respective N1 TSCI of each of N10 device-pair) based on the CIC Of a plurality of CI of the TSCI in a sliding time window. There may be N4 per-component MS for each TSCI in the sliding time window. There may be N1*N4 per-component MS for each device-pair in the sliding time window. In some embodiments, a per-TSCI MS may be computed for each TSCI of each device-pair. The per-TSCI MS for a particular TSCI of a particular device-pair may be computed as an aggregate of all N4 per-component MS associated with the N4 CIC of CI of the particular TSCI of the device-pair. There may be N1 per-TSCI MS for the device-pair, each per-TSCI MS associated with respective one of N1 TSCI. In some embodiments, a first per-device-pair MS for a device-pair may be computed as an aggregate of all respective N1 per-TSCI MS associated with all respective N1 TSCI of the device-pair. A second per-device-pair MS for the device-pair may be computed as another aggregate of all respective N1*N4 per-component MS associated with all respective N4 CIC of CI of all respective N1 TSCI of the device-pair. There may be N10 per-device-pair MS associated with the N10 device-pairs. In some embodiments, a first all-device-pair MS may be computed as an aggregate of all N10 per-device-pair MS associated with the N10 device-pairs. A second all-device-pair MS may be computed as another aggregate of all N10*N1 per-TSCI MS associated with all respective N1 TSCI of all N10 device-pairs (assuming N1 is same for all device-pairs). A third all-device-pair MS may be yet another aggregate of all N10*N1*N4 per-component MS associated with all respective N4 TSCIC of all respective N1 TSCI of all N10 device-pairs (assuming N1 is same for all device-pairs and N4 is same for all TSCI).

In some embodiments, any MS at a granularity level may also be computed based on at least one 1D transform/k-D transform matrix at the granularity level. Any MS may comprise/be one of: a time reversal resonance strength (TRRS), an inner product of two adjacent CI vectors, a similarity score between two adjacent CI vectors, or a feature of 1D transform. The feature may be the 1D transform evaluated at a particular transform index/coefficient (e.g. ACF evaluated at a particular time lag such as one sampling period, or tau=1/Fs). The feature may be close to zero in a stationary environment and positive in a dynamic environment with object motion. Thus motion may be detected when the MS is greater than some threshold.

In some embodiments, the system may utilize all-device-pair statistics and sensitivity to spatial arrangements of N10 device-pairs. If the sensing task is performed/carried out using all-device-pair statistics (e.g. all-device-pair 1D transform/k-D transform/MS/TSCI) of the sensing system (e.g. using the all-device-pair statistics as input to a neural network), the sensing system may have a tendency to be sensitive to the spatial arrangement of the N10 device pairs. An advantage of the use of the all-device-pair statistics is that, if the spatial arrangement of the N10 device pairs do not be changed in the future, the all-device-pair statistics may allow the system to have very good/superior sensing task performance. A disadvantage of the use of the all-device-pair statistics is that, if the spatial arrangement of the N10 device pairs are changed/moved/altered (e.g. moving the one/more device pairs in same venue, or simply being in a different/new venue), the sensing task performance/characteristics of the sensing system may be significantly affected/degraded/deteriorated.

In some embodiments, the system may utilize per-device-pair MS and sensitivity to spatial arrangements of N10 device-pairs. If the sensing task is performed/carried out using per-device-pair statistics (e.g. per-device-pair 1D transform/k-D transform/MS/TSCI) of the sensing system (e.g. using the per-device-pair statistics as input to a neural network), the sensing system may not be sensitive to the spatial arrangement of the N10 device pairs. This is because many/various/a plethora of spatial arrangements of the N10 device pairs may be used to train/tune/configure the sensing system. An advantage of the use of per-device-pair statistics is that, if there is no change to the amount of antenna pairs or of spatial streams, the sensing system should have good performance. A disadvantage is that it may still be sensitive to any change/alteration/difference in antenna pairs/spatial streams in each device-pair.

In some embodiments, the system may perform sensing using MS in a time period. Sometimes, sensing task (monitoring/detection/estimation/recognition/counting of presence/motion/breathing/vital-sign/fall-down/abnormality/movement/location/daily-activity of objects) may be performed erroneously/sporadically due to noise and may lead to false positive/negative. To avoid false positive/negative, only when monitoring/detection/estimation/recognition/counting is valid/repeated in sufficient number of sliding time windows in the time period (i.e. when a percentage of sliding time windows with positive/negative object monitoring/detection/estimation/recognition/counting) is greater than a threshold (e.g. 30%, 50%, 70%, 90%), object monitoring/detection/estimation/recognition/counting may be confirmed to be positive/negative in the time period. There may be additional (temporally adjacent/neighboring) time periods in which object motion is monitored/detected/estimated/recognition/counted. Alternative way to detect object motion in time period. Alternatively, an extended time period may be found in which object motion may be detected. The extended time period may be partitioned into the time period and addition time periods.

In one embodiment/example, the multiple classification/detection outcomes may comprise a presence or an absence of user/intruder. The classification/detection may be performed when object motion is detected in the time period.

In some embodiments, the system may perform assembling/combining/concatenating 1D transform to form 2-D transform. To compute/generate/prepare for input to the DNN/model/FM/LLM, multiple 1D transforms associated with a TSCI may be concatenated/grouped/combined together to form a k-dimensional (“k-D”, such as 2-D or 3-D or 4-D or higher D) transform matrix. There may be N9 sliding time windows in the time period. Recall that a 1D per-TSCI N11-point transform may be computed based on a TSCI for each of the N9 sliding time windows in a time period, each N11-point 1D transform represented as a N11-tuple vector. For the TSCI, the N9 vectors associated the N9 1D N11-point transforms (at a granularity of per-TSCI) in the time period may be assembled/combined/concatenated to form a 2-dimensional (2-D) matrix (called “transform matrix” or “spectral matrix”) of size N11×N9 (at the granularity of per-TSCI), each 1D transform (vector) being a column of the 2-D matrix. The horizontal axis of the 2-D transform matrix may be time axis and the vertical axis may be transform axis (e.g. frequency axis for 1D transform being STFT, or time-lag axis for 1D transform being ACF). An N11×N9 2-D transform matrix may be computed for each TSCI of each device-pair. Alternatively, a 1D per-TSCIC N11-point transform may be computed based on a TSCIC of the TSCI for each of the N9 sliding time windows in the time period, each N11-point 1D transform represented as a N11-tuple vector. For the TSCIC of the TSCI, the N9 vectors associated the N9 1D N11-point transforms (at a granularity level of per-TSCIC) in the time period may be assembled/combined/concatenated to form a 2-D) matrix (transform/spectral matrix) of size N11×N9 (at the granularity of per-TSCIC), each 1D transform (vector) being a column of the 2-D matrix. The horizontal axis of the 2-D transform matrix may be time axis and the vertical axis may be transform axis. A N11×N9 2-D transform matrix may be computed for each TSCIC of the TSCI. As there may be respective N4 CIC in CI of the TSCI, there may be N4 such N11×N9 2-D transform matrices for the TSCI. Note that N4 may be different for different device-pair.

In some embodiments, the system may perform a construction of k-D transform matrices. For each device-pair, there may be N1 TSCI and thus N1 associated 2-D transform matrices each of size N11×N9. The N1 2-D transform matrices may be combined/assembled/concatenated to form a 3-D transform matrix of size N1×N11×N9. For the venue, there may be N10 device-pairs and thus N10 associated 3-D transform matrices each of size N1×N11×N9. The N10 3-D transform matrices may be combined/assembled/concatenated to form a 4-D transform matrix of size N10×N1×N11×N9. In some situations, multiple venues (e.g. living room, dining room, kitchen, second floor, etc.) may be considered together for a task. The multiple 4-D transform matrices may be combined/assembled/concatenated (e.g. recursively) further to form 5-D or higher dimensional transform matrices. Any k-D transform matrix may be computed at one of the granularity levels: per-TSCIC/per-TSCI/per-device-pair/all-device-pair.

For per-TSCIC k-D transform matrix, when per-TSCIC (per-component) 1D transform is used, the resulting k-D transform matrix (e.g. 2-D transform matrix of size N11×N9) is a per-component k-D transform matrix. There may be N4 per-component 1-D N11-point transform computed based on respective CIC of CI of each TSCI for each of N9 sliding time windows in the time period. For each TSCI, there may be N4 per-component 2-D transform matrices each of size N11×N9. For each device-pair, there may be N4 per-component 3-D transform matrices each of size N1×N11×N9. For the venue, there may be N4 per-component 4-D transform matrices each of size N10×N1×N11×N9.

For per-TSCI k-D transform matrix, when per-TSCI 1D transform is used, the resulting k-D transform matrix (e.g. 2-D transform matrix of size N11×N9) is a per-TSCI k-D transform matrix. There may be one 1-D per-TSCI N11-point transform computed based on CI of each TSCI for each of N9 sliding time windows in the time period. For each TSCI, there may be one per-TSCI 2-D transform matrices each of size N11×N9. For each device-pair, there may be one per-TSCI 3-D transform matrices each of size N1×N11×N9. For the venue, there may be one per-TSCI 4-D transform matrices each of size N10×N1×N11×N9.

In some embodiments, all 2-D, 3-D and 4-D transform matrices may be of size N11×N9. N1×N11×N9 and N10×N1×N11×N9 respectively for all granularities, regardless of any/all differences between difference device-pairs, including difference in bandwidth, amount of TX antennas, amount of RX antennas, etc. Although different device-pairs may have different N1 and N4, the size of 2-D transform matrices may be independent of N1 and N4. Such dimension constancy of 2-D transform matrices may make them suitable as input to the CNN. This also make it possible to use 2-D transform matrices at a first granularity (e.g. lower granularity such as per-TSCI) as additional/supplementary/reasonable 2-D transform matrices to train the deep learning network which expects 2-D transform matrices at a second granularity (e.g. higher granularity such as per-device-pair). In particular, when training data (e.g. 1D transform, 2-D transform matrix) is insufficient at the second granularity, some of the first granularity data may be used as supplementary/additional/reasonable training data to train the DNN.

In some embodiments, the system may perform a construction of “d-transform” matrices as input to DNN/model/FM/LLM (instead of transform matrices). Alternatively, a derivative (e.g. first/second/third order) or differential of the 1D transforms (called “ID d-transform”, or “ID A-transform”) may be computed at any granularity (e.g. per-TSCIC/per-TSCI/per-device-pair/all-device-pair). The 1D d-transform may be used in place of the 1D transform to generate/construct the k-D transform, and the resulting k-D transforms are called k-D d-transform. In particular, all the 1D d-transforms in the time period may be assembled/concatenated to form a 2-D d-transform matrix of size N11×N9, each 1D d-transform being a column of the 2-D d-transform matrix. The horizontal axis of the 2-D d-transform matrix may be time axis and the vertical axis may be transform axis. And recursively, a plurality of k-D d-transform matrices may be assembled/combined/concatenated to form a (k+1)-D d-transform matrix. The k-D matrices may be fed as input or used to construct an input to the DNN/model/FM/LLM.

In some embodiments, the system may use CNN as feature extraction module of DNN/model/FM/LLM. The k-D transform matrices and/or additional k-D transform matrices (or, alternatively, the k-D D-transform matrix and additional k-D D-transform matrices) may be fed as input to a feature extraction module of the DNN to compute/derive/extract features from the k-D transform matrices (or k-D d-transform matrices). The feature extraction module may be a convolutional neural network (CNN) or an encoder of a transformer architecture. In each layer of the CNN, the multiple convolution filters may be applied concurrently/contemporaneously/sequentially/independently (e.g. in any order) to each of the plurality of transforms/d-transforms matrices. The output of the CNN may be rearranged/flattened/concatenated/reorganized to form a data structure for inputting to the stage-2 network. The stage-2 network may compute an output analytics for each outcome class. Among the multiple output analytics, the maximum one may be identified and the associated outcome class may be selected as the classifier output.

In some embodiments, in a training phase, both the stage-1 network and the stage-2 network may be trained using training data (e.g. labeled training data). For each outcome/event/action/situation class, the respective collection of training TSCI may be obtained based on training wireless signals transmitted from training Type1 devices to training Type2 devices when situation/events/actions associated with the outcome class occurred. However, for some reason, there may be insufficient/not-so-many training data for a particular outcome/event/action/situation class. In an operating/inference phase, the 1D transforms and the subsequent 2-D transform matrices may be computed at a target granularity level (e.g. at per-device-pair level) based on TSCI obtained based on wireless signals transmitted from Type 1 devices to Type2 devices.

In the training phase, the 1D transforms and the subsequent 2-D transform matrices may be computed at more than one granularity levels comprising the target granularity level and at least one other granularity level. For example the at least one other granularity level (e.g. at per-TSCI level) may comprise a level lower than the target granularity level (e.g. at per-device-pair level). For the outcome classes with sufficient training data, the 1D transforms and the subsequent 2-D transform matrices may be computed at the target granularity level only. But for at least one outcome class with insufficient training data, the 1D transforms and the subsequent 2-D transform matrices may be computed at both the target granularity level (e.g. at per-device-pair) and at least one other level (e.g. at per-TSCI level). In additional to the target level 2-D transform matrices, the at least one other level of 2-D transform matrices may be used as training data to train the deep learning network.

In some embodiments, a foundation model may be used for wireless sensing. A foundation model may be a type of large-scale machine learning models (e.g. AI model) trained on vast amounts of wireless sensing data (e.g. the N1 TSCI for each device-pair) to perform a wide range of wireless sensing tasks. These models may be designed to serve a general purpose starting point for various downstream applications, such as wireless sensing, motion detection, presence detection, intrusion detection, breathing/vital sign detection, sleep monitoring, occupancy detection, daily activity monitoring, fall detection, motion recognition, gesture recognition, gait recognition, locationing/positioning, navigation, multimodal tasks, speech enhancement, voice activity detection, natural language processing, image, video, speech, audio, etc. Foundation models may be typically pre-trained on massive datasets and then fine-tuned for specific task.

Foundation models may have these key characteristics: (1) Scale. They may be trained on large datasets and may have billions of parameters. (2) Generalization. They may be adapted to multiple tasks across different domains. (3) Transfer learning. They may leverage knowledge from pre-training to improve performance on specific tasks with minimal additional training. (4) Versatility. They may be used for tasks like text generation, translation, summarization, image recognition, wireless sensing tasks such as motion/presence/location estimation, breathing detection, fall detection, and more. Some examples of foundation models for natural language processing (NLP) may comprise (1) GPT (Generative Pre-trained Transformer) series such as GPT-3, GPT-4, (2) BERT (Bidirectional encoder representations from Transformers), (3) T5 (Text-to-Text Transfer Transformer). Some example of multimodal foundation models may comprise (1) CLIP (Contrastive Language-Image Pretraining), (2) DALL-E (which generates images from text prompts). Some example of foundation models for computer vision may comprise (1) Vision Transformers (ViT). Some challenges for foundation models may be: (1) high computational costs for training, (2) potential biases in the data. (3) environmental impact due to energy consumption.

In some embodiments, foundation models may be built using various architectures, depending on the type of data (e.g. text, images, audio, TSCI, etc.) and the tasks they may be designed to perform. Some example architectures used for foundation models include: Transformer architecture, Pre-training and Fine-Tuning. Scalability, and Transfer Learning.

Transformer architecture: foundation models may be based on the Transformer architecture. Key features may include: (a) self-attention mechanism, which may allow the model to handle long range dependencies and weight the importance of different parts of the input data dynamically. (b) Scalability, which may allow transformers to handle large-scale data and parallelize computations efficiently. (c) Layered-structure, which may comprise multiple encode and decoder layers (though some may use only encoders or decoders). The encoder may have a stack of layers and the decoder may have a stack of identical layers. Each layer may have two sub-layers: a multi-head self-attention mechanism and a position-wise fully connected feed-forward network.

Pre-training and Fine-Tuning: foundation models may be pre-trained on massive datasets using unsupervised or self-supervised learning objectives (e.g. masked language modeling, next-token prediction). After pre-training, the models may be fine-tuned on specific downstream tasks with smaller, task specific datasets. This two-phase approach may allow the model to learn general features from the large dataset and then specialize for specific tasks.

Scalability: foundation models may be designed to scale with increasing computational resources and data. This may comprise scaling up: (a) model size, which is the number of parameters (e.g. billions or trillions), (b) data size, which is the amount of training data (e.g. terabytes of text or images), (c) compute resource used for training on large scale GPU/TPU. The foundation models may be designed to scale with more data and more parameters.

Transfer Learning: a key feature of foundation models may be their ability to transfer knowledge from one task to another. This may be facilitated by the pre-training phase, where the model may learn a wide range of features and patterns that may be generally useful across many tasks.

In some examples, for each training data (e.g. each training data comprising at least one of: 1D/k-D transform matrix, 1D/k-D matrix of CI measurements, 1D/k-D matrix of other measurements, at least one sequence of 1D/k-D matrices; the other measurements may comprise any of: other wireless measurements such as RSSI, interference info, system state/settings/parameters, other sensor inputs such as audio, imaging, video, pressure, etc.) of a foundation model, a plurality of associated derived/augmented training data may be computed by performing data augmentation on the training data and/or additional training data. There may be multiple ways to perform data augmentation. The system may perform swapping/reordering/interchanging/reorganizing/altering multiple submatrices of a 1D/2D/k-D matrix. For a 1D matrix/vector, the submatrix may be simply a 1-D submatrix comprising some of the elements/components of the 1D matrix/vector. The elements/components (i.e. the corresponding component indices) may be consecutive or non-consecutive. For a 2-D matrix, a submatrix may be a 1-D submatrix such as a row vector comprising a row or part of a row, a column vector comprising a column or part of a column, a diagonal/anti-diagonal vector comprising diagonal (or off-diagonal) or anti-diagonal (or off-anti-diagonal) elements/components, a directional vector comprising matrix elements/components in a direction. A submatrix may be a 2-D submatrix comprising components/elements in multiple rows and columns (i.e. components in 2 directions, each direction being any of: row, column, diagonal, anti-diagonal, or arbitrary direction). The 2-D submatrix may comprise multiple consecutive/non-consecutive rows/columns. The 2-D submatrix may comprise a sampling (e.g. subsampling, horizontal/vertical/diagonal/anti-diagonal/directional subsampling, periodic/aperiodic/random sampling) of matrix elements/components. The 2-D submatrix may be a rectangular submatrix (a “full” rectangular submatrix with all submatrix elements obtained from the 2-D matrix). The 2-D submatrix may be a collection of submatrix rows/submatrix columns of different lengths (forming a “non-full” rectangular submatrix, with some submatrix elements being empty, i.e. not obtained from the 2-D matrix). Similarly, for a k-D matrix, a sub-matrix may be a 1-D submatrix, a 2-D submatrix, a 3-D submatrix . . . a (k−1)-D submatrix, or a k-D submatrix. A 1-D submatrix may be a vector/1D submatrix comprising elements/components in a row/column/direction. A 2-D submatrix may comprise elements/components in two directions (e.g. any two of the k dimensions, or any two “diagonal” or “anti-diagonal” directions, or any two arbitrary directions). A (k2)-D submatrix may comprise elements/components in k2 directions, for any k2<=k (e.g. any k2 of the k dimensions, any k2 “diagonal” or “anti-diagonal” directions, or any k2 arbitrary directions). A k2-D submatrix may comprise a sampling (e.g. subsampling, directional subsampling, random sampling) of matrix elements/components in the k2 directions. The (k2)-D submatrix may be a “rectangular” submatrix (a “full” submatrix with all submatrix elements being obtained from the k-D matrix). The (k2)-D submatrix may be a collection of smaller dimensional submatrix of different submatrix size (forming a “non-full” submatrix, with some elements being empty, i.e. not obtained from the k-D matrix).

In some examples, single submatrix reorganization/alteration may be performed. A submatrix may be partitioned into multiple partitions, each partition comprising some of the submatrix elements/components. The partitions may be disjoint/not disjoint. A submatrix (or a partition of the submatrix) may be rotated, with submatrix components/elements being rotated in a fashion similar to bits being rotated in a bitwise rotation of a byte/word in computers. A submatrix (or a partition of the submatrix) may be shifting, with submatrix components/elements shifted in a similar fashion as bitwise shifting. A submatrix (or a partition of the submatrix) may be permuted/shuffled, with submatrix components/elements being permuted/shuffled/re-ordered in many possible orders.

Scaling. A submatrix (or a partition of the submatrix) may be scaled. Each submatrix component/element may be scaled by a respective scaling factor. The scaling factors of different submatrix/element components may be same/different. A submatrix (or a partition of the submatrix) may be replaced by a similar patch/submatrix/partition. A submatrix (or a partition of the submatrix) may be resized (becoming bigger or smaller). Resizing factor may be different for different dimensions. A submatrix (or a partition of the submatrix) may be moved to another location. A submatrix (or a partition of the submatrix) may be distorted along an axis. Noise (e.g. Gaussian, impulsive, salt-and-pepper) may be added to a submatrix (or a partition of the submatrix). A submatrix (or a partition of the submatrix) may be filtered (e.g. lowpass filtering, highpass filtering, contrast enhanced, edge detection, blurring). A submatrix (or a partition of the submatrix) may be removed. It may be replaced/masked by a predefined value (e.g. zero) or pattern (e.g. noise patch/submatrix/partition). A submatrix (or a partition of the submatrix) may be replaced by blending (e.g. weighted averaging) of two or more patches/submatrices/partitions. A submatrix (or a partition of the submatrix) may be replaced a patch/submatrix/partition from another matrix. The patch/submatrix/partition may be synthesized based on the another matrix.

In some embodiments, two (or more) submatrices may be swapped/shuffled. For 1D vector/matrix, two vector components may be swapped. The two components may be adjacent to each other with a distance (of associated component indices) of one. The two components may not be adjacent to each other, with a distance greater than one. The component indices of the two components may be a predefined constant, or a dynamically generated (adaptively changed) quantity. For 2-D matrix, the two 1-D submatrices may be adjacent to each other at a distance of one (e.g. one submatrix is row 2 and the other is row 3, with the two rows having a row distance or offset distance of one), or not adjacent to each other with a distance greater than one (e.g. one is row 2 and the other is row 5, with a distance of 3). For the 2-D matrix, the two submatrices may be 2-D submatrices. The two 2-D submatrices may have an “offset distance” of one or more than one. Similarly, for k-D matrix, the (k2)-D submatrices may have an offset distance of one or more than one.

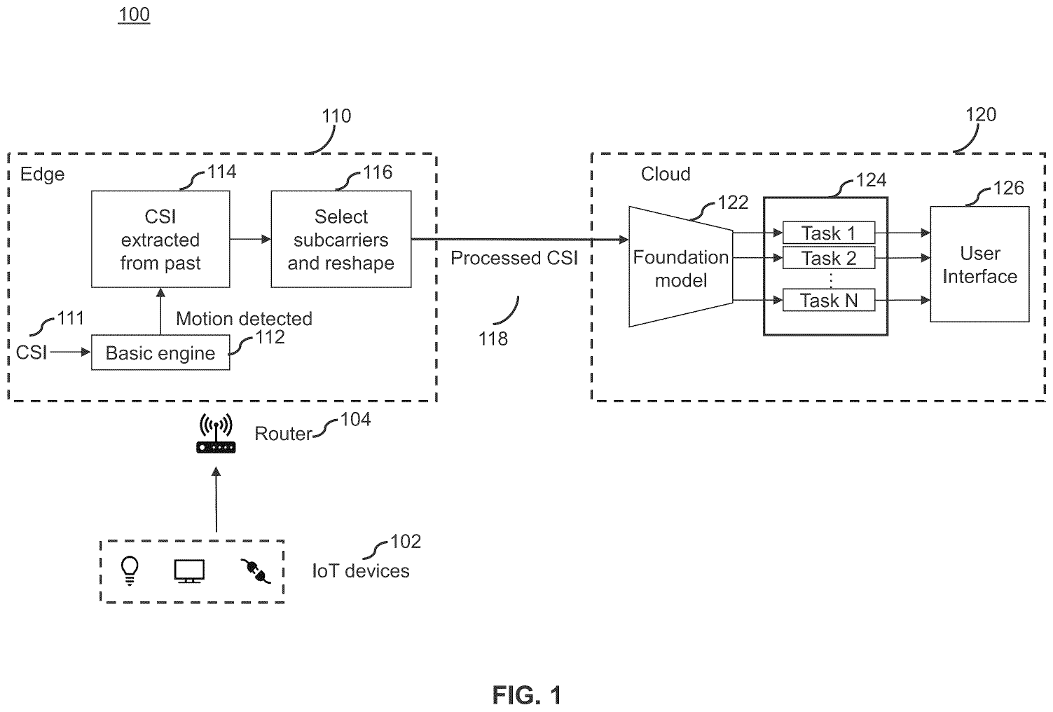

FIG. 1 illustrates an example framework of a system 100 for wireless sensing using a foundation model, according to some embodiments of the present disclosure. As shown in FIG. 1, the system 100 may collect CSI 111 based on wireless signals transmitted from one or more IoT devices 102 to a router 104. In general, the CSI 111 may be any channel information (e.g. CSI, CFR, CIR, etc.) collected based on wireless signals transmitted from a transmitter to a receiver. In some embodiments, the transmitter may serve as a Bot (e.g. Type1 device), while the receiver may serve as an Origin (e.g. Type2 device). A Bot can transmit a wireless signal to the Origin in a venue (e.g. a house), to obtain channel information of a wireless multipath channel based on the wireless signal, where the channel information of the wireless multipath channel may be impacted by motion/presence of any object/user in the venue.

In some embodiments, an edge device 110 (e.g. a local device or local server) may process the CSI 111 to generate processed CSI 118. In the example shown in FIG. 1, the edge device 110 includes a basic engine 112 configured to determine whether a triggering event (e.g. motion detection) happens based on the CSI 111. If a motion is detected by the basic engine 112, the edge device 110 may extract, at operation 114, an immediate past portion of the CSI 111 within an immediate past time period (e.g. past 5 seconds, past 10 seconds). At operation 116, the edge device 110 may process the extracted CSI data based on data augmentation. For example, the edge device 110 may select subcarriers for at least one of the extracted CSI data to ensure all extracted CSI data have a same number of subcarriers according to a standardized format that is suitable for a foundation model 122, and resample each of the extracted CSI data to a predetermined temporal rate according to the standardized format. In some embodiments, the data augmentation performed may further include at least one of: adding random noise to the extracted CSI data; randomizing the selected subcarriers within a block; performing a time scaling or a time warping on the extracted CSI data; simulating at least one environmental parameter related to multi-path change or occlusion; and normalizing amplitudes of the extracted CSI data to mitigate power variation. As such, the edge device 110 may generate the processed CSI 118 which has the standardized format readable by the foundation model 122.

The edge device 110 may transmit the processed CSI 118 to a cloud server 120. As shown in FIG. 1, the cloud server 120 includes the foundation model 122, a plurality of task-specific models 124 and a user interface 126. For example, the processed CSI 118 may be transmitted to the foundation model 122 for training and/or executing the foundation model 122. In some examples, taking the processed CSI 118 as an input, the foundation model 122 may output a feature map representing channel related features and/or sensing related features. The feature map may be utilized by each of the plurality of task-specific models 124 to perform a corresponding one of wireless sensing tasks, e.g. motion detection, user presence detection, breathing/heartbeat detection, fall down detection, intruder detection, etc. In some embodiments, one or more of the task-specific models 124 are selected to perform corresponding wireless sensing tasks using the feature map generated by the foundation model 122, e.g. based on a user instruction during an inference phase. As such, the foundation model 122 is always utilized to perform any of the wireless sensing tasks, while each of the task-specific models 124 is merely utilized to perform a corresponding one of the wireless sensing tasks.

In some embodiments, the plurality of task-specific models 124, which are downstream task models, may be trained based on the foundation model 122. For each downstream task, the system can fine-tune the downstream task model and the foundation model together using supervised data, or freeze the foundation model for all tasks and only tune the downstream task model. In some examples, the plurality of task-specific models 124 may be trained by freezing all model parameters of the foundation model 122 during the training of the plurality of task-specific models 124. In some examples, the plurality of task-specific models 124 may be trained by fine-tuning all model parameters of the foundation model 122 based on at least one task-specific prediction loss during the training of the plurality of task-specific models 124. In some examples, the plurality of task-specific models 124 may be trained by: freezing model parameters of an upstream layer of the foundation model 122, and fine-tuning model parameters of a downstream layer of the foundation model 122. Each of the plurality of task-specific models 124 may be a downstream model compared to the foundation model 122.

In some embodiments, the foundation model 122 may be trained when the model design is finalized and a certain amount of data has been collected. In some embodiments, the downstream task models may be trained after the foundation model 122, which can capture some high-level representations, is trained and a designed model is ready for each downstream task. The labeled data may be used to train the downstream model, where the output of an encoder of the foundation model 122 may be the input of the downstream model. The foundation model 122 may be updated on the cloud server 120. For example, with more data collected, the foundation model 122 may be re-trained where the weights of the foundation model 122 may be updated and saved on the cloud server 120.

In some embodiments, the foundation model 122 may be trained based on self-supervised machine learning without labelled data. Each of the plurality of task-specific models 124 may be trained based on labelled data.

In some embodiments, each of the plurality of task-specific models 124 may be used to perform a corresponding one of the plurality of wireless sensing tasks together with the foundation model 122. The sensing results of the wireless sensing tasks may be presented via the user interface 126, which may be a website-based user interface or an APP-based user interface, to one or more users. In some embodiments, different sensing results of the wireless sensing tasks may be presented via different user interfaces.

In some embodiments, during a training phase, a training dataset may be generated by the edge device 110 and transmitted from the edge device 110 to the cloud server 120. The foundation model 122 and the plurality of task-specific models 124 may be trained by the cloud server 120.

During an inference phase, the plurality of wireless sensing tasks may be performed by: collecting and processing real-time CI data by at least one local device or edge device to generate processed real-time CI data; determining, by the at least one local device, whether a triggering event happens based on the processed real-time CI data; in accordance with a determination that the triggering event happens, transmitting an immediate past portion of the processed real-time CI data within an immediate past time period from the at least one local device to a cloud server; and performing, by the cloud server, a wireless sensing task corresponding to the triggering event based on the immediate past portion of the processed real-time CI data using the trained foundation model and a trained task-specific model corresponding to the wireless sensing task.

In some embodiments, the CSI 111 may be raw CSI generated by the router 104 based on data transmitted from the one or more IoT devices 102 to the router 104. In some examples, the edge device 110 may be a device coupled to or integrated with the router 104. When there is a trigger on the edge device 110 (e.g., motion detection), the edge device 110 can send the processed CSI 118 of past several seconds (following a unified format) to the cloud server 120 as an input to the foundation model 122.

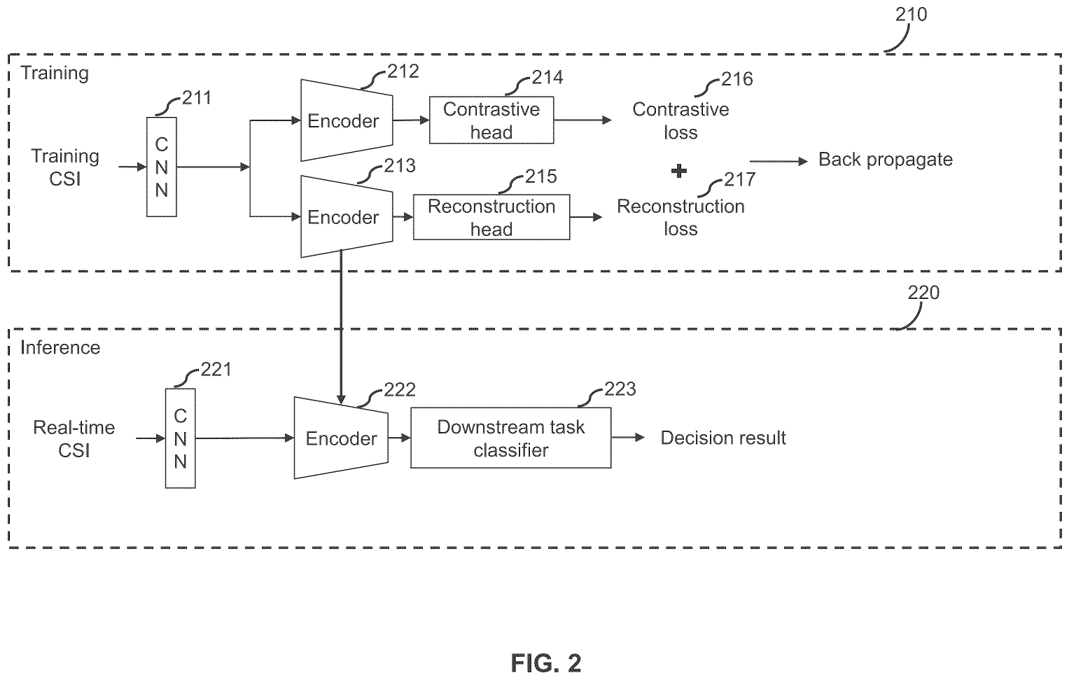

FIG. 2 illustrates example processes 210, 220 for training and executing a foundation model for wireless sensing, according to some embodiments of the present disclosure. In some embodiments, the foundation model may be implemented as the foundation model 122 in FIG. 1. In the example of FIG. 2, the foundation model may be implemented as an encoder. In some examples, the process 210 shows a process for training the foundation model, while the process 220 shows a process for executing the foundation model.

During the process 210, a training dataset (e.g. CSI data used for training) may be processed by a CNN 211, e.g. based on some data augmentation techniques as discussed above, before being used to train the foundation model. In this example shown in FIG. 2, two copies of the foundation model are represented by two encoders 212, 213 respectively, and are trained to minimize a contrastive loss function 216 and a reconstruction loss function 217 respectively and simultaneously. In some embodiments, the entire foundation model including the CNN 211 and the encoders 212, 213 may be placed on a cloud server. In some embodiments, the CNN 211 may be placed on an edge device while the encoders 212, 213 may be placed on the cloud server, to reduce data transmission cost.

In some embodiments, the training dataset may comprise: a plurality of CI pairs, original CI data and a mask. In some embodiments, the plurality of CI pairs comprises: a positive CI pair formed by a preprocessed CI and its associated augmented CI, a positive CI pair formed by two preprocessed CI, a positive CI pair formed by two augmented CI, a negative CI pair formed by two CI obtained from two different wireless channels, a negative CI pair formed by two CI obtained from two different venues, a negative CI pair formed by two CI associated with two different sensing events.

The contrastive loss function 216 may be determined by a contrastive head 214 of the foundation model based on a first similarity metric (e.g. an embedding distance) between CI data of each CI pair in the training dataset. In some embodiments, determining the contrastive loss function comprises: mapping each CI in the training dataset to a corresponding embedding point in an embedding space using the foundation model; for each CI pair comprising two CI in the training dataset, generating a distance score between two embedding points corresponding to the two CI of the CI pair based on the first similarity metric; and determining the contrastive loss function based on the distance score. For example, the distance score is smaller when the CI pair is a positive CI pair; the distance score is larger when the CI pair is a negative CI pair.

The reconstruction loss function 217 may be determined by a reconstruction head 215 of the foundation model based on a second similarity metric between the original CI data and predicted CI data generated based on the mask. In some embodiments, determining the reconstruction loss function comprises: generating masked CI data at least in part by applying the mask to the original CI data to remove at least one portion of the original CI data along a time dimension or a subcarrier dimension; generating the predicted CI data based on the masked CI data using the foundation model; generating an error function between the original CI data and the predicted CI data based on the second similarity metric; and determining the reconstruction loss function based on the error function.

In some embodiments, a total loss function may be determined based on an aggregate of the contrastive loss function and the reconstruction loss function. The model parameters of the foundation model may be determined, trained or learned to minimize the total loss function. For example, the aggregate of the contrastive loss function and the reconstruction loss function may comprise a weighted combination of the contrastive loss function and the reconstruction loss function. The weights used in the weighted combination may also be included in the model parameters of the foundation model and may be adjusted during the training to minimize the total loss function through an iterative back propagation process.

During the process 220, the trained foundation model (implemented as an encoder 222) may be executed to infer decision results for wireless sensing tasks, during an inference phase. In this example shown in FIG. 2, real-time CI data (e.g. real-time CSI) may be collected and then processed by CNN 221, e.g. based on some data augmentation techniques as discussed above, before being used as an input to execute the foundation model. Based on CI data collected in real-time, the trained foundation model (implemented as an encoder 222) may generate a feature map. The feature map may be input to a downstream task classifier 223, which may be one of a plurality of task-specific models, to perform a corresponding one of a plurality of wireless sensing tasks. The decision result generated by the downstream task classifier 223 may be based on the feature map, and may indicate a classification of the corresponding wireless sensing task (e.g. motion detected or not, type of moving subject, occupied or empty, fall down or not, user presence or not, etc.).

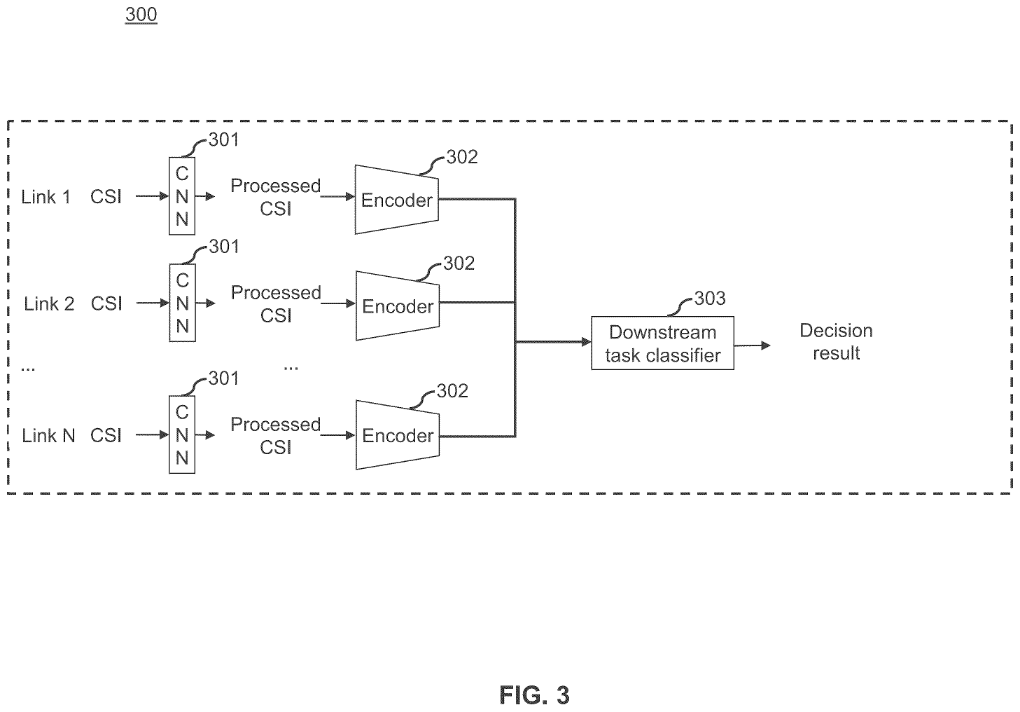

FIG. 3 illustrates an example method 300 for combing decisions for a wireless sensing task based on multiple links, according to some embodiments of the present disclosure. In some embodiments, there are multiple device pairs in at least one venue. Each of the device pairs is formed by a transmitter and a receiver. For each of the plurality of device pairs: a wireless signal is transmitted by the transmitter through a wireless channel to the receiver. The received wireless signal differs from the transmitted wireless signal due to the wireless channel and any sensing event in the at least one venue. A time series of channel information (TSCI) of the wireless channel may be obtained based on the received wireless signal. In some embodiments, real-time CI data may be collected based on all TSCI obtained for the device pairs. That is, during an inference phase, the real-time CI data may be collected from multiple wireless links. Each of the wireless links may correspond to a wireless channel between a transmitter and a receiver, or between a transmitting antenna and a receiving antenna. The real-time CI data may be utilized to perform at least one task of the plurality of wireless sensing tasks.

For each task of the at least one task, the system may process each real-time CI data collected from a corresponding one of the multiple wireless links using a corresponding CNN 301 to generate processed CI, and generate, using a corresponding copy of the foundation model 302, a corresponding feature map based on the processed CI. That is, the real-time CI data collected from multiple links may be processed in parallel and used to execute the foundation model 302 in parallel. In some embodiments, a same CNN 301 may process all real-time CI data in series, and a same copy of the foundation model 302 may be executed in series based on the processed CI.

In some embodiments, the system may fuse the plurality of feature maps generated by the foundation model 302 for the multiple links, e.g. along a subcarrier dimension or according to an index of each of the multiple wireless links, to generate a fused feature map. The system may input the fused feature map into a downstream task classifier 303, which may be a task-specific model corresponding to a wireless sensing task to generate a decision result for the wireless sensing task. In some embodiments, the downstream task classifier 303 may be a small transformer model or a RNN model that can take input of variant length.

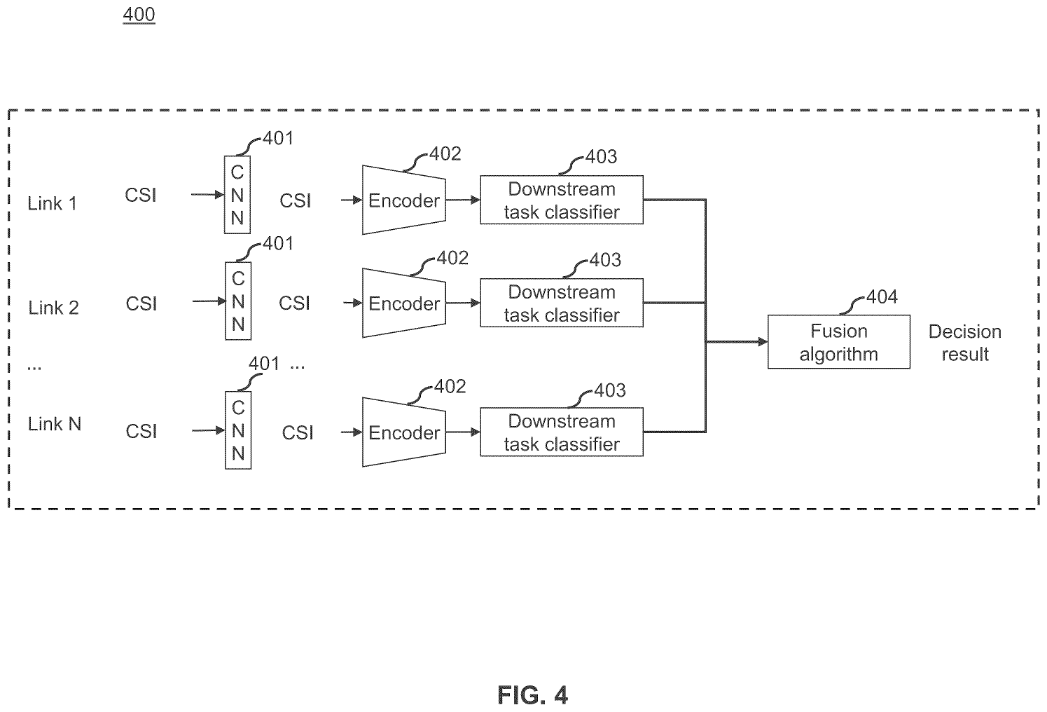

FIG. 4 illustrates another example method 400 for combing decisions for a wireless sensing task based on multiple links, according to some embodiments of the present disclosure. Similar to FIG. 3, real-time CI data may be collected from multiple wireless links, where each of the wireless links may correspond to a wireless channel between a transmitter and a receiver, or between a transmitting antenna and a receiving antenna. The real-time CI data may be utilized to perform at least one task of a plurality of wireless sensing tasks.

For each task of the at least one task, the system may process each real-time CI data collected from a corresponding one of the multiple wireless links using a corresponding CNN 401 to generate processed CI, and generate, using a corresponding copy of the foundation model 402, a corresponding feature map based on the processed CI. That is, the real-time CI data collected from multiple links may be processed in parallel and used to execute the foundation model 402 in parallel. In some embodiments, a same CNN 401 may process all real-time CI data in series, and a same copy of the foundation model 402 may be executed in series based on the processed CI.

In some embodiments, the system may input each of the plurality of feature maps generated by the foundation model 402 into a copy of the downstream task classifier 403, which may be a task-specific model corresponding to a wireless sensing task, to generate a candidate decision result for the task. The system may utilize a fusion model or algorithm 404 to fuse all candidate decision results generated for the task to generate a final decision result for the task.

In some examples, for a motion detection task, when X number of the candidate decision results indicate motion detected and Y number of the candidate decision results indicate no motion detected, the fusion model or algorithm 404 may determine the final decision result as motion detected or no motion detected based on a comparison between X and Y.

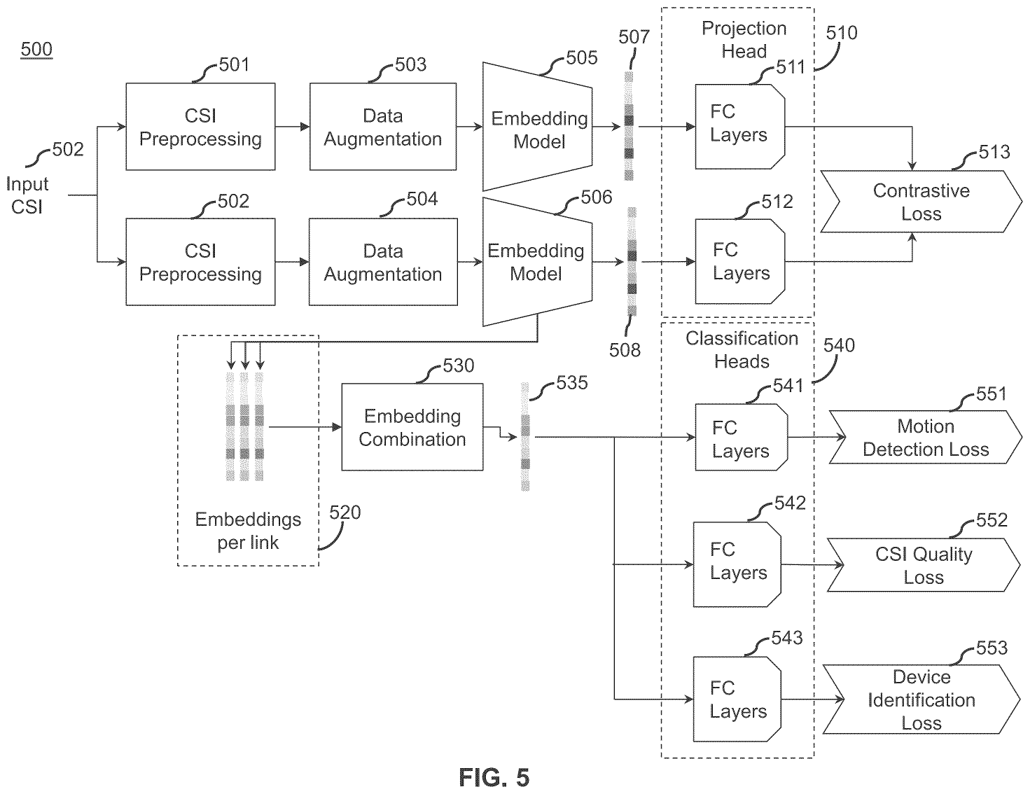

FIG. 5 illustrates an example process 500 for multi-task learning based on a foundation model, according to some embodiments of the present disclosure. In some embodiments, multiple tasks (including e.g. robust motion detection, presence detection, noisy device identification and filtering) may be desired at the same time. What these tasks have in common includes: CSI-based preprocessing and feature extraction, and some classification operation. To exploit the common structures and/or functions of these tasks, a system can utilize a shared encoder with multi-task training targets and unsupervised learning. The example process 500 illustrates a multi-step framework to achieve specific models, by fine tuning a classification head to enable different tasks.

In some embodiments, a system may receive input CSI 502, e.g. from various devices. The input CSI 502 may come from Wi-Fi links with different subcarriers and link configurations. The input CSI 502 may include CSI pairs, each pair having two different CSI with two different features, e.g. different channels, different venues, different subcarriers, etc. The two CSI may be processed in parallel to generate a contrastive loss 513, along a first branch of the process 500.

As shown in FIG. 5, the system may utilize various pre-processing methods 501, 502, including padding and data manipulation, and data augmentation methods 503, 504, to create a consistent and unified representation 507, 508 of the input CSI 502 regardless of its original format. The unified representation 507, 508 may be generated based on an embedding model 505, 506 (as part of a foundation model) for each CSI in each CSI pair, to ensure a fixed size and shape for each input to a projection head 510 of the foundation model.

In some embodiments, the data augmentation methods 503, 504 applied in the CSI domain may generate diverse versions of a same CSI data, to create two distinct representations of the same underlying information through small manipulations that do not alter the core data content. These augmentations may introduce randomness, resulting in different views of the same data when applied twice with varying parameters.

After two different augmented representations are fed into an embedding model, which can be off-the-shelf or custom-trained, a smaller feature vector (embedding) may be generated for each augmented representation. Then the embedding vectors may be input into the fully connected (FC) layers 511, 512 of the projection head 510 to ensure that the embedding vectors of the two different views (positive data pairs) of the same data are similar or close to each other, e.g. by minimizing the contrastive loss 513. Simultaneously, the model learns to differentiate embedding vectors from augmentations of different data samples (negative data pairs).

As shown in FIG. 5, the process 500 also includes a second branch from the embedding model 506, with classification heads 540 for training and/or performing downstream tasks like motion detection, CSI quality assessment, and device identification. This second branch may process individual links of a device (e.g., from multiple transmitter antennas to multiple receiver antennas) in parallel. An embedding combination method 530 may be used to consolidate the embedding vectors 520 from these parallel links into a single representation 535 that captures environmental information. The single representation 535 may be input into the FC layers 541, 542, 543 of the classification heads 540 to determine a motion detection loss 551, a CSI quality loss 552, a device identification loss 553, respectively. In some embodiments, more and/or alternative loss functions may be utilized for various tasks. During training, the losses from these multiple tasks may be combined with weights, to generate a total loss along with the contrastive loss from the first branch.

In some embodiments, the first branch related to contrastive learning may be referred to as pre-training as it involves learning representations without explicit manual labels, similar to how models are pre-trained on large datasets before fine-tuning for specific tasks in the second branch. Although pre-training and fine-tuning may occur concurrently, the concept of learning a general-purpose representation first still applies. In some embodiments, each of the embedding model 505, 506 (two copies) can act as an encoder in a foundation model. The pre-training may help the encoder to learn meaningful features from the unlabeled CSI data.

While the overall process 500 has some parallel aspects, the second branch related to classification may depend from the intermediate output of the upper embedding model 506. In some embodiments, the contrastive loss 513 primarily influences the FC layers 511, 512 and the embedding models 505, 506; and the loss functions 551, 552, 553 may influence the FC layers 541, 542, 543.

In some embodiments, the losses 513, 551, 552, 553 are combined together for training and are dynamically weighted. The contribution of the contrastive loss 513 relative to the downstream task losses 551, 552, 553 may change over the course of training. Initially, the contrastive loss may be weighted more heavily, but its importance may gradually decrease as the weights of the second branch increase over epochs. This can enable the model to first learn a good representation and then focus more on the specific downstream tasks.

Different loss functions may be combined to optimize the parameters of the upstream layers. When the tasks are related, combining losses can lead to synergistic improvements. The decision to combine losses and the weighting strategies may involve some experimentation.

The classification heads may directly correspond to the specific tasks the model is trained to perform. This enables the simultaneous training of a foundational model and task-specific classification models. In some embodiments, as discussed above, reconstruction heads may be utilized alongside the contrastive-loss based learning.

As such, the system may utilize various techniques for the multi-task learning, including: parallel processing of multiple links, embedding combination, modification to the contrastive loss function to handle similar samples from the same device or closely spaced time instances, data augmentation techniques with some adaptations for the specific domain, etc.

For example, the system can apply the contrastive loss 513 to Wi-Fi CSI data, where different links from the same device or temporally close samples exhibit high similarity. To address this high similarity, similar/dissimilar pairs need to be created for such instances during the contrastive loss calculation. This careful selection of pairs is crucial for the successful training of the loss function 513.

The system can achieve significant performance benefits by processing multiple links (e.g., from multiple antennas) in parallel instead of treating them as a single input. The embedding combination 530, which can use methods like averaging, max pooling, or neural networks, may aggregate the information from these parallel streams.

During the CSI pre-processing 501, 502, the system can standardize the input CSI 502 to a consistent size (e.g., 60 subcarriers and four links). When there are fewer links or subcarriers, the CSI pre-processing 501, 502 may include repeating samples. This repeating method for padding can improve training speed and performance compared to zero padding. When there are more links, the first four (or first N in general) are processed, and the remaining ones might be handled separately before combination.

For motion detection, the system may use a mapping based on experiment labels, where the experiment may be related to: walking, robot, fan, empty, fast-walking, jogging, running, etc., While human motion may be labeled as 1, the rest can be labeled as 0. For CSI quality, the system can use labels in the CSI verification dataset, which has motion/empty labels, and good/bad labels. For device identification, device names are included in filenames and folder-names. A device name table may be built to extract device names with a priority list, with high and medium confidence labels during device type classification.

In some embodiments, the CSI preprocessing 501, 502 can play at least two important roles: standardizing data inputs to make neural network (e.g. the foundation model) more flexible, and mitigating nonlinearities. The preprocessing steps may include the following: CSI normalization per packet to offset gain control, clipping or reshaping links to standardize input size, clipping or repeating subcarriers to standardize the input size. While randomly clip is performed during training, the system may only take the first L links and S subcarriers during testing and executing.

In some embodiments, the system can repeat subcarriers until reaching a certain size of subcarriers (e.g. 60), and a certain link size (e.g. 4). The system can combine embedding's of each link for any classification task, to ensure consistent input representation and added diversity during training.

In some embodiments, the contrastive loss 513 may be based on a Normalized Temperature-scaled Cross Entropy (NT-Xent) loss, the motion detection loss 551 and the CSI quality loss 552 may be based on a Binary Cross-Entropy (CE) loss, and the device identification or device type loss 553 may be based on a focal loss. In some embodiments, a training may be conducted with a cumulative loss function:

$${L}_{loss} = β ( t ) {l}_{nt - xent} + ( 1 - β ( t ) ) ( {l}_{food}^{device} + {l}_{ce}^{csiquality} + {l}_{ce}^{occ} )$$

where β is a parameter to balance pre-training with fine-tuning. Early epochs focus on pre-training, whereas later epochs focus on the fine-tuning tasks.

In some embodiments, parameters to be trained or learned may include: optimizer with weight decay, scheduler to reduce the learning rate over time, the batch size with distributed training, where the parameters are trained for a certain number (e.g. 10) epochs. In some embodiments, the system can adapt the weights of pre-training and fine-tuning over time. For example, the system can start with β=1, and reduce it 0.1 every epoch.

As described, not all data has labels for all tasks. As such, partial labels are utilized in the downstream multi-task learning where some data samples might have labels for only a subset of the tasks being trained, the system may continue training even when not all labels are available for every data point. In some examples, the system only calculates a loss function for existing labels. If no label exists, the loss may be set to 0 to enable backpropagation to keep the network connected, but has no gradients. In some embodiments, a successful implementation of mix-up (mixing labels with each other for robustness) may improve the performance further.

In some embodiments, the input CSI 502 is not divided but rather has two copies passed through potentially slightly different pre-processing 501, 502 and then data augmentation pipelines 503, 504 in parallel. This results in two different views of the same input, which are then used for contrastive learning. While a single pre-processing block followed by a split is possible, keeping them separate can enable a potential application of slightly different pre-processing steps to each stream.

In some embodiments, the data augmentation pipelines 503, 504 may utilize one or more of the following data augmentation techniques: random noise addition, cropping of subcarriers and time samples, reordering of subcarriers (with localized movements), salt and pepper noise, channel response augmentation (scaling samples with a vector). The data augmentation techniques may also include techniques for wireless sensing, including: Noise Injection, Scaling and Normalization, Subcarrier Shuffling and Selection, Time Scaling and Warping, Environmental Parameter Variation, etc. These methods may create diverse views of the data while preserving the underlying information.

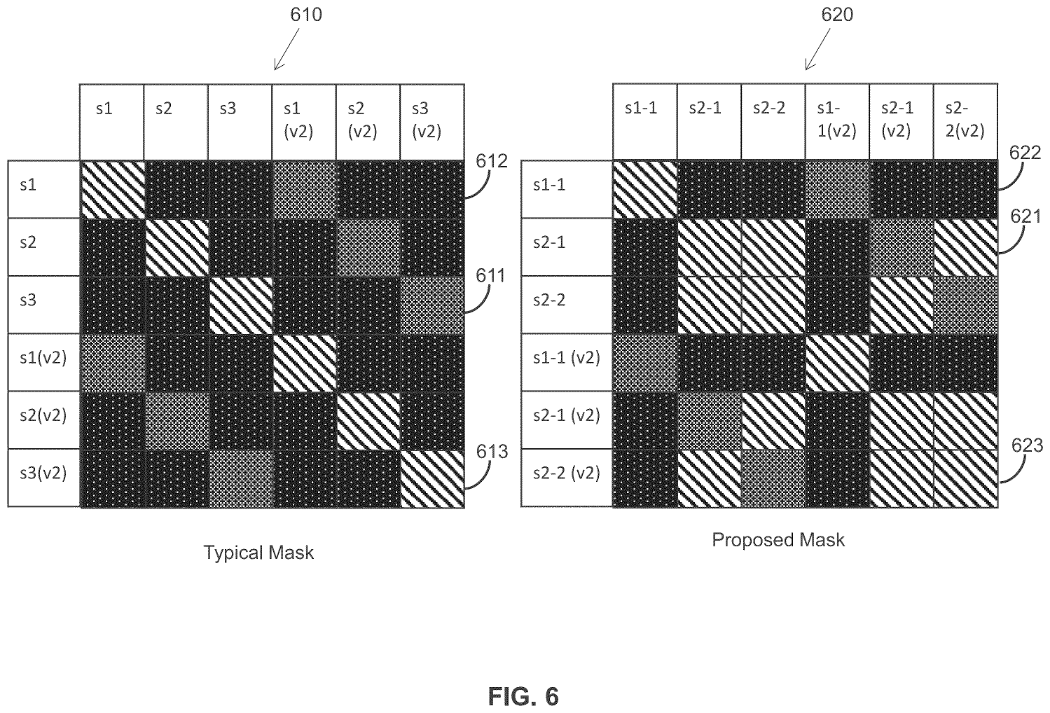

FIG. 6 illustrates an example mask used for contrastive loss, according to some embodiments of the present disclosure. As discussed above, multiple samples might be correlated, such that after processing, some positive sample pairs and some negative sample pairs are created. In a typical mask map example 610 for training data pair generation, sample s1(v2) may be a variant (e.g. an augmented version) of sample s1, such that s1 and s1(v2) are marked similar to each other based on a similar mark 611. In contrast, samples s1 and s2 are two different samples that are marked as dissimilar to each other based on a dissimilar mark 612. In addition, each sample and itself are marked as undefined (neither similar nor dissimilar) based on an undefined mark 613.

In a proposed mask map example 620 for training data pair generation with multiple wireless links (e.g. one transmitter antenna and two receiver antennas), sample s1-1(v2) may be a variant (e.g. an augmented version) of sample s1-1, such that s1-1 and s1-1(v2) are marked similar to each other based on a similar mark 621. In contrast, samples s1-1 and s2-1 are two different samples that are marked as dissimilar to each other based on a dissimilar mark 622. In addition, each sample and itself (e.g. s1-1 and s1-1 itself) are marked as undefined (neither similar nor dissimilar) based on an undefined mark 623. Further, two copies of a sample from two links (e.g. s2-1 and s2-2) are also marked as undefined (neither similar nor dissimilar) based on the undefined mark 623. In some embodiments, a mask based on the proposed mask map example 620 may be utilized to generate positive (similar) sample pairs and negative (dissimilar) sample pairs for training a foundation model based on a contrastive loss and/or a reconstruction loss.

In some embodiments, the system may process links in batch dimension or parallel processing of links. In some embodiments, the system may use shuffling during training and validation. Once the model is trained, it can be used for inference in real-time.

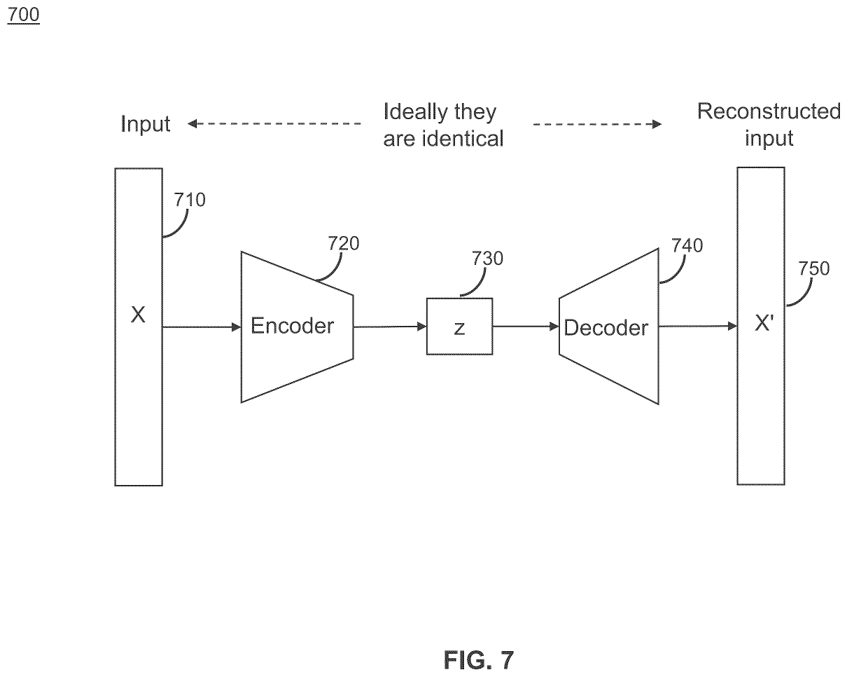

In some embodiments, anomaly detection may be performed based on an encoder. As shown in FIG. 7, a system 700 may include an encoder 720 and a decoder 740. The encoder 720 may receive the input X 710 and generate Z 730, which is a compressed low dimensional representation of the input X. The decoder 740 may receive the Z 730 and generate a reconstructed input X′ 750, which would be identical to input X 710 in an ideal case.

In some embodiments, anomalies may be detected by setting a threshold on the reconstruction error, which may be measured based on a difference between input X 710 and reconstructed input X′ 750. For example, data points with reconstruction errors higher than the threshold are considered anomalies.

In some embodiments, the CSI data samples come from multiple different chipsets or links, and the network can accommodate the varying subcarrier number of the CSI, based on methods including: zero padding, interpolation, repetition padding, masking, etc.

In some embodiments, the encoder 720 may be trained as a foundation model for multiple wireless sensing tasks, while a different version of the decoder 740 may be trained to perform each corresponding one of the multiple wireless sensing tasks.

In some embodiments, a mask may be used primarily to handle variable-length input data. For CSI data, the dimension of subcarrier is varying, and different chipsets may have different number of subcarriers. Therefore, padding on those subcarriers can be performed to make sure the network has consistently fixed dimension for input data, but the padded values may be invalid. The mask can ensure that these padding values do not influence the model's learning or attention mechanism, focusing only on the valid parts of the data. In some embodiments, the mask is a tensor and may contain 1 for valid subcarriers and 0 for padded subcarriers. In some embodiments, in the forward pass, the attention mechanism can use this mask to exclude the padded or invalid subcarriers from contributing to the final output.

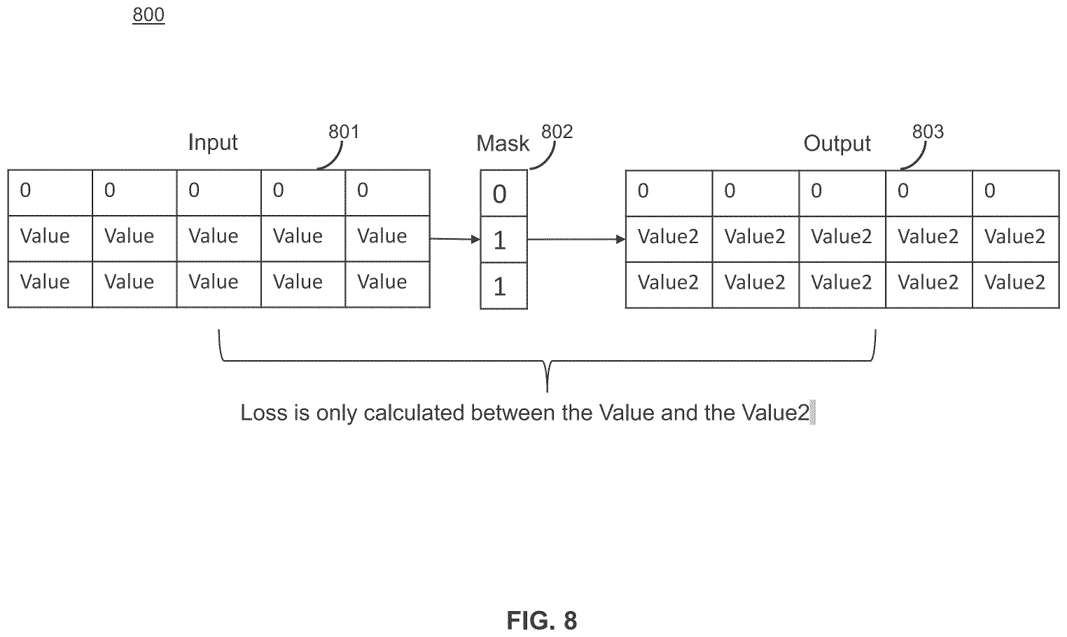

In some embodiments, the masking technique may be used to handle varying data dimensions before feeding them into the network. This method may involve padding data to a fixed dimension and using a mask to indicate valid and padded values. FIG. 8 illustrates an example process 800 for applying a mask, according to some embodiments of the present disclosure. As shown in FIG. 8, values in the first row of the input table 801 are padded values (0) and masked as “0”; and values in the second and third rows of the input table 801 are valid values (Value) and masked as “1”. Based on the mask 802, the output table 803 is generated to reconstruct only the second and third rows as Value2, while keeping the values in the first row as zero, for zero padding here. The mask can help the network to learn where the loss calculation ignores nonsense data to improve performance. For example, when computing the loss (how far off the model's predictions are from the ground truth), only the valid values (masked as “1”) are used. The padded parts are effectively ignored in the loss calculation. In some examples, different rows may correspond to different subcarriers.

The masking technique may be used in both training and testing phases for an anomaly detection task, e.g. a CSI verification task aiming at detecting anomalous CSI data. In an example of Wi-Fi sensing, verifying CSI quality before deployment can prevent performance issues caused by bad devices. The system may combine the masking with subcarrier padding in auto-encoders for CSI based sensing tasks. The system may use Recurrent Neural Networks (RNN) for the encoder and decoder based on the time-series nature of CSI data.

In various embodiments, the disclosure provides methods and systems for training a foundation model on WiFi Channel State Information (CSI) using a combination of contrastive learning and predictive learning, augmented by wireless-specific data transformations. The foundation model may be designed to generalize across different tasks, devices, and environments, supporting flexible deployment in real-world IoT systems. The system may have a cloud-edge distributed architecture, a novel training framework combining self-supervised learning objectives, specialized data augmentation strategies tailored for CSI, and a multi-bot fusion strategy for robust downstream inference.

In some embodiments, the system architecture may be partitioned into edge and cloud components for efficiency. The edge side may include: IoT devices continuously measuring raw WiFi CSI, an edge preprocessing module, and an edge triggering mechanism. The edge preprocessing module may unify the number of subcarriers, resample CSI to a standard temporal rate, and compress data dimensions (e.g., selective subcarrier selection) to reduce transmission size. The edge triggering mechanism may include a lightweight motion detection module (e.g., moving average statistics) that can detect events. In some examples, only when motion is detected, a recent time window (e.g., past 5 seconds) of preprocessed CSI is transmitted to the cloud.

The cloud side may include: a foundation model storage which stores the latest foundation model weights; pre-training and fine-tuning Engines configured to conduct large-scale self-supervised pre-training and fine-tune downstream task models using labeled datasets; an inference engine configured to processes uploaded CSI samples to produce predictions for various downstream tasks; and a GUI or App interface configured to sends task results (classification, occupancy status, etc.) to end-user platforms.

In some embodiments, the input data to the foundation model may include preprocessed CSI samples standardized to a fixed format (e.g., 250 timestamps*98 subcarriers). In some embodiments, the foundation model may include an encoder backbone and two parallel learning heads. In some examples, the encoder backbone may be based on a 6-layer Vision Transformer (ViT) or other deep learning models, and may be used to learn temporal and frequency patterns in the CSI data.

The two parallel learning heads include a contrastive learning head and a reconstruction (predictive) learning head. The contrastive learning head may be configured to embed input samples into a latent space and encourage samples from the same augmentation to have similar embedding's. The reconstruction learning head may try to reconstruct masked portions or original signal patterns, and enforce the encoder to retain fine-grained feature information.

The training objectives may include a contrastive loss and a reconstruction loss. Given two augmentations of the same input, minimizing the contrastive loss means minimizing their distance in the latent space, e.g. based on the NT-Xent Loss. For reconstruction loss (e.g., MSE or smooth L1 loss), the reconstruction error may be minimized between predicted and actual CSI data. In some embodiments, the foundation model may be trained based on a joint optimization to minimize a total loss, which is a weighted combination (e.g. weighted sum) of the contrastive loss and the reconstruction loss.

In some embodiments, domain-specific data augmentation techniques may be used. For example, noise injection may be performed by adding Gaussian noise to CSI samples, to improve robustness to environmental noise. For example, subcarrier shuffling may be performed by randomizing selected subcarriers within a block, to encourage frequency invariance. For example, time scaling and warping may be performed by speeding up or slowing down signal evolution to generalize across motion speeds. For example, environmental parameter variation may be performed by simulating multi-path changes, occlusions to improve spatial generalization. For example, amplitude normalization may be performed by normalizing amplitudes to mitigate power variations to handle device diversity. These augmentations can be applied individually or jointly during contrastive pair creation.

In some embodiments, data augmentation may include link-level ACF calculations. An IoT device has more than one antenna, which can be utilized to generate data. Each Tx-Rx link may observe the target (human or object) from a different spatial perspective. Instead of calculating the MRC combined ACF utilizing all the subcarriers from all the links (Tx-Rx pairs), the system may calculate the MRC combined ACF for each link (Tx-Rx pair). This data augmentation can improve the dataset size by N times, where N is the number of links in the device. By treating each link's ACF as a separate sample or partial view, data diversity may be increased without collecting new scenes. One example use case may be DL-occupancy network design, where the occupancy dataset may be highly imbalanced due to a lack of empty data samples. The system can use link-level feature matrix calculation-based data augmentation to improve the empty dataset.

In some embodiments, data augmentation may include link shuffling and/or permutation. There may be multiple Tx-Rx pairs or links in a device, where each link provides a different view of the scene. For tasks like child presence detection, antennas may be separated and attached to the four corners of a vehicle. As such, each link can provide different information about the scenario. Therefore, link permutation-based data augmentation can help to generalize the model architecture in the following aspects: preventing the model from overfitting for the specific link positions, creating diverse data with different spatial configurations, and enabling better generalization to unseen antenna configurations. One example use case may include a network design for child presence detection, to improve the diversity of child motion data and improve test accuracy in unseen environments.

In some embodiments, data augmentation may include link-mix augmentation, where two data samples are considered to represent the same activity (child motion) but are captured in different environments, positions, or from different Tx-Rx configurations. The system can create a synthetic data sample by combining the links across the two samples, to create a new and diverse representation of the same activity and improve networks generalization capabilities. This can be generalized well to new locations (car models), new device setups, with a good domain adaptation. One example use case may include a network design for child presence detection, to create synthetic data samples in the child motion scenario, as the current data samples are limited, and to improve the test accuracy for unseen environments.

In some embodiments, after pre-training the foundation model, the foundation model may support various downstream tasks including: occupancy detection, fall detection, motion source classification (human, pet, fan, robot, etc.), proximity estimation, breathing detection, etc.

In some examples, during fine-tuning, only task-specific classifier layers are trained, while the pre-trained encoder remains fixed. In some examples, both the encoder and classifiers are updated during downstream training and fine-tuning. The choice may depend on available labeled data and computational resources.

In some embodiments, for environments with multiple sensing devices (bots), each device can independently process its CSI and produce intermediate predictions. For example, a fusion module can aggregate predictions across multiple links based on (a) a voting-based majority decision or (b) a weighted aggregation based on link reliability or device proximity. This fusion can increase robustness, especially in large or cluttered environments.

The foundation model can be updated continuously or periodically. For example, when substantial new data is collected, the system can re-train the foundation model with augmented datasets, and deploy updated weights to the cloud for inference. For special environments (e.g., hospitals, elderly homes), a localized foundation model can be fine-tuned using environment-specific data.

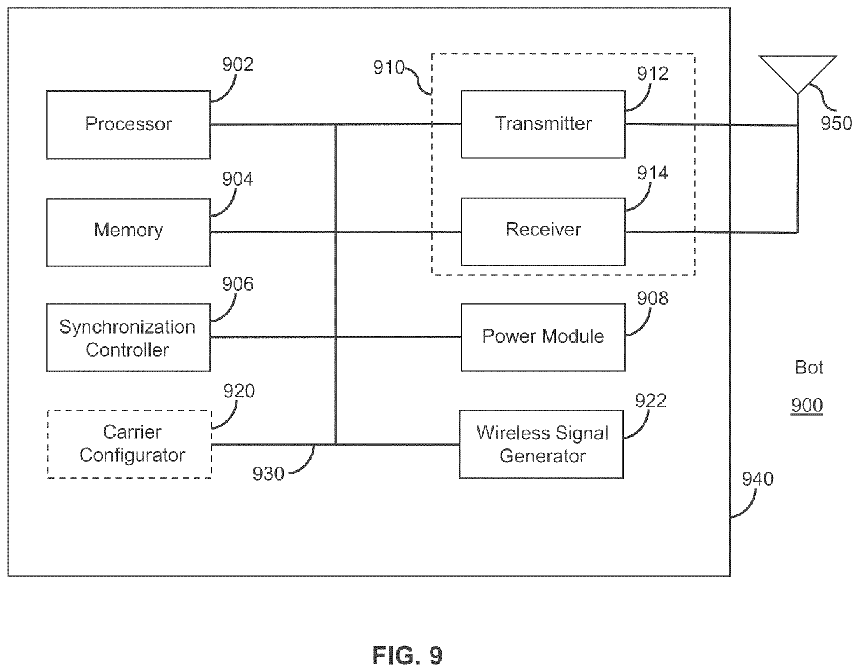

FIG. 9 illustrates an example block diagram of a first wireless device, e.g. a Bot 900, of a wireless sensing system, according to one embodiment of the present teaching. The Bot 900 is an example of a device that can be configured to implement the various methods described herein. As shown in FIG. 9, the Bot 900 includes a housing 940 containing a processor 902, a memory 904, a transceiver 910 comprising a transmitter 912 and receiver 914, a synchronization controller 906, a power module 908, an optional carrier configurator 920 and a wireless signal generator 922.

In this embodiment, the processor 902 controls the general operation of the Bot 900 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 904, which can include both read-only memory (ROM) and random access memory (RAM), can provide instructions and data to the processor 902. A portion of the memory 904 can also include non-volatile random access memory (NVRAM). The processor 902 typically performs logical and arithmetic operations based on program instructions stored within the memory 904. The instructions (a.k.a., software) stored in the memory 904 can be executed by the processor 902 to perform the methods described herein. The processor 902 and the memory 904 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 910, which includes the transmitter 912 and receiver 914, allows the Bot 900 to transmit and receive data to and from a remote device (e.g., an Origin or another Bot). An antenna 950 is typically attached to the housing 940 and electrically coupled to the transceiver 910. In various embodiments, the Bot 900 includes (not shown) multiple transmitters, multiple receivers, and multiple transceivers. In one embodiment, the antenna 950 is replaced with a multi-antenna array 950 that can form a plurality of beams each of which points in a distinct direction. The transmitter 912 can be configured to wirelessly transmit signals having different types or functions, such signals being generated by the processor 902. Similarly, the receiver 914 is configured to receive wireless signals having different types or functions, and the processor 902 is configured to process signals of a plurality of different types.

The Bot 900 in this example may serve as a Bot 102 in FIG. 1 for performing one or more wireless sensing tasks. For example, the wireless signal generator 922 may generate and transmit, via the transmitter 912, a wireless signal through a wireless multipath channel impacted by a motion of an object in the venue. The wireless signal carries information of the channel. Because the channel was impacted by the motion, the channel information includes motion information that can represent the motion of the object. As such, the motion can be indicated and detected based on the wireless signal. The generation of the wireless signal at the wireless signal generator 922 may be based on a request for motion detection from another device, e.g. an Origin, or based on a system pre-configuration. That is, the Bot 900 may or may not know that the wireless signal transmitted will be used to detect motion.

The synchronization controller 906 in this example may be configured to control the operations of the Bot 900 to be synchronized or un-synchronized with another device, e.g. an Origin or another Bot. In one embodiment, the synchronization controller 906 may control the Bot 900 to be synchronized with an Origin that receives the wireless signal transmitted by the Bot 900. In another embodiment, the synchronization controller 906 may control the Bot 900 to transmit the wireless signal asynchronously with other Bots. In another embodiment, each of the Bot 900 and other Bots may transmit the wireless signals individually and asynchronously.

The carrier configurator 920 is an optional component in Bot 900 to configure transmission resources, e.g. time and carrier, for transmitting the wireless signal generated by the wireless signal generator 922. In one embodiment, each CI of the time series of CI has one or more components each corresponding to a carrier or sub-carrier of the transmission of the wireless signal. The detection of the motion may be based on motion detections on any one or any combination of the components.

The power module 908 can include a power source such as one or more batteries, and a power regulator, to provide regulated power to each of the above-described modules in FIG. 9. In some embodiments, if the Bot 900 is coupled to a dedicated external power source (e.g., a wall electrical outlet), the power module 908 can include a transformer and a power regulator.

The various modules discussed above are coupled together by a bus system 930. The bus system 930 can include a data bus and, for example, a power bus, a control signal bus, and/or a status signal bus in addition to the data bus. It is understood that the modules of the Bot 900 can be operatively coupled to one another using any suitable techniques and mediums.

Although a number of separate modules or components are illustrated in FIG. 9, persons of ordinary skill in the art will understand that one or more of the modules can be combined or commonly implemented. For example, the processor 902 can implement not only the functionality described above with respect to the processor 902, but also implement the functionality described above with respect to the wireless signal generator 922. Conversely, each of the modules illustrated in FIG. 9 can be implemented using a plurality of separate components or elements.

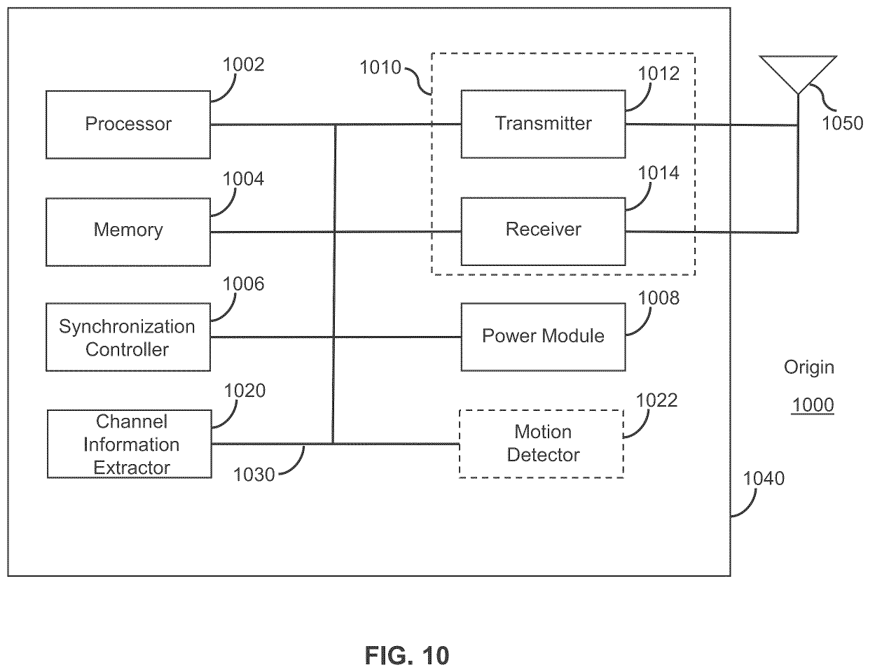

FIG. 10 illustrates an example block diagram of a second wireless device, e.g. an Origin 1000, of a wireless sensing system, according to one embodiment of the present teaching. The Origin 1000 is an example of a device that can be configured to implement the various methods described herein. The Origin 1000 in this example may serve as an Origin 104 in FIG. 1 for performing one or more wireless sensing tasks. As shown in FIG. 10, the Origin 1000 includes a housing 1040 containing a processor 1002, a memory 1004, a transceiver 1010 comprising a transmitter 1012 and a receiver 1014, a power module 1008, a synchronization controller 1006, a channel information extractor 1020, and an optional motion detector 1022.

In this embodiment, the processor 1002, the memory 1004, the transceiver 1010 and the power module 1008 work similarly to the processor 902, the memory 904, the transceiver 910 and the power module 908 in the Bot 900. An antenna 1050 or a multi-antenna array 1050 is typically attached to the housing 1040 and electrically coupled to the transceiver 1010.

The Origin 1000 may be a second wireless device that has a different type from that of the first wireless device (e.g. the Bot 900). In particular, the channel information extractor 1020 in the Origin 1000 is configured for receiving the wireless signal through the wireless multipath channel impacted by the motion of the object in the venue, and obtaining a time series of channel information (CI) of the wireless multipath channel based on the wireless signal. The channel information extractor 1020 may send the extracted CI to the optional motion detector 1022 or to a motion detector outside the Origin 1000 for detecting object motion in the venue.

The motion detector 1022 is an optional component in the Origin 1000. In one embodiment, it is within the Origin 1000 as shown in FIG. 10. In another embodiment, it is outside the Origin 1000 and in another device, which may be a Bot, another Origin, a cloud server, a fog server, a local server, and an edge server. The optional motion detector 1022 may be configured for detecting the motion of the object in the venue based on motion information related to the motion of the object. The motion information associated with the first and second wireless devices is computed based on the time series of CI by the motion detector 1022 or another motion detector outside the Origin 1000.

The synchronization controller 1006 in this example may be configured to control the operations of the Origin 1000 to be synchronized or un-synchronized with another device, e.g. a Bot, another Origin, or an independent motion detector. In one embodiment, the synchronization controller 1006 may control the Origin 1000 to be synchronized with a Bot that transmits a wireless signal. In another embodiment, the synchronization controller 1006 may control the Origin 1000 to receive the wireless signal asynchronously with other Origins. In another embodiment, each of the Origin 1000 and other Origins may receive the wireless signals individually and asynchronously. In one embodiment, the optional motion detector 1022 or a motion detector outside the Origin 1000 is configured for asynchronously computing respective heterogeneous motion information related to the motion of the object based on the respective time series of CI.

The various modules discussed above are coupled together by a bus system 1030. The bus system 1030 can include a data bus and, for example, a power bus, a control signal bus, and/or a status signal bus in addition to the data bus. It is understood that the modules of the Origin 1000 can be operatively coupled to one another using any suitable techniques and mediums.

Although a number of separate modules or components are illustrated in FIG. 10, persons of ordinary skill in the art will understand that one or more of the modules can be combined or commonly implemented. For example, the processor 1002 can implement not only the functionality described above with respect to the processor 1002, but also implement the functionality described above with respect to the channel information extractor 1020. Conversely, each of the modules illustrated in FIG. 10 can be implemented using a plurality of separate components or elements.

In one embodiment, in addition to the Bot 900 and the Origin 1000, the system may also comprise: an assistance device, a third wireless device, e.g. another Bot, configured for transmitting an additional heterogeneous wireless signal through an additional wireless multipath channel impacted by the motion of the object in the venue, or a fourth wireless device, e.g. another Origin, that has a different type from that of the third wireless device. The fourth wireless device may be configured for: receiving the additional heterogeneous wireless signal through the additional wireless multipath channel impacted by the motion of the object in the venue, and obtaining a time series of additional channel information (CI) of the additional wireless multipath channel based on the additional heterogeneous wireless signal. The additional CI of the additional wireless multipath channel is associated with a different protocol or configuration from that associated with the CI of the wireless multipath channel. For example, the wireless multipath channel is associated with LTE, while the additional wireless multipath channel is associated with Wi-Fi. In this case, the optional motion detector 1022 or a motion detector outside the Origin 1000 is configured for detecting the motion of the object in the venue based on both the motion information associated with the first and second wireless devices and additional motion information associated with the third and fourth wireless devices computed by at least one of: an additional motion detector and the fourth wireless device based on the time series of additional CI.

In some embodiments, the present teaching discloses systems and methods for wireless sensing using a foundation model.

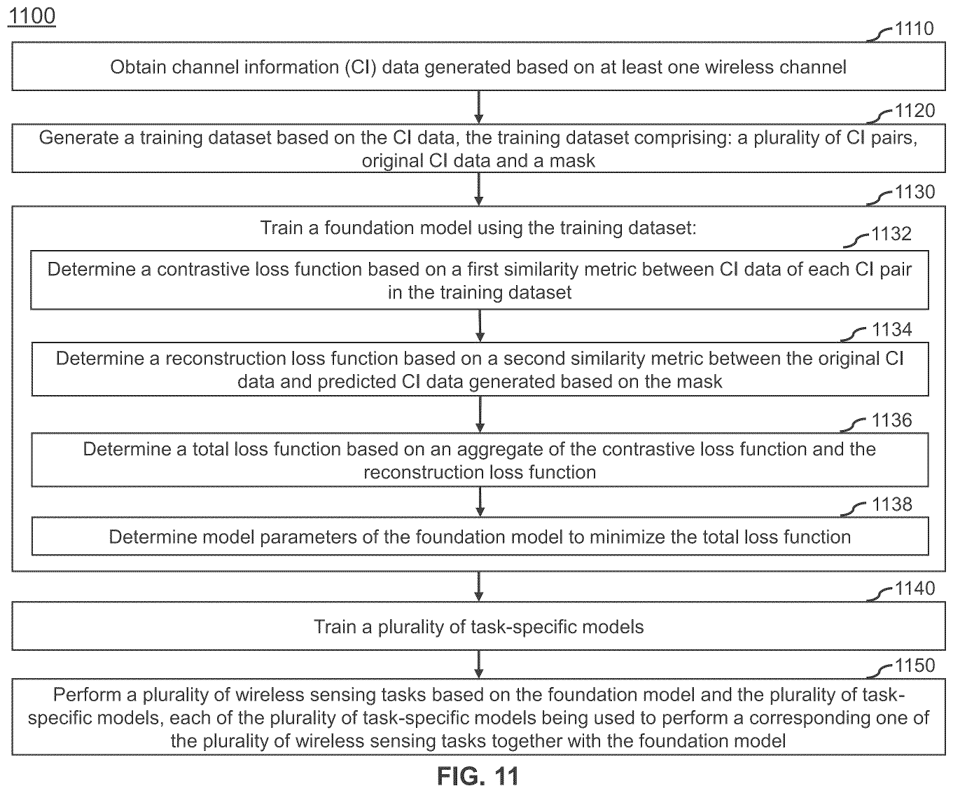

FIG. 11 illustrates a flow chart of an example method 1100 for wireless sensing using a foundation model, according to some embodiments of the present disclosure. In various embodiments, the method 1100 can be performed by any of the systems disclosed above. At operation 1110, channel information (CI) data generated based on at least one wireless channel may be obtained. At operation 1120, a training dataset may be generated based on the CI data, the training dataset comprising: a plurality of CI pairs, original CI data and a mask. At operation 1130, a foundation model may be trained using the training dataset by sub-operations 1132˜1138. At sub-operation 1132, a contrastive loss function is determined based on a first similarity metric between CI data of each CI pair in the training dataset. At sub-operation 1134, a reconstruction loss function is determined based on a second similarity metric between the original CI data and predicted CI data generated based on the mask. At sub-operation 1136, a total loss function is determined based on an aggregate of the contrastive loss function and the reconstruction loss function. At sub-operation 1138, model parameters of the foundation model may be determined to minimize the total loss function. At operation 1140, a plurality of task-specific models may be trained. At operation 1150, a plurality of wireless sensing tasks may be performed based on the foundation model and the plurality of task-specific models. Each of the plurality of task-specific models may be used to perform a corresponding one of the plurality of wireless sensing tasks together with the foundation model.

The following numbered clauses provide examples for wireless sensing using a foundation model.

Clause 1. A method for wireless sensing, comprising: obtaining channel information (CI) data generated based on at least one wireless channel; generating a training dataset based on the CI data, wherein the training dataset comprises: a plurality of CI pairs, original CI data and a mask; training a foundation model using the training dataset at least in part by: determining a contrastive loss function based on a first similarity metric between CI data of each CI pair in the training dataset, determining a reconstruction loss function based on a second similarity metric between the original CI data and predicted CI data generated based on the mask, determining a total loss function based on an aggregate of the contrastive loss function and the reconstruction loss function, and determining model parameters of the foundation model to minimize the total loss function; training a plurality of task-specific models; and performing a plurality of wireless sensing tasks based on the foundation model and the plurality of task-specific models, wherein each of the plurality of task-specific models is used to perform a corresponding one of the plurality of wireless sensing tasks together with the foundation model.

Clause 2. The method of clause 1, wherein obtaining the CI data comprises: determining a plurality of device pairs in at least one venue, wherein each of the plurality of device pairs is formed by a transmitter and a receiver; for each of the plurality of device pairs: transmitting a wireless signal by the transmitter through a wireless channel, receiving the wireless signal by the receiver, wherein the received wireless signal differs from the transmitted wireless signal due to the wireless channel and any sensing event in the at least one venue, obtaining a time series of channel information (TSCI) of the wireless channel based on the received wireless signal; and obtaining the CI data based on all TSCI obtained for the plurality of device pairs.

Clause 3. The method of clause 2, wherein generating the training dataset comprises: processing the CI data to generate preprocessed CI data according to a standardized format readable by the foundation model; performing a data augmentation on preprocessed CI in the preprocessed CI data to generate augmented CI, wherein the plurality of CI pairs comprises: a positive CI pair formed by a preprocessed CI and its associated augmented CI, a positive CI pair formed by two preprocessed CI, a positive CI pair formed by two augmented CI, a negative CI pair formed by two CI obtained from two different wireless channels, a negative CI pair formed by two CI obtained from two different venues, a negative CI pair formed by two CI associated with two different sensing events.

Clause 4. The method of clause 3, wherein processing the CI data comprises: selecting subcarriers for at least one CI in the CI data to generate a same number of subcarriers for all CI in the CI data according to the standardized format; and resampling each CI in the CI data to a predetermined temporal rate according to the standardized format.

Clause 5. The method of clause 4, wherein performing the data augmentation comprises: adding random noise to the preprocessed CI; randomizing the selected subcarriers within a block; performing a time scaling or a time warping on the preprocessed CI; simulating at least one environmental parameter related to multi-path change or occlusion; and normalizing amplitudes of the preprocessed CI to mitigate power variation.

Clause 6. The method of clause 3, wherein determining the contrastive loss function comprises: mapping each CI in the training dataset to a corresponding embedding point in an embedding space using the foundation model; for each CI pair comprising two CI in the training dataset, generating a distance score between two embedding points corresponding to the two CI of the CI pair based on the first similarity metric, wherein: the distance score is smaller when the CI pair is a positive CI pair, the distance score is larger when the CI pair is a negative CI pair; and determining the contrastive loss function based on the distance score.

Clause 7. The method of clause 1, wherein determining the reconstruction loss function comprises: generating masked CI data at least in part by applying the mask to the original CI data to remove at least one portion of the original CI data along a time dimension or a subcarrier dimension; generating the predicted CI data based on the masked CI data using the foundation model; generating an error function between the original CI data and the predicted CI data based on the second similarity metric; and determining the reconstruction loss function based on the error function.

Clause 8. The method of clause 1, wherein: the aggregate of the contrastive loss function and the reconstruction loss function comprises a weighted combination of the contrastive loss function and the reconstruction loss function; and weights used in the weighted combination are included in the model parameters of the foundation model and are adjusted during the training to minimize the total loss function through an iterative back propagation process.

Clause 9. The method of clause 1, wherein training the plurality of task-specific models comprises at least one of: freezing all model parameters of the foundation model during the training of the plurality of task-specific models; fine-tuning all model parameters of the foundation model based on at least one task-specific prediction loss during the training of the plurality of task-specific models; or during the training of the plurality of task-specific models: freezing model parameters of an upstream layer of the foundation model, and fine-tuning model parameters of a downstream layer of the foundation model, wherein each of the plurality of task-specific models is a downstream model compared to the foundation model.

Clause 10. The method of clause 1, wherein performing the plurality of wireless sensing tasks comprises: generating a feature map using the foundation model based on CI data collected in real-time; and inputting the feature map to the plurality of task-specific models perform the plurality of wireless sensing tasks respectively.

Clause 11. The method of clause 1, wherein performing the plurality of wireless sensing tasks comprises: collecting real-time CI data from multiple wireless links for at least one task of the plurality of wireless sensing tasks; and for each task of the at least one task: generating, using the foundation model, a plurality of feature maps each based on real-time CI data collected from a corresponding one of the multiple wireless links, generating a fused feature map at least in part by fusing the plurality of feature maps along a subcarrier dimension or according to an index of each of the multiple wireless links, and inputting the fused feature map into a task-specific model corresponding to the task to generate a decision result for the task.

Clause 12. The method of clause 1, wherein performing the plurality of wireless sensing tasks comprises: collecting real-time CI data from multiple wireless links for at least one task of the plurality of wireless sensing tasks; and for each task of the at least one task: generating, using the foundation model, a plurality of feature maps each based on real-time CI data collected from a corresponding one of the multiple wireless links, inputting each of the plurality of feature maps into a task-specific model corresponding to the task to generate a candidate decision result for the task, and fusing all candidate decision results generated for the task based on a fusion model to generate a final decision result for the task.

Clause 13. The method of clause 1, wherein: the foundation model is trained based on self-supervised machine learning without labelled data; and each of the plurality of task-specific models is trained based on labelled data.

Clause 14. The method of clause 1, wherein: the training dataset is generated by a local device and transmitted from the local device to a cloud server; the foundation model and the plurality of task-specific models are trained by the cloud server; and performing the plurality of wireless sensing tasks comprises: collecting and processing real-time CI data by at least one local device to generate processed real-time CI data, determining, by the at least one local device, whether a triggering event happens based on the processed real-time CI data, in accordance with a determination that the triggering event happens, transmitting an immediate past portion of the processed real-time CI data within an immediate past time period from the at least one local device to the cloud server, and performing, by the cloud server, a wireless sensing task corresponding to the triggering event based on the immediate past portion of the processed real-time CI data using the foundation model and a task-specific model corresponding to the wireless sensing task.

Clause 15. A system for wireless sensing, comprising: at least one local device configured to: obtain channel information (CI) data generated based on at least one wireless channel, generate a training dataset based on the CI data, wherein the training dataset comprises: a plurality of CI pairs, original CI data and a mask; and a cloud server configured to: train a foundation model using the training dataset at least in part by: determining a contrastive loss function based on a first similarity metric between CI data of each CI pair in the training dataset, determining a reconstruction loss function based on a second similarity metric between the original CI data and predicted CI data generated based on the mask, determining a total loss function based on an aggregate of the contrastive loss function and the reconstruction loss function, and determining model parameters of the foundation model to minimize the total loss function, and train a plurality of task-specific models, wherein the at least one local device and the cloud server are further configured to perform a plurality of wireless sensing tasks based on the foundation model and the plurality of task-specific models, wherein each of the plurality of task-specific models is used to perform a corresponding one of the plurality of wireless sensing tasks together with the foundation model.

Clause 16. The system of clause 15, wherein the at least one local device is configured to generate the training dataset at least in part by: processing the CI data to generate preprocessed CI data according to a standardized format readable by the foundation model; performing a data augmentation on preprocessed CI in the preprocessed CI data to generate augmented CI, wherein the plurality of CI pairs comprises: a positive CI pair formed by a preprocessed CI and its associated augmented CI, a positive CI pair formed by two preprocessed CI, a positive CI pair formed by two augmented CI, a negative CI pair formed by two CI obtained from two different wireless channels, a negative CI pair formed by two CI obtained from two different venues, a negative CI pair formed by two CI associated with two different sensing events.

Clause 17. The system of clause 16, wherein: processing the CI data comprises: selecting subcarriers for at least one CI in the CI data to generate a same number of subcarriers for all CI in the CI data according to the standardized format, and resampling each CI in the CI data to a predetermined temporal rate according to the standardized format; and performing the data augmentation comprises at least one of: adding random noise to the preprocessed CI, randomizing the selected subcarriers within a block, performing a time scaling or a time warping on the preprocessed CI, simulating at least one environmental parameter related to multi-path change or occlusion, and normalizing amplitudes of the preprocessed CI to mitigate power variation.

Clause 18. The system of clause 16, wherein determining the contrastive loss function comprises: mapping each CI in the training dataset to a corresponding embedding point in an embedding space using the foundation model; for each CI pair comprising two CI in the training dataset, generating a distance score between two embedding points corresponding to the two CI of the CI pair based on the first similarity metric, wherein: the distance score is smaller when the CI pair is a positive CI pair, the distance score is larger when the CI pair is a negative CI pair; and determining the contrastive loss function based on the distance score.

Clause 19. The system of clause 15, wherein determining the reconstruction loss function comprises: generating masked CI data at least in part by applying the mask to the original CI data to remove at least one portion of the original CI data along a time dimension or a subcarrier dimension; generating the predicted CI data based on the masked CI data using the foundation model; generating an error function between the original CI data and the predicted CI data based on the second similarity metric; and determining the reconstruction loss function based on the error function.

Clause 20. A device for wireless sensing, comprising: at least one processor; and at least one memory storing instructions, which when executed, cause the at least one processor to perform operations comprising: obtaining channel information (CI) data generated based on at least one wireless channel, generating a training dataset based on the CI data, wherein the training dataset comprises: a plurality of CI pairs, original CI data and a mask, training a foundation model using the training dataset at least in part by: determining a contrastive loss function based on a first similarity metric between CI data of each CI pair in the training dataset, determining a reconstruction loss function based on a second similarity metric between the original CI data and predicted CI data generated based on the mask, determining a total loss function based on an aggregate of the contrastive loss function and the reconstruction loss function, and determining model parameters of the foundation model to minimize the total loss function, training a plurality of task-specific models, and performing a plurality of wireless sensing tasks based on the foundation model and the plurality of task-specific models, wherein each of the plurality of task-specific models is used to perform a corresponding one of the plurality of wireless sensing tasks together with the foundation model.

In some embodiments, a wireless sensing system may utilize a deep learning network. Examples of a deep learning network may include: a Feedforward neural network (FNN), a Convolutional neural network (CNN), a Recurrent neural networks (RNN), an autoencoder, a Generative Adversarial Network (GAN), a transformer network, a Radial Basis Function Network (RBFN), a Self-organizing Map (SOM), a Deep Belief Network (DBN), a Neural Turing Machine (NTM).

In some embodiments, a CNN is primarily used for processing structured grid data such as images. CNN uses a mathematical operation called convolution in place of general matrix multiplication in at least one of their layers. They are designed to automatically and adaptively learn spatial hierarchies of features from input images. In some embodiments, variants including Residual Neural networks (ResNet) may be used to facilitate the training of deep learning networks by allowing gradients to flow more effectively through multiple layers.

In some embodiments, a RNN is suited for sequential data like time series, speech, text. RNNs have connections that form directed cycles, allowing information to persist over time. Variants include Long Short-Term Memory (LSTM) and Gated Recurrent Units (GRU) were developed to address issues like vanishing gradients and to better capture long-range dependencies.

In some embodiments, autoencoders are unsupervised learning models that aim to learn a representation (encoding) for a set of data. Typically used for dimensionality reduction or feature learning. Consist of an encoder that compresses the input into a latent space representation and a decoder that reconstructs the input data from this representation.

In some embodiments, GANs may comprise two networks: a generator and a discriminator, which are trained simultaneously through adversarial processes. The generator learns to produce data that is similar to the training data, while the discriminator learns to distinguish between real and generated data. Used for generating realistic images, videos, and voice recordings.

In some embodiments, a transformer network is a model that uses self-attention mechanisms to weigh the significance of different parts of the input data differently. Transformers have been shown to be highly effective for natural language processing tasks. The architecture is the basis for models like BERT, GPT (Generative Pretrained Transformer), and others.

In some embodiments, RBFNs may use radial basis functions as activation functions. They may be used for function approximation, time series prediction, and control.

In some embodiments, SOMs may be unsupervised learning models used to produce a low-dimensional representation of a higher-dimensional data set. Useful for visualizing high-dimensional data in two or three dimensions.

In some embodiments. DBNs may be composed of multiple layers of stochastic, latent variables. The layers can be trained in a greedy, layer-wise fashion.

In some embodiments, NTMs may combine the fuzzy pattern matching capabilities of neural networks with the algorithmic power of programmable computers. They can infer simple algorithms from examples.

The following numbered clauses provide examples for training a deep learning network as a classifier for wireless sensing.

Clause A1. A method/device/system/software of training deep learning classifier using multi-granularity-level training data, comprising: in an operating phase: transmitting a wireless signal by a Type 1 heterogeneous wireless device through a wireless channel in a venue; receiving the wireless signal by a Type2 heterogeneous wireless device in the venue, wherein the received wireless signal differs from the transmitted wireless signal due to the wireless channel and a motion of a user in the venue; obtaining N1 time series of channel information (TSCI) of the wireless channel by the Type2 device based on the received wireless signal; for each of the N1 TSCI: computing a respective 1-dimensional (1D) N11-point transform at a target granularity level based on channel information (CI) of the TSCI for each of N9 sliding time windows in a time period, wherein any granularity level is one of: per-component level, per-TSCI level, or all-TSCI level, and constructing a 2-dimensional (2-D) transform matrix of size N11×N9 at the target granularity level for the TSCI for the time period based on the N9 1D N11-point transform; inputting the N1 2-D transform matrices at the target granularity level for the time period into a deep learning classifier; using the deep learning classifier to classify the motion of the object in the time period into a particular motion class based on the N1 2-D transform matrix at the target granularity level; in a training phase: obtaining a plurality of training TSCI for the particular motion class based on respective received training wireless signal transmitted from a training Type1 device to a training Type2 device; for each of N9 sliding time windows in a training time period and for each training TSCI, computing a respective first 1-dimensional (1D) N11-point transform at the target granularity level and multiple respective second 1D N11-point transforms at a second granularity level based on channel information (CI) of the TSCI in the sliding time window, wherein the second granularity level is different from the target granularity level; constructing a first 2-dimensional (2-D) transform matrix of size N11×N9 at the target granularity level for each training TSCI for the training time period based on the N9 first 1D N11-point transform; constructing multiple second 2-D transform matrices of size N11×N9 at the second granularity level for each training TSCI for the training time period based on the second 1D N11-point transforms at the second granularity level, each second 2-D transform matrix based on respective N9 second 1D N11-point transform; training the deep learning network for the particular motion class based on both the first 2-D transform matrix and the multiple second 2-D transform matrices.

In some embodiments, the deep learning classifier may be used only when motion is detected—i.e. when motion statistics is greater than a threshold.

Clause A2. The method/device/system/software of training deep learning classifier using multi-granularity-level training data of clause A1, comprising: computing a motion statistics (MS) based on N5 CI of the TSCI in the time period; detecting the motion of the user in the time period by comparing the motion statistics with a first threshold, wherein the motion of user is detected in the time period when the motion statistics exceeds the first threshold; classifying the motion of the user when the motion of the user is detected.

In some embodiments, there may be a plurality of motion classes for the deep learning classifier.

Clause A3. The method/device/system/software of training deep learning classifier using multi-granularity-level training data of clause A1, comprising: using the deep learning classifier to classify the motion of the object in the timer period into one of a plurality of motion classes based on the 2-D transform matrix at the target granularity level.

In some embodiments, the deep learning classifier may have two stages: stage-1 network, stage-2 network. The stage-1 network may be CNN with ReLU activation and maxpooling. In some embodiments, a shared CNN architecture may be used by utilizing a single CNN model to extract features from multiple 2-D transform matrices. This may minimize computation overhead, enable batch processing. This shared architecture may facilitate integration of 2-D transform matrices from new devices without the need for retraining the model. This may particularly be beneficial in dynamic environments where the number of IoT devices may vary. In some embodiments, some possible stage-2 networks are listed here. It may be a transformer. Positional embedding may not be used, which helped to make the system device-agnostic. The classification token is a learnable embedding with the same dimensionality as the feature maps. Attention map of transformer block may measure importance of each feature map and assigns a weight based on that.

Clause A4. The method/device/system/software of training deep learning classifier using multi-granularity-level training data of clause A3, comprising: wherein the deep learning classifier comprises a stage-1 neural network and a stage-2 neural network; wherein the stage-1 neural network is the first stage of the deep learning classifier comprising a convolutional neural network (CNN); wherein the stage-2 neural network is the second stage of the deep learning classifier comprising one of: feedforward neural network (FNN), fully-connected network (FCN), CNN, recurrent neural network (RNN), long short-term memory (LSTM), or transformer.

In some embodiments, the data flow includes: 2-D transform matrix inputted to Stage-1. In some embodiments, 2-D transform matrix is input to stage-1 CNN. Output of stage-1 CNN may be fed into stage-2 network (possible some suitable data rearrangement). Output of stage-2 CNN may be output analytics associated with the plurality of motion classes.

Clause A5. The method/device/system/software of training deep learning classifier using multi-granularity-level training data of clause A4, comprising: inputting the 2-D transform matrix for the time period into the stage-1 CNN of the deep learning classifier; inputting an intermediate output of the stage-1 CNN into the stage-2 neural network of the deep learning classifier; output a plurality of output likelihood score for the plurality of motion classes, each output analytics associated with respective motion classes.

In some embodiments, motion class associated with max output analytics may be chosen.

Clause A6. The method/device/system/software of training deep learning classifier using multi-granularity-level training data of clause A5, comprising: classifying the motion of the object in the time period into the particular motion class when the associated particular output likelihood score is greater than a threshold and is maximum among the plurality of output analytics.

In some embodiments, while special multi-granularity-level may be used to generate additional/supplementary/reasonable training data for motion classes that have insufficient training data, single (target) granularity level may be used for/used to train motion classes with sufficient training data.

Clause A7. The method/device/system/software of training deep learning classifier using multi-granularity-level training data of clause A1, comprising: in the operating phase: using the deep learning classifier to classify the motion of the object in the timer period into a second motion class based on the 2-D transform matrix at the target granularity level; in the training phase: obtaining a plurality of training TSCI for the second motion class based on respective received training wireless signal transmitted from a training Type1 device to a training Type2 device; for each of N9 sliding time windows in a training time period and for each training TSCI, computing a respective 1-dimensional (1D) N11-point transform at the target granularity level based on channel information (CI) of the TSCI in the sliding time window; constructing a 2-dimensional (2-D) transform matrix of size N11×N9 at the target granularity level for each training TSCI for the training time period based on the N9 1D N11-point transform; training the deep learning network for the second motion class based on the 2-D transform matrix.

In some embodiments, there are some ways to compute 1D transform at per-component granularity level.

Clause A8. The method/device/system/software of training deep learning classifier using multi-granularity-level training data of clause A1, comprising: where each CI have N4 CI-components (CIC); computing a per-component 1D N11-point transform associated with a particular component of CI of a particular TSCI by: forming a N11-tuple vector by concatenating a respective component of N11 consecutive CI of the particular TSCI, and applying the N11-point transform to the N11-tuple vector.

In some embodiments, there are some ways to compute 1D transform at per-TSCI granularity level.

Clause A9. The method/device/system/software of training deep learning classifier using multi-granularity-level training data of clause A8, comprising: computing a per-TSCI 1D N11-point transform associated with a particular TSCI as an aggregate of N4 per-component 1D N11-point transforms associated with the N4 components of the particular TSCI.

In some embodiments, there is a way to compute 1D transform at all-TSCI granularity level. (Basically the same as per-device-pair).

Clause A10. The method/device/system/software of training deep learning classifier using multi-granularity-level training data of clause A9, comprising: computing an all-TSCI 1D N11-point transform associated with all TSCI as an aggregate of N1 per-TSCI 1D N11-point transforms associated with the N1 TSCI.

In some embodiments, there is another way to compute 1D transform at all-TSCI granularity level. (Basically the same as per-device-pair).

Clause A11. The method/device/system/software of training deep learning classifier using multi-granularity-level training data of clause A9, comprising: computing an all-TSCI 1D N11-point transform associated with all TSCI as an aggregate of N1*N4 per-component 1D N11-point transforms associated with the N4 CIC of CI of the N1 TSCI.

In some embodiments, there is special case when there are more than one device-pairs.

Clause A12. The method/device/system/software of training deep learning classifier using multi-granularity-level training data of clause A11, comprising: wherein there are N10 pairs of Type1 devices and Type2 devices in the venue; in the operating phase: for each of N10 pairs of Type1 devices and Type2 devices: transmitting a respective wireless signal by a respective Type1 device through a wireless channel in a venue; receiving the respective wireless signal by a respective Type2 device in the venue, wherein the received respective wireless signal differs from the transmitted respective wireless signal due to the wireless channel and the motion of the user in the venue; obtaining respective N1 time series of channel information (TSCI) of the wireless channel by the respective Type2 device based on the received respective wireless signal; for each of N10 device-pairs: for each of the respective N1 TSCI of the device-pair: for each of the N4 CIC of CI of the TSCI of the device-pair: computing a per-component 1-dimensional (1D) N11-point transform based on the CIC of channel information (CI) of the TSCI of the device-pair in each of N9 sliding time windows in a time period, and constructing a per-component 2-dimensional (2-D) transform matrix of size N11×N9 for the CIC of CI of the TSCI of the device-pair for the time period based on the N9 per-component 1D N11-point transforms, computing a per-TSCI 1D N11-point transform for the TSCI of the device-pair as a first aggregate of the N4 per-component 1D N11-point transform in each of the N9 sliding time windows in the time period, and constructing a per-TSCI 2-D transform matrix of size N11×N9 for the TSCI of the device-pair for the time period based on the N9 per-TSCI 1D N11-point transforms; computing a per-device-pair 1D N11-point transform as a second aggregate of the N1 per-TSCI N11-point transform, or as a third aggregate of the N1*N4 per-component N11-point transform, in each of the N9 sliding time windows in the time period; constructing a per-device-pair 2-D transform matrix of size N11×N9 for the N10 device-pair for the time period based on the N9 per-device-pair 1D N11-point transforms; computing an all-device-pair 1D N11-point transform as a fourth aggregate of the N10 per-device-pair N11-point transforms, as a fifth aggregate of all respective N1 per-TSCI N11-point transforms of all the N10 device-pairs, or as a sixth aggregate of all respective N1*N4 per-component N11-point transform of all the N10 device-pairs, in each of the N9 sliding time windows in the time period; constructing an all-device-pair 2-D transform matrix of size N11×N9 for all the N10 device-pairs for the time period based on the N9 per-device-pair 1D N11-point transforms; inputting the 2-D transform matrix at a target granularity level for the time period into a deep learning classifier, wherein the target granularity level is either per-device-pair level or all-device; using the deep learning classifier to classify the motion of the object in the time period into a particular motion class based on the 2-D transform matrix at the target granularity level; in a training phase: obtaining a plurality of training TSCI for the particular motion class based on respective received training wireless signal transmitted from a training Type1 device to a training Type2 device; for each of N9 sliding time windows in a training time period and for each training TSCI, computing a respective first 1-dimensional (1D) N11-point transform at the target granularity level and multiple respective second 1D N11-point transforms at a second granularity level based on channel information (CI) of the TSCI in the sliding time window, wherein the second granularity level is different from the target granularity level; constructing a first 2-dimensional (2-D) transform matrix of size N11×N9 at the target granularity level for each training TSCI for the training time period based on the N9 first 1D N11-point transform; constructing multiple second 2-D transform matrices of size N11×N9 at the second granularity level for each training TSCI for the training time period based on the second 1D N11-point transforms at the second granularity level, each second 2-D transform matrix based on respective N9 second 1D N11-point transform; training the deep learning network for the particular motion class based on both the first 2-D transform matrix and the multiple second 2-D transform matrices.

Clause A13. The method/device/system/software of training deep learning classifier using multi-granularity-level training data of clause A12, comprising: wherein the target granularity level is the all-device-pair level; wherein the second granularity level is any of: the per-device-pair level, the per-TSCI level or the per-component level.

Clause A14. The method/device/system/software of training deep learning classifier using multi-granularity-level training data of clause A12, comprising: wherein the target granularity level is the per-device-pair level; wherein the second granularity level is the per-TSCI level or the per-component level.

Clause A15. The method/device/system/software of training deep learning classifier using multi-granularity-level training data of clause A1, comprising: constructing the 2-D transform matrix of size N11×N9 for the time period by assembling and concatenating the N9 1D transform as columns of the 2-D transform matrix.

Clause A16. The method/device/system/software of training deep learning classifier using multi-granularity-level training data of clause A15, comprising: wherein each 1D transform is associated with a time stamp; assembling and concatenating the N9 1D transform as columns of the 2-D transform matrix in increasing order of the time stamp.

Clause A17. The method/device/system/software of training deep learning classifier using multi-granularity-level training data of clause A1, comprising: computing N9 1D N11-point d-transform based on the N9 1D N11-point transform in the N9 sliding time windows in the time period, each 1D d-transform being a differential of a respective 1D transform in transform domain; constructing the 2-dimensional (2-D) transform matrix of size N11×N9 for each time fragment by assembling and concatenating the N9 1D d-transform as columns of the 2-D transform matrix in increasing order of the time stamp.

In some embodiments, ACF may be crucial for a range of passive sensing applications, including gait monitoring, motion detection, breathing estimation, human identification, and gesture recognition. Analyzing ACF over extended time windows may provide valuable insights into slowly changing environmental dynamics while observing ACF at shorter intervals allows us to detect transient changes, such as falls. Increasing frequency of ACF calculations along with enhancing resolution and duration of time lags may be vital for optimizing performance across these applications. However, this approach leads to larger ACF vector sizes. The ability to compress ACF data offers significant advantages: (1) efficient data transmission, compression of ACF, faster and more cost effective data transmission, thereby enhancing responsiveness and overall performance of applications; (2) reduced complexity. Using ACF as input can significantly increase the number of parameters that need to be learned, requiring extensive training data. Compressed ACF may reduce input dimensions, which simplifies the model and decreases the number of parameters to learn, simplify the training process. ACF compression can enhance efficiency of data transmission, reduces storage requirement, improves processing speeds and reduces bandwidth consumption.

In some examples, a dictionary learning approach or deep learning based approach can be used to learn a compact representation of an ACF vector. In some embodiments, an encoder-decoder architecture may be utilized. Using a training dataset, the model can learn a lossy encoded representation of a general ACF vector that can be reconstructed with minimum error. In some embodiments, to build such a system, the following operations may be performed.

(a) d-ACF (difference of ACF) calculation. In some examples, the d-ACF vectors are calculated with a time lag of 0.1 sec. For a sounding rate of 1500 Hz, this results in 149 length vector which is downsampled by 2 (due to computation of difference of adjacent ACF) to obtain a 74 length vector. For every second, d-ACF calculations are performed 10 times, i.e. a step size of 0.1 sec used. There are 232 subcarriers in total from the 4×4 MIMO of which only 39 subcarriers are used by uniform downsampling.

(b) Data preparation. In some examples, d-ACF vectors are generated for different subcarriers from the CSI collected during routine activities in indoor environments including movement of humans, pets, and other mechanical objects. The d-ACF vectors may then be normalized to lie in the range of 0 and 1.

(c) Training. In some examples, an encoder-decoder architecture that includes 17700 learnable parameters may be trained using above training dataset using 5000 epochs and a learning rate of 1e{−4} and a mean squared error loss.

The features described above may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., C. Java), including compiled or interpreted languages, and it may be deployed in any form, including as a stand-alone program or as a module, component, subroutine, a browser-based web application, or other unit suitable for use in a computing environment.

Suitable processors for the execution of a program of instructions include, e.g., both general and special purpose microprocessors, digital signal processors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

While the present teaching contains many specific implementation details, these should not be construed as limitations on the scope of the present teaching or of what may be claimed, but rather as descriptions of features specific to particular embodiments of the present teaching. Certain features that are described in this specification in the context of separate embodiments may also be implemented in combination in a single embodiment. Conversely, various features that are described in the context of a single embodiment may also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter have been described. Any combination of the features and architectures described above is intended to be within the scope of the following claims. Other embodiments are also within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A method for wireless sensing, comprising:
obtaining channel information (CI) data generated based on at least one wireless channel;
generating a training dataset based on the CI data, wherein the training dataset comprises: a plurality of CI pairs, original CI data and a mask;
training a foundation model using the training dataset at least in part by:
determining a contrastive loss function based on a first similarity metric between CI data of each CI pair in the training dataset,
determining a reconstruction loss function based on a second similarity metric between the original CI data and predicted CI data generated based on the mask,
determining a total loss function based on an aggregate of the contrastive loss function and the reconstruction loss function, and
determining model parameters of the foundation model to minimize the total loss function;
training a plurality of task-specific models; and
performing a plurality of wireless sensing tasks based on the foundation model and the plurality of task-specific models, wherein each of the plurality of task-specific models is used to perform a corresponding one of the plurality of wireless sensing tasks together with the foundation model.

2. The method of claim 1, wherein obtaining the CI data comprises:
determining a plurality of device pairs in at least one venue, wherein each of the plurality of device pairs is formed by a transmitter and a receiver;
for each of the plurality of device pairs:
transmitting a wireless signal by the transmitter through a wireless channel,
receiving the wireless signal by the receiver, wherein the received wireless signal differs from the transmitted wireless signal due to the wireless channel and any sensing event in the at least one venue,
obtaining a time series of channel information (TSCI) of the wireless channel based on the received wireless signal; and
obtaining the CI data based on all TSCI obtained for the plurality of device pairs.

3. The method of claim 2, wherein generating the training dataset comprises:
processing the CI data to generate preprocessed CI data according to a standardized format readable by the foundation model;
performing a data augmentation on preprocessed CI in the preprocessed CI data to generate augmented CI, wherein the plurality of CI pairs comprises:
a positive CI pair formed by a preprocessed CI and its associated augmented CI,
a positive CI pair formed by two preprocessed CI,
a positive CI pair formed by two augmented CI,
a negative CI pair formed by two CI obtained from two different wireless channels,
a negative CI pair formed by two CI obtained from two different venues,
a negative CI pair formed by two CI associated with two different sensing events.

4. The method of claim 3, wherein processing the CI data comprises:
selecting subcarriers for at least one CI in the CI data to generate a same number of subcarriers for all CI in the CI data according to the standardized format; and
resampling each CI in the CI data to a predetermined temporal rate according to the standardized format.

5. The method of claim 4, wherein performing the data augmentation comprises:
adding random noise to the preprocessed CI;
randomizing the selected subcarriers within a block;
performing a time scaling or a time warping on the preprocessed CI;
simulating at least one environmental parameter related to multi-path change or occlusion; and
normalizing amplitudes of the preprocessed CI to mitigate power variation.

6. The method of claim 3, wherein determining the contrastive loss function comprises:
mapping each CI in the training dataset to a corresponding embedding point in an embedding space using the foundation model;
for each CI pair comprising two CI in the training dataset, generating a distance score between two embedding points corresponding to the two CI of the CI pair based on the first similarity metric, wherein:
the distance score is smaller when the CI pair is a positive CI pair,
the distance score is larger when the CI pair is a negative CI pair; and
determining the contrastive loss function based on the distance score.

7. The method of claim 1, wherein determining the reconstruction loss function comprises:
generating masked CI data at least in part by applying the mask to the original CI data to remove at least one portion of the original CI data along a time dimension or a subcarrier dimension;
generating the predicted CI data based on the masked CI data using the foundation model;
generating an error function between the original CI data and the predicted CI data based on the second similarity metric; and
determining the reconstruction loss function based on the error function.

8. The method of claim 1, wherein:
the aggregate of the contrastive loss function and the reconstruction loss function comprises a weighted combination of the contrastive loss function and the reconstruction loss function; and
weights used in the weighted combination are included in the model parameters of the foundation model and are adjusted during the training to minimize the total loss function through an iterative back propagation process.

9. The method of claim 1, wherein training the plurality of task-specific models comprises at least one of:
freezing all model parameters of the foundation model during the training of the plurality of task-specific models;
fine-tuning all model parameters of the foundation model based on at least one task-specific prediction loss during the training of the plurality of task-specific models; or
during the training of the plurality of task-specific models:
freezing model parameters of an upstream layer of the foundation model, and
fine-tuning model parameters of a downstream layer of the foundation model, wherein each of the plurality of task-specific models is a downstream model compared to the foundation model.

10. The method of claim 1, wherein performing the plurality of wireless sensing tasks comprises:
generating a feature map using the foundation model based on CI data collected in real-time; and
inputting the feature map to the plurality of task-specific models perform the plurality of wireless sensing tasks respectively.

11. The method of claim 1, wherein performing the plurality of wireless sensing tasks comprises:
collecting real-time CI data from multiple wireless links for at least one task of the plurality of wireless sensing tasks; and
for each task of the at least one task:
generating, using the foundation model, a plurality of feature maps each based on real-time CI data collected from a corresponding one of the multiple wireless links,
generating a fused feature map at least in part by fusing the plurality of feature maps along a subcarrier dimension or according to an index of each of the multiple wireless links, and
inputting the fused feature map into a task-specific model corresponding to the task to generate a decision result for the task.

12. The method of claim 1, wherein performing the plurality of wireless sensing tasks comprises:
collecting real-time CI data from multiple wireless links for at least one task of the plurality of wireless sensing tasks; and
for each task of the at least one task:
generating, using the foundation model, a plurality of feature maps each based on real-time CI data collected from a corresponding one of the multiple wireless links,
inputting each of the plurality of feature maps into a task-specific model corresponding to the task to generate a candidate decision result for the task, and
fusing all candidate decision results generated for the task based on a fusion model to generate a final decision result for the task.

13. The method of claim 1, wherein:
the foundation model is trained based on self-supervised machine learning without labelled data; and
each of the plurality of task-specific models is trained based on labelled data.

14. The method of claim 1, wherein:
the training dataset is generated by a local device and transmitted from the local device to a cloud server;
the foundation model and the plurality of task-specific models are trained by the cloud server; and
performing the plurality of wireless sensing tasks comprises:
collecting and processing real-time CI data by at least one local device to generate processed real-time CI data,
determining, by the at least one local device, whether a triggering event happens based on the processed real-time CI data,
in accordance with a determination that the triggering event happens, transmitting an immediate past portion of the processed real-time CI data within an immediate past time period from the at least one local device to the cloud server, and
performing, by the cloud server, a wireless sensing task corresponding to the triggering event based on the immediate past portion of the processed real-time CI data using the foundation model and a task-specific model corresponding to the wireless sensing task.

15. A system for wireless sensing, comprising:
at least one local device configured to:
obtain channel information (CI) data generated based on at least one wireless channel,
generate a training dataset based on the CI data, wherein the training dataset comprises: a plurality of CI pairs, original CI data and a mask; and
a cloud server configured to:
train a foundation model using the training dataset at least in part by:
determining a contrastive loss function based on a first similarity metric between CI data of each CI pair in the training dataset,
determining a reconstruction loss function based on a second similarity metric between the original CI data and predicted CI data generated based on the mask,
determining a total loss function based on an aggregate of the contrastive loss function and the reconstruction loss function, and
determining model parameters of the foundation model to minimize the total loss function, and
train a plurality of task-specific models,
wherein the at least one local device and the cloud server are further configured to perform a plurality of wireless sensing tasks based on the foundation model and the plurality of task-specific models,
wherein each of the plurality of task-specific models is used to perform a corresponding one of the plurality of wireless sensing tasks together with the foundation model.

16. The system of claim 15, wherein the at least one local device is configured to generate the training dataset at least in part by:
processing the CI data to generate preprocessed CI data according to a standardized format readable by the foundation model;
performing a data augmentation on preprocessed CI in the preprocessed CI data to generate augmented CI, wherein the plurality of CI pairs comprises:
a positive CI pair formed by a preprocessed CI and its associated augmented CI,
a positive CI pair formed by two preprocessed CI,
a positive CI pair formed by two augmented CI,
a negative CI pair formed by two CI obtained from two different wireless channels,
a negative CI pair formed by two CI obtained from two different venues,
a negative CI pair formed by two CI associated with two different sensing events.

17. The system of claim 16, wherein:
processing the CI data comprises:
selecting subcarriers for at least one CI in the CI data to generate a same number of subcarriers for all CI in the CI data according to the standardized format, and
resampling each CI in the CI data to a predetermined temporal rate according to the standardized format; and
performing the data augmentation comprises at least one of:
adding random noise to the preprocessed CI,
randomizing the selected subcarriers within a block,
performing a time scaling or a time warping on the preprocessed CI,
simulating at least one environmental parameter related to multi-path change or occlusion, and
normalizing amplitudes of the preprocessed CI to mitigate power variation.

18. The system of claim 16, wherein determining the contrastive loss function comprises:
mapping each CI in the training dataset to a corresponding embedding point in an embedding space using the foundation model;
for each CI pair comprising two CI in the training dataset, generating a distance score between two embedding points corresponding to the two CI of the CI pair based on the first similarity metric, wherein:
the distance score is smaller when the CI pair is a positive CI pair,
the distance score is larger when the CI pair is a negative CI pair; and
determining the contrastive loss function based on the distance score.

19. The system of claim 15, wherein determining the reconstruction loss function comprises:
generating masked CI data at least in part by applying the mask to the original CI data to remove at least one portion of the original CI data along a time dimension or a subcarrier dimension;
generating the predicted CI data based on the masked CI data using the foundation model;
generating an error function between the original CI data and the predicted CI data based on the second similarity metric; and
determining the reconstruction loss function based on the error function.

20. A device for wireless sensing, comprising:
at least one processor; and
at least one memory storing instructions, which when executed, cause the at least one processor to perform operations comprising:
obtaining channel information (CI) data generated based on at least one wireless channel,
generating a training dataset based on the CI data, wherein the training dataset comprises:
a plurality of CI pairs, original CI data and a mask,
training a foundation model using the training dataset at least in part by:
determining a contrastive loss function based on a first similarity metric between CI data of each CI pair in the training dataset,
determining a reconstruction loss function based on a second similarity metric between the original CI data and predicted CI data generated based on the mask,
determining a total loss function based on an aggregate of the contrastive loss function and the reconstruction loss function, and
determining model parameters of the foundation model to minimize the total loss function,
training a plurality of task-specific models, and
performing a plurality of wireless sensing tasks based on the foundation model and the plurality of task-specific models, wherein each of the plurality of task-specific models is used to perform a corresponding one of the plurality of wireless sensing tasks together with the foundation model.
